(19) United States
(12) Patent Application Publication
(10) Pub. No.: US 2004/0158581 A1
(43) Pub. Date: Aug. 12, 2004

(54) Method for determination of co-occurences of attributes

(76) Inventors: Max Kotlyar, Kingston (CA); Roland Somogyi, Sydenham (CA); James Green, Kingston (CA); Evan Steeg, Kingston (CA); Alan D. Ableson, Kingston (CA)

Correspondence Address: DOWELL & DOWELL PC, SUITE 309, 1215 JEFFERSON DAVIS HIGHWAY, ARLINGTON, VA, 22202

(21) Appl. No.: 10/478,418

(22) PCT Filed: May 17, 2002
(86) PCT No.: PCT/CA02/00731

(51) Int. Cl. G06F 17/00

(52) U.S. Cl. 707/104.1

(57) ABSTRACT

A method, system, computer program selecting attribute sets of characterizing attributes of an object, selecting an attribute set of attributes of interest, assigning a likelihood for each characterized attribute set that the attribute set occurs when the attribute set of interest occurs (each likelihood determined using Bayesian computable classifiers on a dataset of attributes for actual samples), comparing each assigned likelihood against likelihood thresholds, and reporting the assigned likelihoods of the characterizing attribute set based on the likelihood thresholds. Markers may be identified for diagnosis and prognosis. Characterizing attributes may be gene expression levels and the attribute of interest may be drug sensitivity level, drug dose (absolute concentration or dose relative to some standard dose), dose of drug which causes half-maximal cellular growth rate, or logarithm base 10 (dose) where dose is the dose which yields half-maximal total cell mass accumulating.

### CROSS-REFERENCE TO RELATED APPLICATIONS

This application claims priority from U.S. patent application Ser. No. 60/291,928 filed May 21, 2001 by the same inventors under the same title, and from U.S. patent application Ser. No. 60/291,931 filed May 21, 2001 by the same inventors under the title Methods of Gene Analysis and Treating Cancer. U.S. patent application Ser. Nos. 60/291,928 and 60/291,931 are hereby incorporated herein by reference.

### TECHNICAL FIELD

The invention relates to methods and apparatuses for determining co-occurences of attributes in objects. It also relates to attributes including biological response.

### BACKGROUND ART

The discovery of correlations among pairs or k-tuples of variables has applications in many areas of science, medicine, industry and commerce. For example, it is of great interest to physicians and public health professionals to know which lifestyle, dietary, and environmental factors correlate with each other and with particular diseases in a database of patient histories. It is potentially profitable for a trader in stocks or commodities to discover a set of financial instruments whose prices covary over time. Sales staff in a supermarket chain or mail-order distributor would be interested in knowing that consumers who buy product A also tend to buy products B and Q and this can be discovered in a database of sales records. Computational molecular biologists and drug discovery researchers would like to infer aspects of molecular structure from correlations between distant sequence elements in aligned sets of RNA or protein sequences.

One formulation of the general problem which encompasses many diverse applications, and which facilitates understanding of the principles described herein is a matrix of discrete features in which rows correspond to “objects” (such as diseases, individual patients, stock prices, consumers, or protein sequences) and the columns correspond to features, or attributes, or variables (such as drug sensitivity, gene expression, lifestyle factors, stocks, sales items, or amino acid residue positions).

Given the vast amount of data and the valuable nature of the information available from large datasets, one wants to use efficient techniques to assist in the determination of correlations. For example, large-scale datasets exists of DNA microarray studies. These can be used to determine correlations between gene expression patterns and drug treatments. This approach is urgently needed for the treatment of many diseases and other conditions, for example cancer which involves many different tissues and varieties of tumor types. However, the application of the proper data analysis methods will be critical for the efficient use of these large-scale data sets.

Biologists are generally acquainted with the idea of correlating individual genes with specific physiological functions, and with the use of linear correlation methods, such as Pearson's correlation coefficient. Although the linear, single-gene approach has yielded significant advances in biomedicine, the complex, nonlinear nature of tissue demands the use of more sophisticated methods.

It is desirable to provide efficient means by which to determine correlations between attributes of objects.

### DISCLOSURE OF THE INVENTION

In a first aspect of the invention provides, a base method for identifying one or more characterizing attributes for an object that are likely to co-occur with one or more attributes of interest for the object. The method comprises the steps of selecting one or more attribute sets of one or more characterizing attributes of the object, selecting an attribute set of one or more attributes of interest for the object, assigning a likelihood for each characterized attribute set that the attribute set occurs for the object when the attribute set of interest occurs for the object (each likelihood determined using one or more Bayesian computable classifiers on a dataset of attributes for a plurality of actual samples of the object), comparing each assigned likelihood against one or more likelihood thresholds, and reporting the assigned likelihoods of the characterizing attribute set based on the likelihood thresholds.

In another aspect the invention provides, a method comprising the steps of, selecting one characterizing attribute set of one or more attributes for the object, selecting an attribute of interest for the object, assigning a likelihood for the characterized attribute set that the attribute occurs for the object when the attribute of interest occurs for the object (the assigned likelihood determined using a Bayesian computable classifier on a dataset of attributes for a plurality of actual samples of the object), comparing the assigned likelihood against a likelihood threshold, and reporting the assigned likelihood of the characterizing attribute set based on the likelihood threshold.

In another aspect the invention provides, a method comprising the steps of, selecting one or more attribute sets of one or more characterizing attributes of the object, selecting an attribute set of one or more attributes of interest for the object, assigning a likelihood for each characterized attribute set that the attribute set occurs for the object when the attribute set of interest occurs for the object (each likelihood determined using one or more Bayesian computable classifiers on a dataset of attributes for a plurality of actual samples of the object), determining a likelihood significance for each assigned likelihood using artificial samples, and ranking the assigned likelihoods of the characterizing attribute set using the likelihood significance.

In another aspect the invention provides, a method comprising the steps of accessing one of the systems described below.

In another aspect the invention provides, a base system used to identify one or more characterizing attributes for an object that are likely to co-occur with one or more attributes of interest for the object using a dataset of samples of attributes for the object. The system comprises a computing platform, and a computer program on a computer readable medium for use on the computer platform in association with the dataset. The computer program comprises instructions to identify a characterizing attribute for an object that is likely to co-occur with an attribute of interest for the object, by carrying out the steps of one of the base methods.

The methods may be used for drug discovery by identifying characterizing attribute sets for interaction by the drug using the steps one of the base methods for drug sensitive attributes of interest drug, and performing screens for drugs where growth in cells having desirably ranked characterizing attribute sets is drug sensitive.

The methods may be used for identifying markers for diagnostic kits used to determine if a treatment is appropriate for a patient, by identifying a gene expression level set to be tested for in the patient by carrying out the steps of one of the base methods.

The methods may be used for identifyg markers for diagnosis of a living system by identifying an attribute set to be tested for in the living system using the steps of one of the base methods. The methods may also be used for identifying markers for prognosis of a living system by identifying an attribute set to be tested for in the living system using the steps of one of the base methods. The diagnosis or prognosis may be with respect to a disease or syndrome type of a patient. The methods may also be used for identifing markers for determining the appropriateness of a therapy or treatment of a living system by identifying an attribute set to be tested for in the living system using the steps of one of the base methods.

In the above methods the attributes of the attribute set may include protein concentrations. The protein concentrations may include tissue protein concentrations. The protein concentrations may include serum protein concentrations.

In the above methods the attributes of the attribute set may include molecular markers. The molecular markers may include blood molecular markers. The molecular markers may include tissue molecular markers.

In the above methods the attributes of the attribute set may include clinical observables. The clinical observables may include microscopic clinical observables. The clinical observables may include macroscopic clinical observables.

The markers may be for diagnostic kits used in the diagnosis, for diagnostic procedures used in the diagnosis, for prognostic kits used in the prognosis, or for prognostic procedures used in the prognosis.

A likelihood threshold for each characterizing attribute set may be determined using the same Bayesian classifiers as the assigned likelihood on a dataset of attributes for a plurality of artificial samples of the object. Similarly, a likelihood threshold for each characterizing attribute set may be determined by computing those characterizing attribute sets with an assigned likelihood above a given percentile of all assigned likelihoods for the relevant attribute set.

Artificial samples may be created by randomizing the actual gene expression levels for the characterizing attributes. Artificial samples may be created by transposing the actual gene expression levels for each characterizing attribute to another characterizing attribute.

The assigned likelihoods of the characterizing attribute sets may be compared against a likelihood threshold determined by computing those characterizing attribute sets with an assigned likelihood above a given percentile of all assigned likelihoods for the relevant attribute set of interest.

The characterizing attributes may be gene expression levels and the attribute of interest may be drug sensitivity level, drug dose (absolute concentration or dose relative to some standard dose) along an increasing or decreasing scale, dose of drug which causes half-maximal cellular growth rate, or −logarithm₁₀(dose) where dose is the dose which yields half-maximal total cell mass accumulating under otherwise standard conditions.

Drug sensitivity level may represent growth inhibiting in diseased cells, a lack of growth inhibiting in diseased cells, patient toxicity in healthy cells. The attributes may be represented in a dataset taken from the NCI60 dataset. The Bayesian classifier may be selected from a group consisting of linear discriminant analysis, quadratic discriminant analysis, and a uniform/gaussian analysis.

The characterizing attribute sets ranked following comparison of the likelihood and the likelihood threshold may be reported. The ranked characterizing attributes sets may be reported to one of a group consisting of a computer readable file stored on computer readable media, a printed report, and a computer network. The assigned likelihoods may be ranked by assigned likelihood and subranked by likelihood significance. The assigned likelihood may be compared against a likelihood threshold, and the assigned likelihood of the characterizing attribute set may be reported based on the likelihood threshold and the ranking of the assigned likelihood.

### BRIEF DESCRIPTION OF THE DRAWINGS

For a better understanding of the present invention and to show more clearly how it may be carried into effect, reference will now be made, by way of example, to the accompanying drawings that show the preferred embodiment of the present invention and in which:

FIG. 1 is a first Venn diagram of statistically significant results of analyses employed in the preferred embodiment of the invention;

FIG. 2 is a second Venn diagram of statistically significant results of analyses employed in the preferred embodiment of the invention;

FIG. 3 is a plot of results from a 2D QDA analysis of a dataset according to the preferred embodiment of the invention;

FIG. 4 is a plot of results from a 2D LDA analysis of a dataset according to the preferred embodiment of the invention;

FIG. 5 is a plot of results from a 2D QDA analysis of a dataset according to the preferred embodiment of the invention;

FIG. 6 is a plot of results from a 2D UGDA analysis of a dataset according to the preferred embodiment of the invention;

FIG. 7 is a plot of results from a 1D LDA analysis of a dataset according to the preferred embodiment of the invention;

FIG. 8 is a plot of results from a 1D UGDA analysis of a dataset according to the preferred embodiment of the invention;

FIG. 9 is an example flow chart of a computer program according to the preferred embodiment of the invention;

FIG. 10 is an example block diagram of a system according to the preferred embodiment of the invention;

FIG. 11 is an example flow chart of a computer program according to an alternate embodiment of the invention;

FIG. 12 is an example block diagram of a system according to an alternate embodiment of the invention;

FIG. 13 is an example flow chart of a computer program according to an alternate embodiment of the invention;

FIG. 14 is an example block diagram of a system according to an alternate embodiment of the invention;

FIG. 15 is an example flow chart of a computer program according to an alternate embodiment of the invention; and

FIG. 16 is an example block diagram of a system according to an alternate embodiment of the invention.

### MODES FOR CARRYING OUT THE INVENTION

A number of alternative base methods, systems and devices will now be referred described, along with alternative applications for those methods, systems and devices. It is understood that these base methods, systems and devices and their alternative applications are by way of description of preferred embodiments and are not limiting to the principles described and the application of those principles.

As previously set out, a base method identifies one or more characterizing attributes for an object that are likely to co-occur with one or more attributes of interest for the object. The method comprises the steps of selecting one or more attribute sets of one or more characterizing attributes of the object, selecting an attribute set of one or more attributes of interest for the object, assigning a likelihood for each characterized attribute set that the attribute set occurs for the object when the attribute set of interest occurs for the object (each likelihood determined using one or more Bayesian computable classifiers on a dataset of attributes for a plurality of actual samples of the object), comparing each assigned likelihood against one or more likelihood thresholds, and reporting the assigned likelihoods of the characterizing attribute set based on the likelihood thresholds.

In an alternative base method, the method comprises the steps of, selecting one characterizing attribute set of one or more attributes for the object, selecting an attribute of interest for the object, assigning a likelihood for the characterized attribute set that the attribute occurs for the object when the attribute of interest occurs for the object (the assigned likelihood determined using a Bayesian computable classifier on a dataset of attributes for a plurality of actual samples of the object), comparing the assigned likelihood against a likelihood threshold, and

Reporting the assigned likelihood of the characterizing attribute set based on the likelihood threshold.

In a further alternative base method, the method comprises the steps of; selecting one or more attribute sets of one or more characterizing attributes of the object, selecting an attribute set of one or more attributes of interest for the object, assigning a likelihood for each characterized attribute set that the attribute set occurs for the object when the attribute set of interest occurs for the object (each likelihood determined using one or more Bayesian computable classifiers on a dataset of attributes for a plurality of actual samples of the object), determining a likelihood significance for each assigned likelihood using artificial samples, and ranking the assigned likelihoods of the characterizing attribute set using the likelihood significance.

In a further alternative base method, the method comprises the steps of accessing one of the systems described below.

As previously set out a base system is used to identify one or more characterizing attributes for an object that are likely to co-occur with one or more attributes of interest for the object using a dataset of samples of attributes for the object. The system comprises a computing platform, and a computer program on a computer readable medium for use on the computer platform in association with the dataset. The computer program comprises instructions to identify a characterizing attribute for an object that is likely to co-occur with an attribute of interest for the object, by carrying out the steps of one of the base methods.

The base methods can be used for drug discovery by identifying characterizing attribute sets for interaction by the drug using the steps one of the base methods for drug sensitive attributes of interest drug, and performing screens for drugs where growth in cells having desirably ranked characterizing attribute sets is drug sensitive.

The base methods can be used for identifying markers for diagnostic kits used to determine if a treatment is appropriate for a patient, by identifying a gene expression level set to be tested for in the patient by carrying out the steps of one of the base methods.

In the base methods, a likelihood threshold for each characterizing attribute set can be determined using the same Bayesian classifiers as the assigned likelihood on a dataset of attributes for a plurality of artificial samples of the object. Similarly, a likelihood threshold for each characterizing attribute set can be determined by computing those characterizing attribute sets with an assigned likelihood above a given percentile of all assigned likelihoods for the relevant attribute set.

Artificial samples can be created by randomizing the actual gene expression levels for the characterizing attributes. Artificial samples can be created by transposing the actual gene expression levels for each characterizing attribute to another characterizing attribute.

The assigned likelihoods of the characterizing attribute sets may be compared against a likelihood threshold determined by computing those characterizing attribute sets with an assigned likelihood above a given percentile of all assigned likelihoods for the relevant attribute set of interest.

For the base methods, the characterizing attributes may be gene expression levels and the attribute of interest may be drug sensitivity level, drug dose (absolute concentration or dose relative to some standard dose) along an increasing or decreasing scale, dose of drug which causes half-maximal cellular growth rate, or -logarithm₁₀(dose) where dose is the dose which yields half-maximal total cell mass accumulating under otherwise standard conditions.

Drug sensitivity level may represent growth inhibiting in diseased cells, a lack of growth inhibiting in diseased cells, patient toxicity in healthy cells. The attributes may be represented in a dataset taken from the NCI60 dataset. The Bayesian classifier may be selected from a group consisting of linear discriminant analysis, quadratic discriminant analysis, and a uniform/gaussian analysis.

The characterizing attribute sets ranked following comparison of the likelihood and the likelihood threshold may be reported. The ranked characterizing attributes sets may be reported to one of a group consisting of a computer readable file stored on computer readable media, a printed report, and a computer network. The assigned likelihoods may be ranked by assigned likelihood and subranked by likelihood significance. The assigned likelihood may be compared against a likelihood threshold, and the assigned likelihood of the characterizing attribute set may be reported based on the likelihood threshold and the ranking of the assigned likelihood.

The modes described herein provide extensions and alternatives to the base methods described above and employ many similar principles. The principles of one application as described herein may be applied to the others as appropriate. Thus, the description of all elements of each application will not always be repeated for all applications.

In the preferred embodiment it is preferred for simplicity of programming and interpretation to consider the object and attributes in the form of a matrix, see for example Table 1; however, this is not strictly required and any of the embodiments can utilize a data set of objects and attributes that are not represented in the form of a matrix by sampling the data set directly.

TABLE 1

| Sample | Object | Attributes |
|---|---|---|
| 1 | A | I d e f |
| 2 | B | II d g h |
| 3 | A | I d h |

As an example of a dataset laid out in matrix format, the objects may be a particular disease, while the samples are taken from different patients and the attributes are particular expression levels of particular genes and sensitivity to a particular drug. The samples may be cells. Using the data in Table 1, sample 1 from a cell having disease A is taken from a first patient. The disease A cell from the patient has sensitivity to drug I and gene expression levels d, e, f. Similarly, sample 2 from a cell having disease B may also be taken from the same patient. The disease B cell from the patient has sensitivity to drug II and gene expression levels d, g, h. Sample 3 from a cell having disease A is taken from a different patient. The disease A cell from the patient has sensitivity to drug I and gene expression levels d, h.

For the example set out above, we may be interested in whether or not sensitivity to drug I is related somehow to gene expressions levels d and e together. Thus, drug I is an attribute set of interest and gene expression levels d and e are a characterizing attribute set. This may be represented in a matrix in the form of Table 2.

TABLE 2

| | | | Characterizing Attribute set |
|---|---|---|---|
| Sample | Object | Attribute set of Interest I | d e |
| 1 | A | yes | yes |
| 2 | B | no | no |
| 3 | A | yes | no |

Alternatively, object A and object B may be part of a generic object C. For example, one may be interested in knowing if a number of forms of cancer are sensitive to the same drug. In this case, the relevant samples may change. In the example above, the first patient has two forms of cancer A and B. If one is looking for drug sensitivity in both cancers A and B then the all the samples may be relevant, while the object is cancers of type A and B. This permits the use of samples from the same patient for different cancers. Samples from the same patient with the same attribute of interest would ordinarily be considered to be only one sample. The particular definition of objects, samples, attributes of interest and characterizing attributes is a matter of choice for the designer of a particular embodiment. It is recognized that some choices may be superior to others; however, that does not bring them any of them outside of the principles described herein.

The datasets may contain many different samples, some of which will not contain attribute sets of interest for a given run of the methods. These can be filtered out before the methods are run, or they may be left in the dataset to be accessed when the methods are run.

Each of the features for an object may be numerical or qualitative. The features are transformed into ordinal (values capable of being ordered) variables, termed attributes.

The principles described herein can be extended to attributes sets of interest and characterizing sets of higher orders. For example, one may want to know if sensitivity to a particular cocktail of drugs co-occurs with a particular combination of gene expression levels.

In this description, specific reference is made on many occasions to examples in the biotech industry. This is in no way limiting to the broad nature of the principles described herein which may be applied to many industry including, by way of example only, financial services, drug discovery, discovery and analysis of genetic networks, sales analysis, direct mail and related marketing activities, clustering customer data, analysis of medical, epidemiological and public health databases, patient data, causes of failures and the analysis of complex systems.

When using the phrases “occurs for” and “attributes for” in respect of an object, it is understood that these are broadly intended. Attributes may not simply be a part of an object, such as its gene expression levels, but may be factors or things that could broadly be related to the object, such as weather on a particular day (attribute) may be related to the price (attribute) of an agricultural stock (object). It is also understood that objects are not limited to traditionally tangible objects, but may be intangible objects such as bonds or stocks as well.

It is recognized that a characterizing attribute set that is likely to co-occur with an attribute set of interest does not necessarily imply that the characterizing attribute set is causing the attribute of interest; however, in many situations this information continues to be useful. For example, symptoms (characterizing attributes) may act as a useful disease marker (attribute of interest); however, they are caused by, and do not generally cause, the disease.

The methods can form part of methods for identifying possible drug targets. Once it is known that a disease or diseased cell is affected by drugs that appear to interact with cells having particular combinations of gene expression levels then screening studies can be conducted to find other drugs that also inhibit growth in cells with those combinations of expression levels.

The base method takes a dataset of samples of objects, including a characterizing attributes set and an attribute set of interest, as input. The method generates an output display of characterizing attribute sets that have a substantial likelihood of co-occurring with the attribute set of interest.

As part of the method, one or more characterizing attribute sets are selected, and one or more attribute sets of interest are selected. The likelihood of each characterizing attribute set co-occurring in actual samples of the object is determined using a Bayesian computable classifier. A likelihood of each characterizing set occurring in artificial samples is used to determine a likelihood threshold. Only those characterizing attribute sets with a likelihood co-occurrence greater than its likelihood threshold is selected.

For example, an embodiment of the method may take a collection of biological samples, their gene expression measurements (characterizing attributes), and a binary high/low drug response measurement (attributes of interest) as input. The method generates a prioritized list of genes, ranked by their p-values or ability to correctly predict the drug response (likelihood of co-occurrence). In this example, the method consists of three steps:

1) Selection of candidate gene sets (characterizing attribute set).

2) Calculation of classification accuracy for each gene set using a Bayesian classifier (determination of likelihood of co-occurrence using Bayesian classifier)

3) Ranking of the gene sets by their classification accuracy and the identification of meaningful gene sets by a comparison of their classification accuracies with those generated using randomized data (determination of likelihood threshold using artificial samples and selection of characterizing attribute sets having a substantial likelihood of co-occurrence).

Step 1) can take a number of forms. A simple list of all single genes can be a collection of (singleton) gene sets. A list of all pairs of genes can be a collection of (gene pair) candidate gene sets. Pre-processing techniques (such as those described in PCT Patent Application PCT/CA98/00273 filed Mar. 23 1998 under title Coincidence Detection Method, Products and Apparatus, inventor Evan W. Steeg, published Oct. 1 1998 as WO 98/43182) may be used to create candidate gene sets. Alternative pre-processing techniques may be used, including by way of example, standard feature detectors, or known gene pathway tables.

Step 2) can also take a number of forms. Classical statistical techniques such as Linear Discriminant Analysis or Quadratic Discriminant Analysis can be used. Other probabilistic models, such as the Gaussian/Uniform, can be tailored to particular applications or to suit biological intuition.

Step 3) involves the comparison of the classification scores from step 2) to those generated from randomized data Multiple datasets (on the order of 100 or more) are generated by permuting the gene expression values over the samples. i.e. if samples were rows and genes were columns in a table, we would permute the entries in each column, independently. Steps 1) and 2) are repeated for the randomized data, and the scores from the real data are compared to the scores from the randomized data The scores are ranked according to those most likely to indicate a co-occurrence and those scores greater than the scores for randomized data. Selections can be made according to the rank of the scores for the non-randomized data, or according to the rank of the difference of the scores for the real and randomized data. Selections may also be based on other calculations using the real and random scores.

By way of example, validation can be determined either by comparing classification scores from the real data to all the classification scores from the randomized data and then applying the Bonferroni correction, or by comparing the most extreme classification accuracies from each randomized trial to the most extreme classification accuracy from the real data An empirical p-value can be obtained directly by calculating the proportion of random datasets for which their extreme classification accuracies exceeded that in the real data. Only those gene sets with p-values below a user-selected cutoff are reported.

The results of the method described above have many uses including, by way of example, to use the:

1) gene sets identified as potential targets for drug interaction.

2) gene sets identified for pre-treatment screening of patients to identify the most effective drug treatment.

We analyzed data on the responses of 60 human cancer cell lines (NCI60) to 90 drugs shown to inhibit their growth in culture (Developmental Therapeutics Program, National Cancer Institute). These data were correlated with the basal (untreated) gene expression patterns from the same set of cell lines (see Ross, D. T., Scherf, U., Eisen, M. B., Perou, C. M., Rees, C., et al. (2000) Systematic variation in gene expression patterns in human cancer cell lines. Nature 24, 227-235, and Scherf, U., Ross, D. T., Waltham, W., Smith, L. H., Lee, J. K., et al. (2000) A gene expression database for the molecular pharmacology of cancer. Nature 24, 236-244).

We compared linear and nonlinear methods for correlating gene expression levels of individual genes with drug sensitivity for 1000 genes across the 60 cancer cell lines, which included breast, central nervous system, colon, lung, renal, and prostate cancer, as well as melanoma and leukemia cell lines. In addition, we correlated the expression patterns of pairs of genes with drug sensitivities to determine whether more than one gene was required to predict drug sensitivity in some cases.

We found that linear and non-linear methods captured different, although to some extent overlapping, correlations, suggesting specific genes as markers for particular drug treatments. We also found that expression levels of combinations of genes should be considered as indicators of effective drug treatments, as these combinations sometimes contain information not found in the expression patterns of individual genes considered in isolation.

We conclude that nonlinear and combinatorial, as well as linear, single-gene methods are appropriate for the efficient extraction of gene expression-drug sensitivity relationships in cancer cell lines. Computational methods such as these should be useful in cancer diagnosis and treatment.

First, we divided drug sensitivity into low- and high-sensitivity classes (creating possible attributes of interest):

Drug sensitivities were reported as −logGI50 s, with the log being base 10. All the drug sensitivities were normalized to mean zero so that the measurement really reflected differential growth inhibition. We wanted to categorize the cell line response into “uninhibited” and “inhibited”, with a small gray area to avoid the effects of harsh cutoffs. In that scale, a value of 1.0 for a cell line/drug combination meant that the cell line was inhibited to 50% growth at 1/10 the dosage of the “average” drug. For our purposes, we wanted to identify those drugs that were effective at least ⅕ the “average” dosage, which in the log scale turns into 0.7. Thus, any value of −logGI50 less than 0.7 were considered “uninhibited” or a low sensitivity/response. On the other end of the scale, all of those drugs that resulted in inhibition at concentrations<1/10 of the average dosage were all considered “inhibitory”. We then put in a smooth linear scaling between the cutoffs of 0.7 (low response) and 1.0 (high response). This gave us the function:

f(r)=0 if r<0.7

(r−0.7)/0.3 if r in [0.7, 1)

1 if r>=1

Sensitivities in the range [0.7,1] are partially in both classes. Since it varies between 0 and 1, the function f can be viewed as a fuzzy classification or a probability. f(r) Probability of sensitivity in high class, 1−f(r)=Probability of sensitivity in low class.

Finding correlations (determining likelihood of co-occurrence of attribute set of interest and characterizing attribute set) between drug sensitivity (attribute set of interest) and gene expression (characterizing attribute set):

For a given gene, A, and drug, B, we try to see if 2 classes of cell lines (high and low sensitivity) can be distinguished on the basis of gene expression. One of the methods for finding correlations was a slightly modified version of LDA (slightly modified to account for partial class membership). LDA consists of the following steps:

Fit a gaussian Gh to the gene expressions in the high sensitivity class Ch and a gaussian Gh to gene expressions in the low sensitivity class Cl, where |Ch| is the number of cell lines in the high sensitivity class, and |Cl| is the number of cell lines in the low sensitivity class.

Let Lexpr=expression of gene A in cell line L, Lsensitivity=sensitivity of cell line L to drug B

The mean of G1 is calculated as

sum from cell line L=1 to |Ch| of (Lsensitivity*Lexpr)/(sum of sensitivities in Ch)

Mean and variance of G1 were calculated in a similar way.

Pooled variance of Gh and Gl was calculated

avg. variance=(Ch variance*sum Ch sensitivities+Cl variance*sum Cl sensitivities)/(num cell lines−2−1)

We calculated the probability of a cell line, L, having high sensitivity as follows

P(L in Ch|Lexpr)=Gh(Lexpr)*P(Ch)/(Gh(Lexpr)*P(Ch)+(Gl(Lexpr)*P(Cl))

above is Equation 1

The error for this probability was calculated as

e=Lsensitivity−P(L in Ch|Lexpr).

Testing predictions:

For a given gene and drug we used cross-validation to test prediction of sensitivity from gene expression. Using 59 cell lines we determined gaussians Gh and G1 for the two sensitivity classes. We predicted the sensitivity class of the 60th cell line L, from its gene expression, using the Equation 1 above. We repeated this procedure for all of the 60 cell lines and calculated a mean squared error for all of the predictions. e=sum L=1 to 60 [P(L in Ch|Lexpr)−L sensitivity]\hat{ }2/60.

Searching for all correlations:

We applied the above method to all pairs of genes and drugs [1000 genes]×[90 drugs]

Using other methods:

1D discriminants

we also used 2 other methods similar to LDA, to search for correlations between sensitivity and gene expression

QDA—differs from LDA in that the original variances of Gh and Gl are used in Equation 1, instead of the average of the variances as a result, QDA can have nonlinear decision boundaries between classes while LDA has linear decision boundaries.

uniform/gaussian discriminant—similar to LDA except uses uniform distribution for the low class instead of a gaussian distribution, the assumption behind these distributions is that a specific mechanism is responsible for high sensitivity (the gaussian distribution), while various mechanisms lead to low sensitivity (uniform distribution), the height of the uniform is calculated as 1/(max(expr)−min(expr))

2D discriminants

The three methods above were extended to look for correlations between pairs of genes and drug sensitivities. For a given pair of genes, the joint distribution of gene expression values was represented by gaussians and uniform distributions. A search for correlations was conducted over all pairs of genes and all drugs. For each drug, the three methods were applied to about ½ million (gene,gene,drug) triples.

Calculating statistical significance (a likelihood threshold):

The statistical significance of MSE scores was determined by comparing against results from randomized data. Statistical significance was adjusted by the Bonferroni method to account for multiple tests. (i.e. for a given drug the statistical significance of a score from a 1D discriminant was multiplied by 1000; statistical significance of scores from 2D discriminants was multiplied by 10\hat{+5}).

To determine whether linear and nonlinear methods could capture different sets of gene expression-drug sensitivity correlations, we employed linear discriminant analysis (LDA) and two nonlinear methods, quadratic discriminant analysis (QDA) and a Bayesian model (a uniform/Gaussian discriminant). Results are shown in Table 3 below.

TABLE 3

| | Drugs | | Drugs | | Genes | | Genes | |
|---|---|---|---|---|---|---|---|---|
| | P <= 0.01 | | P <= 0.1 | | P <= 0.01 | | P <= 0.1 | |
| LDA-1D | 8 | (40%) | 29 | (53%) | 14 | (24%) | 43 | (18%) |
| QDA-1D | 4 | (20%) | 24 | (44%) | 5 | (8%) | 29 | (12%) |
| Bayes | 5 | (25%) | 25 | (45%) | 6 | (10%) | 34 | (14%) |
| mixture 1D | | | | | | | | |
| All 1 D | 13 | (65%) | 43 | (78%) | 20 | (34%) | 73 | (31%) |
| methods | | | | | | | | |
| LDA-2D | 9 | (45%) | 20 | (36%) | 24 | (41%) | 102 | (43%) |
| QDA-2D | 7 | (35%) | 22 | (40%) | 18 | (30%) | 84 | (35%) |
| Bayes | 4 | (20%) | 22 | (40%) | 9 | (15%) | 90 | (38%) |
| mixture 2D | | | | | | | | |
| All 2D | 16 | (80%) | 41 | (74%) | 48 | (81%) | 218 | (91%) |
| methods | | | | | | | | |
| Intersection | 0 | (0%) | 4 | (7%) | 0 | (0%) | 1 | (0.4%) |
| of all | | | | | | | | |
| methods | | | | | | | | |
| Union of all | 20 | (100%) | 55 | (100%) | 59 | (100%) | 239 | (100%) |
| methods | | | | | | | | |

Table 3 summarizes linear, nonlinear, 1D, and 2D analyses for 1000 genes, 90 drugs, and 60 cell lines. Shown are the numbers of statistically significant gene-drug associations found at p<=0.01 and p 21 =0.1. For example, the LDA-1D analysis method found that for each of 8 drugs, at least one gene out of a group of 14 was able to predict high sensitivity at p<=0.01. For LDA-2D, 24 genes arranged in pairs were able to predict high sensitivity to each of 9 drugs at p<=0.01.

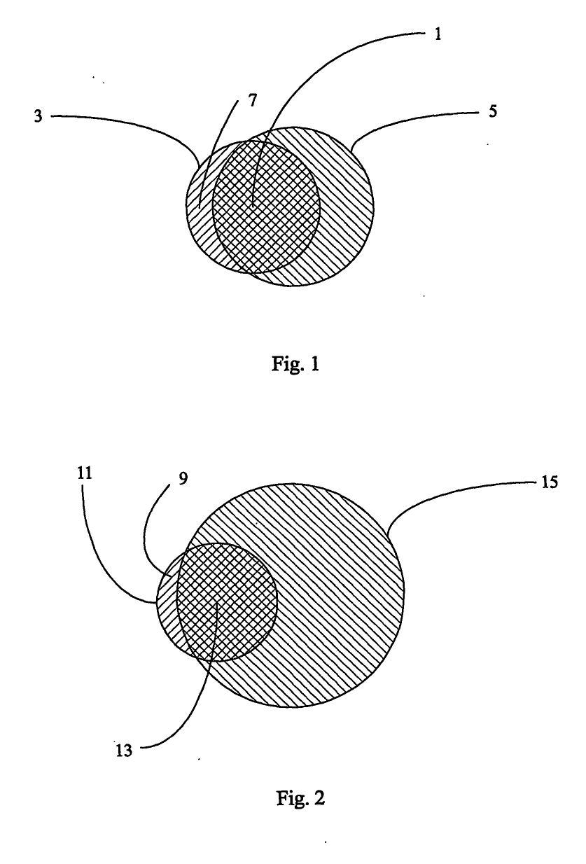

All three methods identified statistically significant correlations between the expression levels of specific genes and sensitivity to drugs based on GI50 values (drug concentration that inhibits cell growth by 50%). Although there was some overlap between the findings of the different methods, they were generally complementary to one another, as shown by the Venn diagrams of statistically significant results from all analysis methods in FIGS. 1 and 2. A degree of overlap occurs between results obtained; however, some of the gene-drug correlations were identified by a single method. As shown in FIG. 1, twenty-six drugs (represented by intersection 1) of the 29 drugs (represented by circle 3) found to be in significant correlations with genes by linear 1D methods (LDA 1D) were also identified by at least one other method in the non-linear and combinatorial methods that identified 52 drugs (represented by circle 5), leaving 3 drugs (represented by the non-intersecting portion 7 of circle 3) that were identified by LDA 1D alone. Similarly, as shown in FIG. 2, five genes (non-intersecting portion 9) out of 43 (circle 11) that were identified by LDA ID as markers for drug sensitivity were identified by that method alone, while the remaining 38 genes (intersection 13) were identified by at least one of the other methods in addition to LDA 1D out of a total of 234 genes (circle 15) that were identified by the other methods.

Nonlinear methods therefore identify gene-drug associations not found by a linear method. This is the case for both 1-dimensional (1D) analysis involving correlations between a single gene and one drug, and for 2D analysis involving correlations between pairs of genes and one drug (gene, gene, drug triples).

To discover correlations between gene expression levels and drug sensitivities that involve more than a single gene, (i.e., the information that predicts high sensitivity to a drug may be contained in the combination of expression patterns of two genes), we applied 2D discriminants. This involved using the same three methods described above for single genes, except that in this case we searched for significant correlations between pairs of genes and individual drugs, i.e., gene, gene, drug triples. Results for 2D methods are shown in Table 3 and FIGS. 1 and 2. The 2D methods discovered correlations that were not identified by the 1D method. It is evident from FIGS. 1 and 2 and Table 3 that relying only on single-gene (1D) correlations would have missed a large proportion of the gene-drug associations, since these required the information contained in pairs of genes; this was the case for all three correlation measures. Overall, the use of our combination of linear, nonlinear, 1D and 2D methods allowed for the discovery of 239 marker genes for high drug sensitivity, while sole reliance on the linear 1D method, LDA 1D, would have yielded only 43 markers, or fewer than 20% of the total. Each of the six methods identified gene-drug correlations not found by any of the other five methods. LDA 1D yielded only five gene markers not identified by at least one of the other methods. For QDA 1D, 1 gene was found by this method only. Uniform/gaussian 1D was the most effective of the 1D methods in this respect, yielding 9 genes correlated with high sensitivity found by this method only. By contrast, genes peculiar to each 2D method included (in pair combinations) 52 genes for LDA, 32 genes for QDA, and 49 genes for uniform/Gaussian.

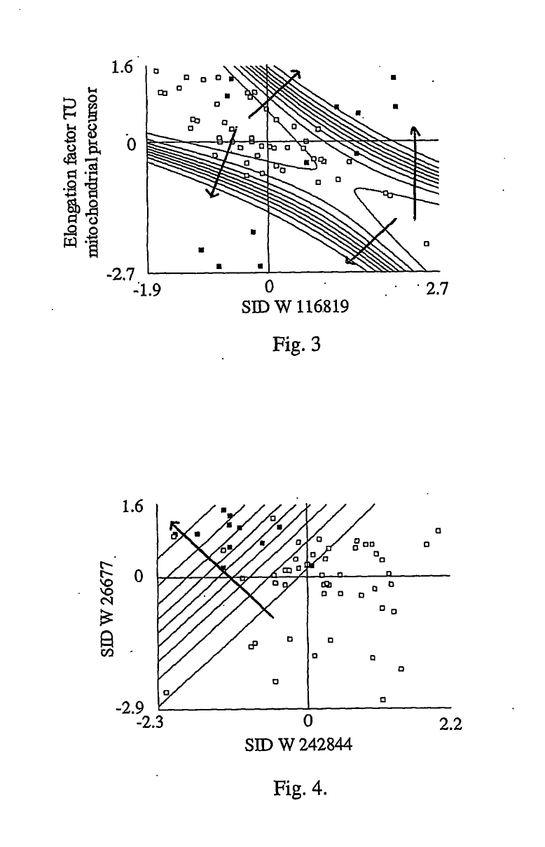

An example of the 2D approach is diagrammed in FIG. 3. Expression levels of the gene elongation factor TU are plotted vs. expression levels of the gene SID W 116819 for the 60 cell lines, whose sensitivities to fluorodopan varied. The areas mapped out by the Gaussian distributions separate most of the black (filled-in squares) points (highly sensitive) cell lines from the white (open squares) points Now sensitivity) cell lines, placing them in separate regions of the graph. Twelve cell lines with high sensitivity to fluorodopan (black points) had varying levels of expression for both genes 1 and 2. In FIG. 3, for either SID W 116819 or elongation factor TU alone, below zero (−) expression occurs in both high and low sensitivity cell lines; similarly, above zero (+) expression for each gene alone occurs in both high and low sensitivity cell lines. Therefore, neither gene alone correlates with sensitivity. However, the genes can be used in combination to obtain a correlation between gene expression and high drug sensitivity. Cell lines that are highly sensitive to fluorodopan (black points) tend to have greater than zero expression values for both genes (++), or below zero expression values for both genes (−−), while the combinations (+−) and (−+) tend to occur in cell lines that have low sensitivity to fluorodopan (white points).

(The use of + and − here is an oversimplification to describe the general distribution of black and white points on the graph in FIG. 3.)

FIGS. 3 through 6 depict 2D analysis of gene expression-drug sensitivity data for 60 cancer cell lines. FIG. 3 employs QDA analysis. Each point represents a cell line, with its location specified by the relative expression of two genes (x and y coordinates). The points are coloured by the cell line's response to Fluorodopan. The contours represent points of equal probability as predicted by the methods described herein. In general the areas where black squares tend to be concentrated are areas of predicted high sensitivity. The arrows indicate the direction of predicted increasing sensitivity. The outermost contour to the bottom left and top right show the decision surface generated by the two Gaussian distributions: outside the outermost contour are classified as high response and the between the gradients as low response. Expression levels of SID W 116819 alone are uncorrelated with sensitivity because a plus (+) can correspond to either high or low sensitivity, and a minus (−) can correspond to either high or low sensitivity; the same is true of elongation factor TU. However, as shown in Table 4 below, when either (+) or (−) co-occurs in both genes, sensitivity is high. When expression levels of SID W 116819and elongation factor TU have opposite signs, sensitivity is low. We therefore obtain a rule for the correlation of the pair of genes with fluorodopan sensitivity.

TABLE 4

| | elongation | |
|---|---|---|
| SID W 116819 | factor TU | Sensitivity |
| + | + | High |
| − | − | High |
| − | + | Low |
| + | − | Low |

Other examples for the 2D methods are shown in FIGS. 4, 5 and 6, and their respective Tables 5, 6 and 7 below.

Referring to FIG. 4, according to LDA 2D method, both SID W 242844 and SUD W 26677 are needed to predict high sensitivity to mitozolamide. For SID W 242844alone, (+) is associated with low sensitivity only, while (−) can be associated with low or high sensitivity. For SID W 26677, (−) is always associated with low, and (+) can correspond to either high or low sensitivity. However, the combination (−+) corresponds to high sensitivity only, so both genes are needed to establish a correlation with high sensitivity

TABLE 5

| SID W 242844 | SID W 26677 | Sensitivity |
|---|---|---|
| + | + | Low |
| − | − | Low |
| − | + | High |
| + | − | Low |

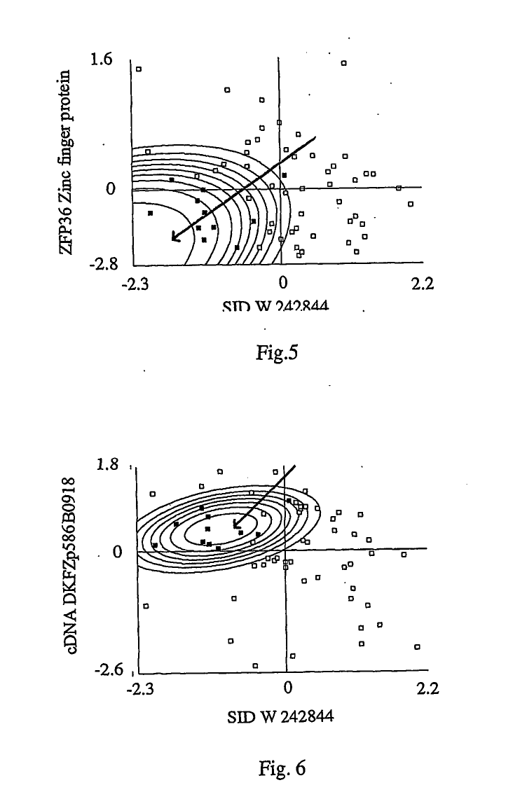

Referring to FIG. 5, according to QDA 2D method, both SID W 242844 and ZFP36 are needed to predict high sensitivity to mitozolamide. For SID W 242844, (−) can correspond to either high or low sensitivity, and (+) corresponds to low sensitivity. For ZFP36, (−) corresponds to either high or low, and (+) corresponds only to low sensitivity. However, the combination (−−) corresponds only to high sensitivity, so both genes are needed for the correlation.

TABLE 6

| SID W 242844 | ZFP36 | Sensitivity |
|---|---|---|
| + | + | Low |
| − | − | High |
| − | + | Low |
| + | − | Low |

Referring to FIG. 6, according to uniform/gaussian 2D, for the high sensitivity cell lines, expression of SID W 242844 tends to be negative (−), while expression of ESTs Chr.1 488132 tends to be positive (+). Both SID W 242844and human nucleotide binding protein are needed to predict high sensitivity to mitozolamide. For SID W 242844, (+) is always associated with low sensitivity, and (−) can be associated with either high or low. For ESTs Chr.1 488132, (−) is associated only with low, and (+) can correspond to either high or low. The combination (−+), however, is associated with high, while all other combinations predict low sensitivity. Therefore, both genes are needed to predict high sensitivity.

TABLE 7

| SID W 242844 | ESTs Chr.1 488132 | Sensitivity |
|---|---|---|
| + | + | Low |
| − | − | Low |
| − | + | High |
| + | − | Low |

Many of the results could not be classified easily as simple plus/minus distributions, but the concept of requiring a particular range of expression value combinations for each pair of genes applies in all cases shown for the 2D methods. In some cases, this range of values includes zero (no deviation in expression from mixed culture control). This is acceptable, since we are interested only in relative basal gene expression levels, not perturbed gene expression relative to the control. For example, a combination of approximately zero (0) expression for gene SID 289361 and positive (+) expression for gene SID 327435 correlated with high sensitivity to fluorouracil according to QDA 2D, in one case.

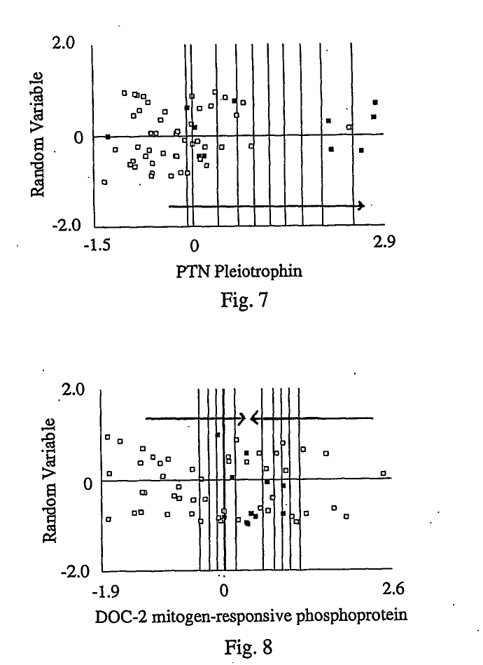

The 1D approach is shown in FIGS. 7 and 8. For single gene correlations, only the value on the x-axis (horizontal axis) is considered. A random variable was used to create a y-axis (vertical-axis) as a visual aid to avoid the problem of overlapping points. Referring to FIG. 7, according to LDA 1D, cell lines with high sensitivity to mitozolamide exhibited high levels of PTN expression. Referring to FIG. 8, Uniform/gaussian ID determined that cells with high sensitivity to mitozolamide expressed DOC-2 mitogen-responsive phosphoprotein in a particular range of values above control. Random variable on y-axis permits visualization of data points that would obscure one another in a one-dimensional graph.

In some instances, we found significant correlations between a gene and more than one drug. Generally, the drugs that correlated with a gene were from the same class, however, this was not always the case. Results are shown in previously set out Table 3.

We determined that certain levels of expression for specific genes are consistently associated with high sensitivity to drugs for cancer in 60 human cancer cell lines. Linear analysis methods alone were insufficient to identify many statistically significant correlations between basal gene expression and high sensitivity to drugs. In addition, we have demonstrated the need for 2D methods, as in many cases, combinations of genes contain the information required to establish correlations with drug sensitivity. This suggests that the physiological functions of cancer cells are often governed by the synergistic actions of multiple genes. These results are consistent with the idea that physiological systems are by nature complex, nonlinear systems, and should be analysed as such.

As shown in Table 3 (where Bayes mixture refers to the Uniform/Gaussian), every one of the six example methods, LDA, QDA, and Uniform/Gaussian each for 1D and 2D analyses, identified gene-drug correlations not discovered by any of the other five methods. This is especially true for the 2D methods. A combination of correlation techniques is appropriate for efficient interpretation of DNA microarray data.

The variability of cancer cell types poses two interrelated problems: 1) diagnosis, and 2) choice of treatment. Evidence has been found that the gene expression patterns of breast-derived cancer cell lines reflect those of the normal tissue of origin and of a breast-derived tumor, suggesting that cell lines may be useful in determining the gene expression patterns of in vivo cancer cells. If this is the case, it should be possible to use the results of large-scale studies of gene expression and drug responses in cancer cell lines to create databases of diagnostic markers for various cancers. Linear, nonlinear, and combinatorial analyses could be applied to determine those markers, and to suggest appropriate therapeutic drugs. As we have demonstrated in the present study, the use of nonlinear and combinatorial analyses in addition to linear, single-gene methods, increases the number of gene-drug associations, and therefore should improve the probability of determining appropriate drug therapies.

Markers identified by these computational methods could be used as the basis for diagnostic tests specific for those genes, perhaps in the form of smaller-scale microarray assays. Tests such as these would be aimed directly toward determination of the best choice(s) for therapeutic drug treatment. For example, a diagnostic test indicating high expression levels for both genes elongation factor TU and SID W 116819 (FIG. 3) would suggest a high probability of a response to fluorodopan treatment.

The present study focused on basal gene expression patterns as indicators of drug sensitivity.

In carrying out the embodiment described above for the NCI60 dataset, we computationally distinguish strong from weak biological responses (i.e., to discriminate, classify, or predict biological responses). In its details, the method employs computationally-derived associations between computationally-analyzed quantitative gene expression data and computationally-analyzed quantitative intensity data. The intensity data represents observables (other than gene expression) assumed to be related in some arbitrary, but graded, manner to the biological responses.

We used a “biological response scoring function,” called f, where f:U→R¹⊂[0,1], and U is a 1-parameter continuous path in R^{m}, m >1. f is constructed to represent biological response on a bounded ordinal scale of real numbers, where

f=0 is interpreted to mean “no or negligible biological response”;

f=1 is interpreted to mean “very substantial, strong, or high biological response”;

0<f<1 is interpreted to mean “biological response somewhere between negligible and substantial in proportion to proximity to 0 or 1, respectively.” Formally, the domain U of f is defined to be a 1-parameter continuous path in m-dimensional space. E.g., U can simply be scalar, i.e., U⊂R¹; or U can be an arbitrary 1-parameter path through higher-dimensional space R^{m}, m>1 (e.g., a series of m-dimensional feature vectors indexed by continuous time). Note: The examples provided here concentrate on the scalar domain case ( i.e., U⊂R¹), but the approach also applies to cases of higher-dimensional continuous 1 -parameter paths.

Domain U⊂R¹ is interpreted to mean:

“degree or intensity of external effect on the biology” either on an increasing or decreasing scale.

### EXAMPLES

U represents drug dose (absolute concentration or dose relative to some standard dose) along an increasing, or decreasing, scale;

U can represent the dose of drug which causes half-maximal cellular growth rate as charted along a scale which decreases to the right;

U represents -logarithm₁₀(dose), where dose is the dose which yields half-maximal total cell mass accumulating in a chemostat under otherwise standard conditions (e.g., let r⊂U such that r=−log GI50=−logarithm₁₀(GI50), where GI50=drug dose which yields 50% of the cellular mass which is achieved under some standard untreated-with-drug conditions.

Note that in this last example, r increases as GI50 decreases. In this case, an increasing r represents a decreasing “intensity of dose needed to obtain some defined biological effect.”

The function f assigns a readily interpretable numerical “biological response score” in the continuous interval [0,1] to a “degree or intensity of external effect on biology” from a scale U⊂R¹. Thus, f is what inexorably links “intensity of external effect on biology” to a readily interpreted biological response scale, where the interpretations of f values are given in 1a) above.

### Example (Continuous Piece-Wise Linear Biological Scoring Function)

$$Let f ( r ) = \{ \begin{matrix}0 , r < 0.7 \\ ( r - 0.7 ) / 0.3 , r ∈ [ 0.7 , 1 ) , where r = - log GI50 = - {logarithm}_{10} ( GI50 ) . \\ 1 , r \geq 1\end{matrix}$$

Interpretations:

If the dose required to achieve some biological effect (say, 50% growth inhibition) is small, then score this phenomenon as “strong biological response”, i.e., “cells are very sensitive.” In f (r) terms, if GI50≦0.1 (i.e., −log(GI50)≧1), then f=1.

If the dose required to achieve some biological effect (say, 50% growth inhibition) is large, then score this phenomenon as “weak biological response”, i.e., “cells are very insensitive.” In f (r) terms, if GI50≧0.2 (i.e., −log(GI50)≦0.7), then f=0.

If the dose required to achieve some biological effect (say, 50% growth inhibition) is modest or a some gradation between low and high, then score this phenomenon as “mixed-strength biological response”, i.e., “cells are somewhat sensitive and/or somewhat insensitive.” In f (r) terms, if 0.2≧GI50>0.1 (i.e., 0.7≦−log(GI50)<1), then f=(r−0.7)/0.3.

### Example (Smooth Biological Scoring Function)

$$\begin{matrix}Let {f}_{sigmoid} ( r ) = 1 - {( 1 + {( \frac{r - a}{b - a} )}^{v} )}^{- 1} , r \geq a , b > a \geq 0 , v > 1 , \\ {f}_{sigmoid} ( r ) = 1 - {( 1 + {( \frac{a - r}{b - a} )}^{v} )}^{- 1} , r < a , b > a \geq 0 , v > 1\end{matrix}$$

where r=−log GI50=−logarithm₁₀(GI50)

Let:

i denote, or label, any given external effect, or situation, on the biology, e.g., temperature, pH, therapeutic intervention, compound applied, drug dosed, etc. (For explanatory convenience, for now on we often refer to any external effect on the biology as “drug.”)

j denote any biological source of gene expression data, e.g., patient, tissue, cultured cell line, etc. (For explanatory convenience, for now on we often refer to any biological source of expression data as “cell line.”)

k denote, or label, any given gene, mRNA species, gene product, or protein. (For explanatory convenience, for now on we often refer to any of these entities as “gene.”)

gₖ^{l} denote, or label, gene abundance or expression level, however numerically adjusted or normalized, of gene k in cell line j.

a represent, or label, any desired categorical description of biological response score. E.g., a=any of “high”, “strong”, “sensitive/insensitive”, etc. if f=1; e.g. a=any of “low”, “weak”, “insensitive”, etc., if f=0; e.g., a =any of “middle”, “modest”, “mixed sensitive/insensitive”, etc. if 0<f<1.

w represent, or label, generally the biological response score (i.e., f value) of any biological source under any external effect or situation, e.g., the sensitivity of a cell line to a drug.

w^{i,j} specifically denote, or label, the biological response score (i.e., f value) of biological source j under any external effect or situation i, e.g., f value of cell line j under some specified exposure to drug i.

wₐ^{i,j} specifically denote, or label, the biological response score (i.e., f value) which falls in some particular category a (e.g., a=sensitive) of biological source j under any external effect or situation i, e.g., wₛₑₙₛᵢₜᵢᵥₑ ^{i,j} means the f value is 1 for cell line j under some specified exposure to drug i.

Cₐⁱ denote the set of biological sources falling in biological response category a when the biological source is external effect i. E.g., Cₛₑₙₛᵢₜᵢᵥₑⁱ is the set comprising cell lines for which the respective f values are 1 when exposed to drug i at some specified dose, i.e., the set of cell lines sensitive to drug i.

|Cₐⁱ| denote the cardinality of Cₐⁱ, i.e., the number of elements in set Cₐⁱ. E.g.,

|Cₛₑₙₛᵢₜᵢᵥₑⁱ|=23, means that for the collection of cell lines considered, there are 23 cell lines that are sensitive to drug i.

For any given external biological effect i (e.g., drug i administered by some specified dosing regime), and for any gene k, . . .

Compute a category-wise data-summarizing mathematical, statistical, machine learning-based, data mining-based, or empirical, etc. entities. For example:

Compute histogram comprising gₖⁱ, for given k, for jεCₐⁱ. E.g., histogram of abundances of gene k from all the cell lines sensitive to drug i.

Compute parameters necessary to fit any chosen mathematical density function or continuous curve to a a category-wise histogram of the type described in 3a.1 above. E.g., in preparation for fitting a gaussian distribution to {gₖ^{j}}, jεCₛₑₙₛᵢₜᵢᵥₑⁱ, compute parameters that are the cell line sensitivity-weighted gene k sample mean ᵢ\overline{g}ₖ^{sensitive} and variance s²ᵢgₖ^{sensitive}, where

$$\begin{matrix}{}_{i}^{}{\overline{g}}{}_{k}^{sensitive} = {w}^{i , j} {g}_{k}^{j} / {\sum }_{j} {w}^{i , j} , j ∈ {C}_{sensitive}^{i} \\ {{s}^{2}}_{i} {\overline{g}}_{k}^{sensitive} = {{w}^{i , j} ( {g}_{k}^{j} - {}_{i}^{}{\overline{g}}{}_{k}^{} )}^{2} / {\sum }_{j} {w}^{i , j} , j ∈ {C}_{sensitive}^{i}\end{matrix}$$

Compute a category-wise average data-summarizing parameters. E.g., sensitive\insensitive average variance are, respectively,

$$\begin{matrix}⟨ {s}^{2} {}_{i}^{}{g}{}_{k}^{} ⟩ = ( {s}^{2} {}_{i}^{}{g}{}_{k}^{sensitive} {\sum }_{{j}^{′}} {w}^{i , {j}^{′}} + {s}^{2} {}_{i}^{}{g}{}_{k}^{insensitive} {\sum }_{\hat{j}} {w}^{i , \hat{j}} ) / \\ ( {\sum }_{{j}^{′}} {w}^{i , {j}^{′}} + {\sum }_{\hat{j}} {w}^{i , \hat{j}} ) ,\end{matrix}$$

where j′εCₛₑₙₛᵢₜᵢᵥₑⁱ and ĵεCₛₑₙₛᵢₜᵢᵥₑⁱ

σₖ^{avg}=the square root of the average variance.

For all a categories of interest, compute a category-wise data-summarizing mathematical, statistical, machine learning-based, data mining-based, or empirical, etc. entities based on any of the a category-wise average data-summarizing parameters such as those examples described above. For example:

Compute a gaussian summarizing entity ᵢGₖ^{sensitive} for gene k in the cell lines sensitive to drug i, i.e., ᵢGₖ^{sensitive} (g, μ, σ)=(σ\sqrt{2π})⁻¹ exp(−(g−μ)²/(2σ²)) where

μ=ᵢ\overline{g}ₖ^{sensitive} and σ=\sqrt{s²ᵢgₖ^{sensitive}},

and compute analogous ᵢGₖ^{insensitive}.

Compute discriminators, classifiers, and predictors of a , the category-wise biological response to external event i, but based on information computed from a given gene k. In these computations, we employ as needed any of the preparatory computations described above. For example:

Compute a Bayesian probability P(jεCₐⁱ|gₖ^{j}) that a cell line j is in biological response category a due to biological effect i, given the gene k abundance in cell line j, e.g.,

$$P ( j ∈ {C}_{i}^{α} \vert {g}_{k}^{j} ) = \frac{{}_{i}^{}{G}{}_{k}^{α} ( {g}_{k}^{j} ) \cdot P ( {C}_{i}^{α} )}{{\sum }_{α} {}_{i}^{}{G}{}_{k}^{α} ( {g}_{k}^{j} ) \cdot P ( {C}_{i}^{α} )}$$

ᵢGₖ^{a} (gₖ^{j})=probability of abundance value gₖ^{j} from the gaussian density fitted to the histogram of the gene k abundances over the cell lines in response category a when subjected to biological effect i.

A probability difference for the above probability is also computed, e.g.,

$${difference}_{Bayesian} = \vert P ( j ∈ {C}_{i}^{α} \vert {g}_{k}^{j} ) - {w}^{i , j} / {\sum }_{j} {w}^{i , j} \vert , j ∈ {C}_{i}^{α} .$$

Note: Importantly, difference_{Bayesian is the difference between ‘the predicted probability that cell line j is in the category a as computed from the gene k abundances across cell lines’ and ‘the observed probability that cell line j is in category a as computed from the effects of biological effect i on the cell lines’.}

As described below the determination of the likelihood of a co-occurrence was calculated using a number of differing methods, namely:

Uniform\Gaussian Discriminant Analysis—1-dimensional (UGDA 1D)

Uniform\Gaussian Discriminant Analysis—2-dimensional (UGDA 2D)

Linear Discriminant Analysis—1-dimensional (LDA 1D)

Quadratic Discriminant Analysis—1-dimensional (QDA 1D)

Linear Discriminant Analysis—2-dimensional (LDA 2D)

Quadratic Discriminant Analysis—2-dimensional (QDA 2D)

Uniform\Gaussian Discriminant Analysis—1-dimensional (UGDA 1D)

This method computes a Bayesian conditional probability P(jεCᵢ^{sensitive}|gₖ^{j}) that a cell line j is sensitive to drug i, given the gene k abundance gₖ^{j} in cell line j.

The probability is computed using the following equation:

$$P ( j ∈ {C}_{i}^{sensitive} \vert {g}_{k}^{j} ) = \frac{{}_{i}^{}{G}{}_{k}^{sensitive} ( {g}_{k}^{j} ) \cdot P ( {C}_{i}^{sensitive} )}{\begin{matrix}{}_{i}^{}{G}{}_{k}^{sensitive} ( {g}_{k}^{j} ) \cdot P ( {C}_{i}^{sensitive} ) + \\ {}_{i}^{}{U}{}_{k}^{} ( {g}_{k}^{j} ) \cdot P ( {C}_{i}^{insensitive} )\end{matrix}}$$

where

P(Cᵢ^{sensitive})=prior probability of the sensitive set=|Cᵢ^{sensitive}|/(|C₁^{sensitive}|+|Cᵢ^{insensitive}|),

P(Cᵢ^{insensitive})=prior probability of the insensitive set=|Cᵢ^{insensitive}|/(|Cᵢ^{sensitive}|+|Cᵢ^{insensitive}|),

ₜGₖ^{sensitive}(gₖ^{j})=probability of abundance value gₖ^{j} from the gaussian density fitted to the histogram of the gene k abundances over the sensitive cell lines when subjected to drug i.

$${}_{i}^{}{G}{}_{k}^{sensitive} ( {g}_{k}^{j} ) = \frac{1}{{σ}_{k}^{sen} \sqrt{2 π}} {ⅇ}^{- {( {g}_{k}^{j} - {μ}_{k}^{sen} )}^{2} / 2 {( {σ}_{k}^{sen} )}^{2}} ,$$

where

μₖ^{sen}=mean of gene k abundances in the sensitive cell lines, jεCₛₑₙₛᵢₜᵢᵥₑ ⁱ

σₖ^{sen}=standard deviation of gene k abundances in the sensitive cell lines, jεCₛₑₙₛᵢₜᵢᵥₑⁱ

ᵢUₖ(gₖ^{j})=probability of abundance value gₖ^{j} from the uniform density fitted to the gene k abundances over all cell lines when subjected to drug i. For a given gene k, this value is constant across all cell lines, j, i.e.,

$${}_{i}^{}{U}{}_{k}^{} ( {g}_{k}^{j} ) = \frac{1}{max ( {g}_{k} ) - min ( {g}_{k} )}$$

where

max(gₖ)=maximum abundance of gene k over all cell lines

min(gₖ)=minimum abundance of gene k over all cell lines

Sample parameters for the UGDA 1D for the NCI60 dataset are:

Rule 1 Gene: SID W 376472 Homo sapiens clone 24429 mRNA sequence [5′:AA041443 3′:AA041360]

Drug: Inosine-glycodialdehyde

Parameters:

μₖ^{sen}=−0.4394, σₖ^{sen}=0.4217

ᵢUₖ(gₖ^{j})=0.2538

P(Cᵢ^{sensitive})=0.1978, P(Cᵢ^{insensitive})=0.8022

Rule 2

Gene: Human clone 23665 mRNA sequence Chr.17 [488020 (IW) 5′:AA054745 3′:AA054747]

Drug: Dolastatin-10

Parameters:

μₖ^{sen}=−0.7752, σₖ^{sen}=0.4217

ᵢUₖ(gₖ^{j})=0.2347

P(Cᵢ^{sensitive})=0.135, P(Cᵢ^{insensitive})=0.865

Rule 3

Gene: SID W 469272 Epidermal growth factor receptor [5′:AA026175 3′:AA026089]

Drug: Dichloroallyl-lawsone

Parameters:

μₖ^{sen}=−0.2886, σₖ^{sen}=0.4416

ᵢUₖ(gₖ^{j})=0.2299

P(Cᵢ^{sensitive})=0.2172, P(Cᵢ^{insensitive})=0.7828

Rule 4

Gene: ESTs Chr.1 [488132 (IW) 5′:AA047420 3′:AA047421]

Drug: N-phosphonoacetyl-L-aspartic-ac

Parameters:

μₖ^{sen}=0.2863, σₖ^{sen}=0.3651

ᵢUₖ(gₖ^{j})=0.241

P(Cᵢ^{sensitive})=0.2583, P(Cᵢ^{insensitive})=0.7417

Rule 5

Gene: LBR Lamin B receptor Chr.1 [307225 (IW) 5′:W21468 3′:N93426]

Drug: Pyrazofurin

Parameters:

μₖ^{sen}=0.4077, σₖ^{sen}=0.4993

ᵢUₖ(gₖ^{j})=0.237

P(Cᵢ^{sensitive})=0.2594, P(Cᵢ^{insensitive})=0.7406

Rule 6

Gene: SID W 305455 TRANSCRIPTIONAL REGULATOR ISGF3 GAMMA SUBUNIT [5′:W39053 3′:N89796]

Drug: Cyanomorpholinodoxorubicin

Parameters:

μₖ^{sen}=0.4419, σₖ^{sen}=0.3505

ᵢUₖ(gₖ^{j})=0.2326

P(Cᵢ^{sensitive})=0.2067, P(Cᵢ^{insensitive})=0.7933

Rule 7

Gene: SID 429145 Human nicotinamide N-methyltransferase (NNMF) mRNA complete cds [5′: 3′:AA004839]

Drug: Semustine (MeCCNU)

Parameters:

μₖ^{sen}=0.2891, σₖ^{sen}=0.398

ᵢUₖ(gₖ^{j})=0.3155

P(Cᵢ^{sensitive})=0.1606, P(Cᵢ^{insensitive})=0.8394

Rule 8

Gene: SID W 242844 ESTs Moderately similar to !!!! ALU SUBFAMILY J WARNING ENTRY !!!! [H.sapiens] [5′:H94138 3′:H94064]

Drug: Mitozolamide

Parameters:

μₖ^{sen}=−1.008, σₖ^{sen}=0.5668

ᵢUₖ(gₖ^{j})=0.2381

P(Cᵢ^{sensitive})=0.2006, P(Cᵢ^{insensitive})=0.7994

Rule 9 Gene: *Homo sapiens lysosomal neuraminidase precursor mRNA complete cds SID W 487887 Hexabrachion (tenascin C cytotactin) [5′:AA046543 3′:AA045473]

Drug: Mitozolamide

Parameters:

μₖ^{sen}=0.8444, σₖ^{sen}=0.5358

ᵢUₖ(gₖ^{j})=0.2597

P(Cᵢ^{sensitive})=0.2006, P(Cᵢ^{insensitive})=0.7994

Rule 10

Gene: ESTs Chr.1 [488132 (1W) 5′:AA047420 3′:AA047421]

Drug: Mitozolamide

Parameters:

μₖ^{sen}=0.4755, σₖ^{sen}=0.3355

ᵢUₖ(gₖ^{j})=0.241

P(Cᵢ^{sensitive})=0.2006, P(Cᵢ^{insensitive})=0.7994

Rule 11

Gene: Human mitogen-responsive phosphoprotein (DOC-2) mRNA complete cds Chr.5 [428137 (IE) 5′: 3′:AA001933]

Drug: Mitozolamide

Parameters:

μₖ^{sen}=0.3967, σₖ^{sen}=0.3587

ᵢUₖ(gₖ^{j})=0.2342

P(Cᵢ^{sensitive})=0.2006, P(Cᵢ^{insensitive})=0.7994

Rule 12

Gene: SID W 345420 Homo sapiens YAC clone 136A2 unknown rRNA 3′untranslated region [5′:W76024 3′:W72468]

Drug: Mitozolamide

Parameters:

μₖ^{sen}=0.7456, σₖ^{sen}=0.5579

ᵢUₖ(gₖ^{j})=0.2625

P(Cᵢ^{sensitive})=0.2006, P(Cᵢ^{insensitive})=0.7994

Rule 13

Gene: CDH2 Cadherin 2 N-cadherin (neuronal) Chr. [325182 (DIRW) 5′:W48793 3′:W49619]

Drug: Mitozolamide

Parameters:

μₖ^{sen}=0.6581, σₖ^{sen}=0.3744

ᵢUₖ(gₖ^{j})=0.2564

P(Cᵢ^{sensitive})=0.2006, P(Cᵢ^{insensitive})=0.7994

Rule 14

Gene: SID W 280376 ESTs Highly similar to CELL CYCLE PROTEIN KINASE CDC5/MSD2 [Saccharomyces cerevisiae] [5′:N50317 3′:N47107]

Drug: Mitozolamide

Parameters:

μₖ^{sen}=0.7347, σₖ^{sen}=0.4233

ᵢUₖ(gₖ^{j})=0.177

P(Cᵢ^{sensitive})=0.2006, P(Cᵢ^{insensitive})=0.7994

Rule 15

Gene: Human mRNA for reticulocalbin complete cds Chr. 11 [485209 (1W) 5′:AA039292 3′:AA039334]

Drug: Cyclodisone

Parameters:

μₖ^{sen}=0.6598, σₖ^{sen}=0.2562

ᵢUₖ(gₖ^{j})=0.1672

P(Cᵢ^{sensitive})=0.1689, P(Cᵢ^{insensitive})=0.8311

Rule 16

Gene: SID W 345420 Homo sapiens YAC clone 136A2 unknown mRNA 3′untranslated region [5′:W76024 3′:W72468]

Drug: Clomesone

Parameters:

μₖ^{sen}=0.7165, σₖ^{sen}=0.4394

ᵢUₖ(gₖ^{j})=0.2625

P(Cᵢ^{sensitive})=0.1917, P(Cᵢ^{insensitive})=0.8083

Rule 17

Gene: SID 289361 ESTs [5′:N99589 3′:N92652]

Drug: Fluorouracil (5FU)

Parameters:

μₖ^{sen}=0.03614, σₖ^{sen}=0.186

ᵢUₖ(gₖ^{j})=0.2252

P(Cᵢ^{sensitive})=0.1628, P(Cᵢ^{insensitive})=0.8372

Rule 18

Gene: SID 43555 MALATE OXIDOREDUCTASE [5′:H13370 3′:H06037]

Drug: Fluorouracil (5FU)

Parameters:

μₖ^{sen}=0.9686, σₖ^{sen}=0.4053

ᵢUₖ(gₖ^{j})=0.241

P(Cᵢ^{sensitive})=0.1628, P(Cᵢ^{insensitive})=0.8372

Rule 19

Gene: H.sapiens mRNA for Gal-beta(1-3/1-4)GlcNAc alpha-2.3-sialyltransferase Chr.11 [324181 (IW) 5′:W47425 3′:W47395]

Drug: Fluorouracil (5FU)

Parameters:

μₖ^{sen}=0.3532, σₖ^{sen}=0.2383

ᵢUₖ(gₖ^{j})=0.2488

P(Cᵢ^{sensitive})=0.1628, P(Cᵢ^{insensitive})=0.8372

Rule 20

Gene: ESTs Moderately similar to ZINC-BINDING PROTEIN A33 [Pleurodeles waltl] Chr.16 [25718 (RW) 5′:R12025 3′:R37093]

Drug: Fluorodopan

Parameters:

μₖ^{sen}=0.542, σₖ^{sen}=0.2812

ᵢUₖ(gₖ^{j})=0.2079

P(Cᵢ^{sensitive})=0.2061, P(Cᵢ^{insensitive})=0.7939

Rule 21

Gene: SID 470501 ESTs [5′:AA031743 3′:AA031652]

Drug: Asaley

Parameters:

μₖ^{sen}=0.7867, σₖ^{sen}=0.4327

ᵢUₖ(gₖ^{j})=0.1869

P(Cᵢ^{sensitive})=0.1878, P(Cᵢ^{insensitive})=0.8122

Rule 22

Gene: SID 307717 Homo sapiens KIAA0430 mRNA complete cds [5′: 3′:N92942]

Drug: Cyclocytidine

Parameters:

μₖ^{sen}=0.004825, σₖ^{sen}=0.232

ᵢUₖ(gₖ^{j})=0.1835

P(Cᵢ^{sensitive})=0.2533, P(Cᵢ^{insensitive})=0.7467

Rule 23

Gene: SID W 122347 ESTs [5′:T99193 3′:T99194]

Drug: Oxanthrazole (piroxantrone)

Parameters:

μₖ^{sen}=−0.09888, σₖ^{sen}=0.6153

ᵢUₖ(gₖ^{j})=0.2198

P(Cᵢ^{sensitive})=0.1956, P(Cᵢ^{insensitive})=0.8044

Rule 24

Gene: SID W 429290 ESTs [5′:AA007457 3′:AA007361]

Drug: Oxanthrazole piroxantrone)

Parameters:

μₖ^{sen}=0.6229, σₖ^{sen}=0.3177

ᵢUₖ(gₖ^{j})=0.2352

P(Cᵢ^{sensitive})=0.1956, P(Cᵢ^{insensitive})=0.8044

Rule 25

Gene: ALDOC Aldolase C fructose-bisphosphate Chr.17 [229961 (IW) 5′:H67774 3′:H67775]

Drug: Anthrapyrazole-derivative

Parameters:

μₖ^{sen}=−0.2373, σₖ^{sen}=0.3786

ᵢUₖ(gₖ^{j})=0.2049

P(Cᵢ^{sensitive})=0.2006, P(Cᵢ^{insensitive})=0.7994

Rule 26

Gene: SID W 381819 Plastin 1 (I isoform) [5′:AA059293 3′:AA059061]

Drug: Teniposide

Parameters:

μₖ^{sen}=0.05147, σₖ^{sen}=0.3839

ᵢUₖ(gₖ^{j})=0.2101

P(Cᵢ^{sensitive})=0.1894, P(Cᵢ^{insensitive})=0.8106

Rule 27

Gene: SID W 345683 ESTs Highly similar to INTEGRAL MEMBRANE GLYCOPROTEIN GP210 PRECURSOR [Rattus norvegicus] [5′:W76432 3′:W72039]

Drug: Daunorubicin

Parameters:

μₖ^{sen}=0.918, σₖ^{sen}=0.3704

ᵢUₖ(gₖ^{j})=0.2762

P(Cᵢ^{sensitive})=0.1811 P(Cᵢ^{insensitive})=0.8189

Rule 28

Gene: SID 234072 EST Highly similar to RETROVIRUS-RELATED POL POLYPROTEIN [Homo sapiens] [5′: 3′:H69001]

Drug: Aphidicolin-glycinate

Parameters:

μₖ^{sen}=−0.3626, σₖ^{sen}=0.4252

ᵢUₖ(gₖ^{j})=0.207

P(Cᵢ^{sensitive})=0.1994 P(Cᵢ^{insensitive})=0.8006

Rule 29

Gene: SID 50243 ESTs [5′:H17681 3′:H17066]

Drug: CPT,10-OH

Parameters:

μₖ^{sen}=0.8677, σₖ^{sen}=0.5387

ᵢUₖ(gₖ^{j})=0.2653

P(Cᵢ^{sensitive})=0.1856 P(Cᵢ^{insensitive})=0.8144

Rule 30

Gene: SID W 346587 Homo sapiens quiescin (Q6) mRNA complete cds [5′:W79188 3′:W74434]

Drug: CPT,10-OH

Parameters:

μₖ^{sen}=1.001, σₖ^{sen}=0.6123

ᵢUₖ(gₖ^{j})=0.2358

P(Cᵢ^{sensitive})=0.1856, P(Cᵢ^{insensitive})=0.8144

Rule 31

Gene: SID W 361023 ESTs [5′:AA013072 3′:AA012983]

Drug: CPT,10-OH

Parameters:

μₖ^{sen}=−0.8339, σₖ^{sen}=0.6084

ᵢUₖ(gₖ^{j})=0.2222

P(Cᵢ^{sensitive})=0.1856, P(Cᵢ^{insensitive})=0.8144

Rule 32

Gene: SID W 488148 H.sapiens mRNA for 3′UTR of unknown protein [5′:AA057239 3′:AA058703]

Drug: CPT

Parameters:

μₖ^{sen}=0.8224, σₖ^{sen}=0.5588

ᵢUₖ(gₖ^{j})=0.2577

P(Cᵢ^{sensitive})=0.2594, P(Cᵢ^{insensitive})=0.7406

Rule 33

Gene: SID W 159512 Integrin alpha 6 [5′:H16046 3′:H15934]

Drug: CPT

Parameters:

μₖ^{sen}=0.7291, σₖ^{sen}=0.6557

ᵢUₖ(gₖ^{j})=0.2571

P(Cᵢ^{sensitive})=0.2594, P(Cᵢ^{insensitive})=0.7406

Rule 34

Gene: SID W 429290 ESTs [5′:AA007457 3′:AA007361]

Drug: CPT

Parameters:

μₖ^{sen}=0.7084, σₖ^{sen}=0.4576

ᵢUₖ(gₖ^{j})=0.2532

P(Cᵢ^{sensitive})=0.2594, P(Cᵢ^{insensitive})=0.7406

Rule 35

Gene: ESTs Chr.5 [487396 (IW) 5′:AA046573 3′:AA046660]

Drug: CPT

Parameters:

μₖ^{sen}=0.6068, σₖ^{sen}=0.3836

ᵢUₖ(gₖ^{j})=0.1848

P(Cᵢ^{sensitive})=0.2594, P(Cᵢ^{insensitive})=0.7406

Rule 36

Gene: SID W 361023 ESTs [5′:AA013072 3′:AA012983]

Drug: CPT,20-ester (S)

Parameters:

μₖ^{sen}=−0.6333, σₖ^{sen}=0.554

ᵢUₖ(gₖ^{j})=0.2222

P(Cᵢ^{sensitive})=0.255, P(Cᵢ^{insensitive})=0.745

Rule 37

Gene: SID W 125268 H.sapiens mRNA for human giant larvae homolog [5′:R05862 3′:R05776]

Drug: CPT,20-ester (S)

Parameters:

μₖ^{sen}=−0.4871, σₖ^{sen}=0.5365

ᵢUₖ(gₖ^{j})=0.266

P(Cᵢ^{sensitive})=0.2844, P(Cᵢ^{insensitive})=0.7156

Rule 38

Gene: SID W 361023 ESTs [5′:AA013072 3′:AA012983]

Drug: CPT,20-ester (S)

Parameters:

μₖ^{sen}=−0.608, σₖ^{sen}=0.5756

ᵢUₖ(gₖ^{j})=0.2222

P(Cᵢ^{sensitive})=0.2844, P(Cᵢ^{insensitive})=0.7156

Rule 39

Gene: SID W 125268 H.sapiens mRNA for human giant larvae homolog [5′:R05862 3′:R05776]

Drug: Chlorambucil

Parameters:

μₖ^{sen}=−0.4569, σₖ^{sen}=0.4595

ᵢUₖ(gₖ^{j})=0.266

P(Cᵢ^{sensitive})=0.2206, P(Cᵢ^{insensitive})=0.7794

Rule 40

Gene: SID 381780 ESTs [5′:AA059257 3′:AA059223]

Drug: Paclitaxel—Taxol

Parameters:

μₖ^{sen}=0.1618, σₖ^{sen}=0.1828

ᵢUₖ(gₖ^{j})=0.2053

P(Cᵢ^{sensitive})=0.1622, P(Cᵢ^{insensitive})=0.7794

Uniform\Gaussian Discriminant Analysis—2-dimensional (UGDA 2D)

This method computes a Bayesian conditional probability P(jεCᵢ^{sensitive}|gₖ^{j},gᵢ^{j}) that a cell line j is sensitive to drug i, given the abundances of two genes k and i, gₖ^{j} and gᵢ^{j}, respectively, in cell line j.

The probability is computed using the following equation:

$$P ( j ∈ {C}_{i}^{sensitive} \vert {g}_{k}^{j} , {g}_{l}^{j} ) = \frac{{}_{i}^{}{G}{}_{k , l}^{sensitive} ( {g}_{k}^{j} , {g}_{l}^{j} ) \cdot P ( {C}_{i}^{sensitive} )}{\begin{matrix}{}_{i}^{}{G}{}_{k , l}^{sensitive} ( {g}_{k}^{j} , {g}_{l}^{j} ) \cdot P ( {C}_{i}^{sensitive} ) + \\ {}_{i}^{}{U}{}_{k , l}^{} ( {g}_{k}^{j} , {g}_{l}^{j} ) \cdot P ( {C}_{i}^{insensitive} )\end{matrix}} ,$$

where

P(Cᵢ^{sensitive})=prior probability of the sensitive set=|Cᵢ^{sensitive}|/(|Cᵢ^{sensitive}|+|Cᵢ^{insensitive}|),

P(Cᵢ^{insensitive})=prior probability of the insensitive set=|Cᵢ^{insensitive}|/(|Cᵢ^{sensitive}|+|Cᵢ^{insensitive}|),

ᵢG_{k,l}^{sensitive}(gₖ^{j},gᵢ^{j})=joint probability of abundance values gₖ^{j} and gᵢ^{j} from the bivariate gaussian density fitted to the histogram of gene k and l abundances over the sensitive cell lines when subjected to drug i.

ᵢG_{k,l}^{sensitive}(gₖ^{j},gᵢ^{j})=

$${}_{i}^{}{G}{}_{k , l}^{sensitive} ( {g}_{k}^{j} , {g}_{l}^{j} ) = \frac{1}{2 π {σ}_{k}^{sen} {σ}_{l}^{sen} \sqrt{1 - {( {ρ}_{k , l}^{sen} )}^{2}}} exp \{ \frac{- [ {( \frac{{g}_{k}^{j} - {μ}_{k}^{sen}}{{σ}_{k}^{sen}} )}^{2} - 2 {ρ}_{k , l}^{sen} ( \frac{{g}_{k}^{j} - {μ}_{k}^{sen}}{{σ}_{k}^{sen}} ) ( \frac{{g}_{l}^{j} - {μ}_{l}^{sen}}{{σ}_{l}^{sen}} ) + {( \frac{{g}_{l}^{j} - {μ}_{l}^{sen}}{{σ}_{l}^{sen}} )}^{2} ]}{2 ( 1 - {( {ρ}_{k , l}^{sen} )}^{2} )} \} ,$$

where

μₖ^{sen}=mean of gene k abundances over the sensitive cell lines

σₖ^{sen}=standard deviation of gene k abundances in the sensitive cell lines

μᵢ^{sen}=mean of gene l abundances over the sensitive cell lines

σₗ^{sen}=standard deviation of gene l abundances in the sensitive cell lines

ρ_{k,l}^{sen}=correlation coefficient of gene k and gene l abundances in the sensitive cell lines

ᵢU_{k,l}(gₖ^{j},gₗ^{j})=probability of abundance values gₖ^{j} and gₗ^{j} from the uniform density fitted to gene k and gene l abundances over all cell lines when subjected to drug i. For given genes k and l, this value is constant across all cell lines, j.

$${}_{i}^{}{U}{}_{k , l}^{} ( {g}_{k}^{j} , {g}_{l}^{j} ) = \frac{1}{[ max ( {g}_{k} ) - min ( {g}_{k} ) ] \cdot [ max ( {g}_{l} ) - min ( {g}_{l} ) ]} ,$$

where

max(gₖ)=maximum abundance of gene k over all cell lines

min(gₖ)=minimum abundance of gene k over all cell lines

max(gₗ)=maximum abundance of gene l over all cell lines

min(gₗ)=minimum abundance of gene l over all cell lines

Sample parameters for the UGDA 2D on the NCI60 dataset are:

Rule 1

Gene 1: SID W 116819 Homo sapiens clone 23887 mRNA sequence [5′:T93821 3′:T93776]

Gene 2: SID W 484681 Homo sapiens ES/130 mRNA complete cds [5′:AA037568 3′:AA037487]

Drug: L-Alanosine

Parameters:

μₖ^{sen}=0.006423, μᵢ^{sen}=−0.25, σₖ^{sen}=0.7146, σₗ^{sen}=0.4424, ρ_{k,l}^{sen}=0.7005

ᵢU_{k,l}(g^{j}ₖ,g^{j}ₗ)=0.04605

P(Cᵢ^{sensitive})=0.2283, P(Cᵢ^{insensitive})=0.7717

Rule 2

Gene 1: EST Chr.6 [72745 (R) 5′:T50815 3′:T50661]

Gene 2: ESTs Weakly similar to dual specificity phosphatase [H.sapiens] Chr.17 [488150 (IW) 5′:AA057259 3′:AA058704]

Drug: L-Alanosine

Parameters:

μₖ^{sen}=−0.3181, μₗ^{sen}=−0.4347, σₖ^{sen}=0.7029, σₗ^{sen}=0.3548, ρ_{k,l}^{sen}=0.7733

ᵢU_{k,l}(g^{j}ₖ,g^{j}ₗ)=0.03881

P(Cᵢ^{sensitive})=0.2283, P(Cᵢ^{insensitive})=0.7717

Rule 3

Gene 1: SID W 469272 Epidermal growth factor receptor [5′:AA026175 3′:AA026089]

Gene 2: MICA MHC class I polypeptide-related sequence A Chr.6 [290724 (R) 5′:3′:N71782]

Drug: Dichloroallyl-lawsone

Parameters:

μₖ^{sen}=−0.2886, μₗ^{sen}=−0.165, σₖ^{sen}=0.4416, σₗ^{sen}=0.3495, ρ_{k,l}^{sen}=0.6331

ᵢU_{k,l}(g^{j}ₖ,g^{j}ₗ)=0.03649

P(Cᵢ^{sensitive})=0.2172, P(Cᵢ^{insensitive})=0.7828

Rule 4

Gene 1: PROBABLE UBIQUITIN CARBOXYL-TERMINAL HYDROLASE Chr.6 [129496 (E) 5′:R16453 3′:R14956]

Gene 2: SID W 125268 H.sapiens mRNA for human giant larvae homolog [5′:R05862 3′:R05776]

Drug: Dichloroallyl-lawsone

Parameters:

μₖ^{sen}=0.5512, μₗ^{sen}=0.1164, σₖ^{sen}=0.509, σₗ^{sen}=0.7882, ρ_{k,l}^{sen}=0.8968

ᵢU_{k,l}(g^{j}ₖ,g^{j}ₗ)=0.05461

P(Cᵢ^{sensitive})=0.2172, P(Cᵢ^{insensitive})=0.7828

Rule 5

Gene 1: Human LOT1 mRNA complete cds Chr.6 [285041 (I) 5′: 3′:N63378]

Gene 2: UBE2H Ubiquitin-conjugating enzyme E2H (homologous to yeast UBC8) Chr.7 [359705 (DIW) 5′:AA010909 3′:AA011300]

Drug: DUP785-brequinar

Parameters:

μₖ^{sen}=0.4687, μₗ^{sen}=−0.2413, σₖ^{sen}=0.5604, σₗ^{sen}=0.6083, ρ_{k,l}^{sen}=−0.3827

ᵢU_{k,l}(g^{j}ₖ,g^{j}ₗ)=0.06755

P(Cᵢ^{sensitive})=0.2694, P(Cᵢ^{insensitive})=0.7306

Rule 6

Gene 1: Human putative 32 kDa heart protein PHP32 mRNA complete cds Chr.8 [417819 (EW) 5′:W88869 3′:W88662]

Gene 2: SID W 305455 TRANSCRIPTIONAL REGULATOR ISGF3 GAMMA SUBUNIT [5′:W39053 3′:N89196]

Drug: Pyrazofurin

Parameters:

μₖ^{sen}=−0.2413, μₗ^{sen}=−0.01115, σₖ^{sen}=0.3564, σₗ^{sen}=0.5233, ρ_{k,l}^{sen}=−0.1372

ᵢU_{k,l}(g^{j}ₖ,g^{j}ₗ)=0.04906

P(Cᵢ^{sensitive})=0.2594, P(Cᵢ^{insensitive})=0.7406

Rule 7

Gene 1: SID W 509468 Protective protein for beta-galactosidase (galactosialidosis) [5′:AA047117 3′:AA047118]

Gene 2: SID W 214236 CD68 antigen [5′:H77807 3′:H77636]

Drug: Pyrazofurin

Parameters:

μₖ^{sen}=−0.3715, μₗ^{sen}=−0.2611, σₖ^{sen}=0.521, σₗ^{sen}=0.5311, ρ_{k,l}^{sen}=0.8032

ᵢU_{k,l}(g^{j}ₖ,g^{j}ₗ)=0.5027

P(Cᵢ^{sensitive})=0.2594, P(Cᵢ^{insensitive})=0.7406

Rule 8

Gene 1: *Human ferritin L chain mRNA complete cds SID W 239001 ESTs [5′:H67076 3′:H68158]

Gene 2: Homo sapiens mRNA for KIAA0638 protein partial cds Chr.11 [470670(IW) 5′:AA031574 3′:AA031453]

Drug: Cyanomorpholinodoxorubicin

Parameters:

μₖ^{sen}=0.438, μₗ^{sen}=0.7537, σₖ^{sen}=0.507, σₗ^{sen}=0.4528, ρ_{k,l}^{sen}=−0.7846

ᵢU_{k,l}(g^{j}ₖ,g^{j}ₗ)=0.0424

P(Cᵢ^{sensitive})=0.2594, P(Cᵢ^{insensitive})=0.7933

Rule 9

Gene 1: IL8 Interleukin 8 Chr.4 [328692 (DW) 5′:W40283 3′:W45324]

Gene 2: SID W 305455 TRANSCRIPTIONAL REGULATOR ISGF3 GAMMA SUBUNIT [5′:W39053 3′:N89796]

Drug: Cyanomorpholinodoxorubicin

Parameters:

μₖ^{sen}=0.856, μₗ^{sen}=0.4419, σₖ^{sen}=0.6623, σₗ^{sen}=0.3503, ρ_{k,l}^{sen}=−0.5992

ᵢU_{k,l}(g^{j}ₖ,g^{j}ₗ)=0.051

P(Cᵢ^{sensitive})=0.2067, P(Cᵢ^{insensitive})=0.7933

Rule 10

Gene 1: SID 272143 ESTs [5′: 3′:N35476]

Gene 2: SID W 345420 Homo sapiens YAC clone 136A2 unknown mRNA 3′untranslated region [5′:W76024 3′:W72468]

Drug: Lomustine (CCNU)

Parameters:

μₖ^{sen}=0.3141, μₗ^{sen}=0.4027, σₖ^{sen}=0.5301, σₗ^{sen}=0.4267, ρ_{k,l}^{sen}=−0.9555

ᵢU_{k,l}(g^{j}ₖ,g^{j}ₗ)=0.04943

P(Cᵢ^{sensitive})=0.1067, P(Cᵢ^{insensitive})=0.8933

Rule 11

Gene 1: ESTs Chr.11 [345012 (IW) 5′:W76307 3′:W72280]

Gene 2: SID 429145 Human nicotinamide N-methyltransferase (NNMT) mRNA complete cds [5′: 3′:AA004839]

Drug: Semustine (MeCCNU)

Parameters:

μₖ^{sen}=0.1845, μₗ^{sen}=0.2891, σₖ^{sen}=0.3375, σₗ^{sen}=0.398, ρ_{k,l}^{sen}=0.6251

ᵢU_{k,l}(g^{j}ₖ,g^{j}ₗ)=0.06712

P(Cᵢ^{sensitive})=0.1066, P(Cᵢ^{insensitive})=0.8934

Rule 12

Gene 1: INPP1 Inositol polyphosphate-1-phosphatase Chr.2 [183876 (EW) 5′:H30231 3′:H26976]

Gene 2: SID 429145 Human nicotinamide N-methyltransferase (NNMT) mRNA complete cds [5′: 3′:AA004839]

Drug: Semustine (MeCCNU)

Parameters:

μₖ^{sen}=0.06554, μₗ^{sen}=0.2891, σₖ^{sen}=0.5184, σₗ^{sen}=0.398, ρ_{k,l}^{sen}=−0.6708

ᵢU_{k,l}(g^{j}ₖ,g^{j}ₗ)=0.05885

P(Cᵢ^{sensitive})=0.1606, P(Cᵢ^{insensitive})=0.8394

Rule 13

Gene 1: SID 276915 ESTs [5′:N48564 3′:N39452]

Gene 2: SID 301144 ESTs [5′:W16630 3′:N78729]

Drug: Mitozolamide

Parameters:

μₖ^{sen}=0.001165, μₗ^{sen}=0.7785, σₖ^{sen}=0.4, σₗ^{sen}=0.2994, ρ_{k,l}^{sen}−0.3594

ᵢU_{k,l}(g^{j}ₖ,g^{j}ₗ)=0.04824

P(Cᵢ^{sensitive})=0.2006, P(Cᵢ^{insensitive})=0.7994

Rule 14

Gene 1: ESTs Chr.1 [45747 (D) 5′:H08940 3′:H08856]

Gene 2: Human mitogen-responsive phosphoprotein (DOC-2) mRNA complete cds Chr.5 [428137 (IE) 5′: 3′:AA001933]

Drug: Mitozolamide

Parameters:

μₖ^{sen}=−0.2316, μₗ^{sen}=0.3967, σₖ^{sen}=0.4407, σₗ^{sen}=0.3587, ρ_{k,l}^{sen}=−0.6006

ᵢU_{k,l}(g^{j}ₖ,g^{j}ₗ)=0.05485

P(Cᵢ^{sensitive})=0.2006, P(Cᵢ^{insensitive})=0.7994

Rule 15

Gene 1: SID W 242844 ESTs Moderately similar to !!!! ALU SUBFAMILY J WARNING ENTRY !!!! [H.sapiens] [5′:H94138 3′:H94064]

Gene 2: ESTs Chr.1 [488132 (IW) 5′:AA047420 3′:AA047421]

Drug: Mitozolamide

Parameters:

μₖ^{sen}=−1.008, μₗ^{sen}=0.4755, σₖ^{sen}=0.5668, σₗ^{sen}=0.3355, ρ_{k,l}^{sen}=0.3703

ᵢU_{k,l}(g^{j}ₖ,g^{j}ₗ)=0.05737

P(Cᵢ^{sensitive})=0.2006, P(Cᵢ^{insensitive})=0.7994

Rule 16

Gene 1: ESTs Chr.1 [488132 (IW) 5′:AA047420 3′:AA047421]

Gene 2: ESTs Chr.1 [346583 (IRW) 5′:W79544 3′:W74533]

Drug: Mitozolamide

Parameters:

μₖ^{sen}=0.4755, μₗ^{sen}=0.4998, σₖ^{sen}=0.3355, σₗ^{sen}=0.593, ρ_{k,l}^{sen}=0.612

ᵢU_{k,l}(g^{j}ₖ,g^{j}ₗ)=0.06478

P(Cᵢ^{sensitive})=0.2006, P(Cᵢ^{insensitive})=0.7994

Rule 17

Gene 1: SID 276915 ESTs [5′:N48564 3′:N39452]

Gene 2: SID W 487878 SPARC/osteonectin [5′:AA046533 3′:AA045463]

Drug: Mitozolamide

Parameters:

μₖ^{sen}=0.001165, μₗ^{sen}=0.9224, σₖ^{sen}=0.4, σₗ^{sen}=0.4976, ρ_{k,l}^{sen}=−0.3656

ᵢU_{k,l}(g^{j}ₖ,g^{j}ₗ)=0.04927

P(Cᵢ^{sensitive})=0.2006, P(Cᵢ^{insensitive})=0.7994

Rule 18

Gene 1: *Human ferritin L chain mRNA complete cds SID W 239001 ESTs [5′:H67076 3′:H68158]

Gene 2: SID W 242844 ESTs Moderately similar to !! !! ALU SUBFAMILY J WARNING ENTRY!!!! [H.sapiens] [5′:H94138 3′:H94064]

Drug: Mitozolamide

Parameters:

μₖ^{sen}=0.5746, μₗ^{sen}=−1.008, σₖ^{sen}=0.4099, σₗ^{sen}=0.5668, ρ_{k,l}^{sen}=0.3637

ᵢU_{k,l}(g^{j}ₖ,g^{j}ₗ)=0.04724

P(Cᵢ^{sensitive})=0.2006, P(Cᵢ^{insensitive})=0.7994

Rule 19

Gene 1: *Human ferritin L chain mRNA complete cds SID W 239001 ESTs [5′:H67076 3′:H68158]

Gene 2: CDH2 Cadherin 2 N-cadherin (neuronal) Chr. [325182 (DIRW) 5′:W48793 3′:W49619]

Drug: Mitozolamide

Parameters:

μₖ^{sen}=0.5746, μₗ^{sen}=0.6581, σₖ^{sen}=0.4099, σₗ^{sen}=0.3744, ρ_{k,l}^{sen}=−0.04564

ᵢU_{k,l}(g^{j}ₖ,g^{j}ₗ)=0.05088

P(Cᵢ^{sensitive})=0.2006, P(Cᵢ^{insensitive})=0.7994

Rule 20

Gene 1: SID 417008 ESTs Weakly similar to No definition line found [C.elegans] [5′:3′:W87796]

Gene 2: CDH2 Cadherin 2 N-cadherin (neuronal) Chr. [325182 (DIRW) 5′:W48793 3′:W49619]

Drug: Mitozolamide

Parameters:

μₖ^{sen}=0.3847, μₗ^{sen}=0.6581, σₖ^{sen}=0.4824, σₗ^{sen}=0.3744, ρ_{k,l}^{sen}=0.6278

ᵢU_{k,l}(g^{j}ₖ,g^{j}ₗ)=0.05309

P(Cᵢ^{sensitive})=0.2006, P(Cᵢ^{insensitive})=0.7994

Rule 21

Gene 1: SID W 242844 ESTs Moderately similar to !!!! ALU SUBFAMILY J WARNING ENTRY!!!! [H.sapiens] [5′:H94138 3′:H94064]

Gene 2: SD W 323824 NADH-CYTOCHROME B5 REDUCTASE [5′:W46211 3′:W46212]

Drug: Mitozolamide

Parameters:

μₖ^{sen}=−1.008, μₗ^{sen}=0.2421, σₖ^{sen}=0.5668, σₗ^{sen}=0.4385, ρ_{k,l}^{sen}=0.04634

ᵢU_{k,l}(g^{j}ₖ,g^{j}ₗ)=0.05737

P(Cᵢ^{sensitive})=0.2006, P(Cᵢ^{insensitive})=0.7994

Rule 22

Gene 1: SID 122022-[5′:T98316 3′:T98261]

Gene 2: *Homo sapiens lysosomal neuraminidase precursor mRNA complete cds SID W 487887 Hexabrachion (tenascin C cytotactin) [5′:AA046543 3′:AA045473]

Drug: Mitozolamide

Parameters:

μₖ^{sen}=0.1567, μₗ^{sen}=0.8444, ρₖ^{sen}=0.4277, σₗ^{sen}=0.5358, ρ_{k,l}^{sen}=0.6386

ᵢU_{k,l}(g^{j}ₖ,g^{j}ₗ)=0.0423

P(Cᵢ^{sensitive})=0.2006, P(Cᵢ^{insensitive})=0.7994

Rule 23

Gene 1: SID W 488691 ESTs Highly similar to NODULATION PROTEIN G [Rhizobium meliloti] [5′:AA045967 3′:AA045833]

Gene 2: ESTs Chr.7 [28051 (D) 5′:R13146 3′:R40626]

Drug: Mitozolamide

Parameters:

μₖ^{sen}=−0.4283, μₗ^{sen}=0.6206, σₖ^{sen}=0.6985, σₗ^{sen}=0.4756, ρ_{k,l}^{sen}=−0.9223

ᵢU_{k,l}(g^{j}ₖ,g^{j}ₗ)=0.05016

P(Cᵢ^{sensitive})=0.2006, P(Cᵢ^{insensitive})=0.7994

Rule 24

Gene 1: Human DNA sequence from clone 1409 on chromosome Xp11.1-11.4. Contains a Inter-Alpha-Trypsin Inh Chr.X [485194 (I) 5′:AA039416 3′:AA039316]

Gene 2: Human mRNA for reticulocalbin complete cds Chr. 11 [485209(IW) 5′:AA039292 3′:AA039334]

Drug: Cyclodisone

Parameters:

μₖ^{sen}=0.2487, μₗ^{sen}=0.6598, σₖ^{sen}=0.04569, σₗ^{sen}=0.2562, ρ_{k,l}^{sen}=−0.4186

ᵢU_{k,l}(g^{j}ₖ,g^{j}ₗ)=0.03818

P(Cᵢ^{sensitive})=0.2006, P(Cᵢ^{insensitive})=0.8311

Rule 25

Gene 1: Human mRNA for reticulocalbin complete cds Chr. 11 [485209 (IW) 5′:AA039292 3′:AA039334]

Gene 2: SID 147338 ESTs [5′: 3′:H01302]

Drug: Cyclodisone

Parameters:

μₖ^{sen}=0.6598, μₗ^{sen}=0.1958, σₖ^{sen}=0.2562, σₗ^{sen}=0.3673, ρ_{k,l}^{sen}=−0.6593

ᵢU_{k,l}(g^{j}ₖ,g^{j}ₗ)=0.03137

P(Cᵢ^{sensitive})=0.1689, P(Cᵢ^{insensitive})=0.8311

Rule 26

Gene 1: Human GDP-dissociation inhibitor protein (Ly-GDI) mRNA complete cds Chr.12 [487374 (IW) 5′:AA046482 3′:AA046695]

Gene 2: Human mRNA for reticulocalbin complete cds Chr.11 [485209(IW) 5′:AA039292 3′:AA039334]

Drug: Cyclodisone

Parameters:

μₖ^{sen}=−0.2079, μₗ^{sen}=0.6598, σₖ^{sen}=0.5996, σₗ^{sen}=0.2565, ρ_{k,l}^{sen}=−0.7022

ᵢU_{k,l}(g^{j}ₖ,g^{j}ₗ)=0.03853

P(Cᵢ^{sensitive})=0.1689, P(Cᵢ^{insensitive})=0.8311

Rule 27

Gene 1: SID W 510182 H.sapiens mRNA for kinase A anchor protein [5′:AA053156 3′:AA053135]

Gene 2: SID W 346663 ESTs [5′:W94188 3′:W74616]

Drug: Cyclodisone

Parameters:

μₖ^{sen}=−0.4516, μₗ^{sen}=0.3877, σₖ^{sen}=0.4114, σₗ^{sen}=0.3607, ρ_{k,l}^{sen}=−0.8186

ᵢU_{k,l}(g^{j}ₖ,g^{j}ₗ)=0.03563

P(Cᵢ^{sensitive})=0.1689, P(Cᵢ^{insensitive})=0.8311

Rule 28

Gene 1: Homo sapiens clone 24560 unknown mRNA complete cds Chr. 16 [418227 (IW 5′:W90284 3′:W90607]

Gene 2: Human mRNA for reticulocalbin complete cds Chr.11 [485209 (IW) 5′:AA039292 3′:AA039334]

Drug: Cyclodisone

Parameters:

μₖ^{sen}=0.2463, μₗ^{sen}=0.6598, σₖ^{sen}=0.3831, σₗ^{sen}=0.2562, ρ_{k,l}^{sen}=0.5841

ᵢU_{k,l}(g^{j}ₖ,g^{j}ₗ)=0.03311

P(Cᵢ^{sensitive})=0.1689, P(Cᵢ^{insensitive})=0.8311

Rule 29

Gene 1: ESTs Chr.1 [488132 (IW) 5′:AA047420 3′:AA047421]

Gene 2: Human mRNA for reticulocalbin complete cds Chr.11 [485209 (IW) 5′:AA039292 3′:AA039334]

Drug: Cyclodisone

Parameters:

μₖ^{sen}=0.479, μₗ^{sen}=0.6598, σₖ^{sen}=0.3464, σₗ^{sen}=0.2562, ρ_{k,l}^{sen}=−0.4896

ᵢU_{k,l}(g^{j}ₖ,g^{j}ₗ)=0.04029

P(Cᵢ^{sensitive})=0.1689, P(Cᵢ^{insensitive})=0.8311

Rule 30

Gene 1: ESTs Chr.1 [488132 (IW) 5′:AA047420 3′:AA047421]

Gene 2: ESTs Chr.1 [346583 (IRW) 5′:W79544 3′:W74533]

Drug: Cyclodisone

Parameters:

μₖ^{sen}=0.479, μₗ^{sen}=0.4024, σₖ^{sen}=0.3464, σₗ^{sen}=0.5961, ρ_{k,l}^{sen}=0.7576

ᵢU_{k,l}(g^{j}ₖ,g^{j}ₗ)=0.06748

P(Cᵢ^{sensitive})=0.1689, P(Cᵢ^{insensitive})=0.8311

Rule 31

Gene 1: SID W 510395 Ribosomal protein S16 [5′:AA053701 3′:AA053681]

Gene 2: SID W 345420 Homo sapiens YAC clone 136A2 unknown mRNA 3′untranslated region [5′:W76024 3′:W72468]

Drug: Clomesone

Parameters:

μₖ^{sen}=−0.4557, μₗ^{sen}=0.7165, σₖ^{sen}=0.2618, σₗ^{sen}=0.4934, ρ_{k,l}^{sen}=0.4265

ᵢU_{k,l}(g^{j}ₖ,g^{j}ₗ)=0.05367

P(Cᵢ^{sensitive})=0.1917, P(Cᵢ^{insensitive})=0.8083

Rule 32

Gene 1: ESTs Wealdy similar to GAR22 protein [H.sapiens] Chr. [51904 (E) 5′:H24408 3′:H22555]

Gene 2: SID 147338 ESTs [5′: 3′:H01302]

Drug: Clomesone

Parameters:

μₖ^{sen}=0.3048, μₗ^{sen}=0.1604, σₖ^{sen}=0.4287, σₗ^{sen}=0.37, ρ_{k,l}^{sen}=−0.7076

ᵢU_{k,l}(g^{j}ₖ,g^{j}ₗ)=0.03507

P(Cᵢ^{sensitive})=0.1917, P(Cᵢ^{insensitive})=0.8083

Rule 33

Gene 1: MSN Moesin Chr.X [486864 (IW) 5′:AA043008 3′:AA042882]

Gene 2: Human mRNA for reticulocalbin complete cds Chr.11 [485209 (IW) 5′:AA039292 3′:AA039334]

Drug: Clomesone

Parameters:

μₖ^{sen}=0.6791, μₗ^{sen}=0.4913, σₖ^{sen}=0.4486, σₗ^{sen}0.4435, ρ_{k,l}^{sen}=0.8962

ᵢU_{k,l}(g^{j}ₖ,g^{j}ₗ)=0.03916

P(Cᵢ^{sensitive})=0.1917, P(Cᵢ^{insensitive})=0.8083

Rule 34

Gene 1: Homo sapiens gamma2-adaptin (G2AD) mRNA complete cds Chr.14 [415647 (IW) 5′:W78996 3′:W80537]

Gene 2: ESTs Chr.6 [146640 (I) 5′:R80056 3′:R79962]

Drug: Fluorouracil (5FU)

Parameters:

μₖ^{sen}=0.3802, μₗ^{sen}=0.1649, σₖ^{sen}=0.419, σₗ^{sen}=0.7902, ρ_{k,l}^{sen}=0.9422

ᵢU_{k,l}(g^{j}ₖ,g^{j}ₗ)=0.04435

P(Cᵢ^{sensitive})=0.1628, P(Cᵢ^{insensitive})=0.8372

Rule 35

Gene 1: SID W 415811 ESTs [5′:W84831 3′:W84784]

Gene 2: H.sapiens mRNA for Gal-beta(1-3/1-4)GlcNAc alpha-2.3-sialyltransferase Chr.11 [324181 (IW) 5′:W47425 3′:W47395]

Drug: Fluorouracil (5FU)

Parameters:

μₖ^{sen}=−0.16, μₗ^{sen}=−0.3532, σₖ^{sen}=0.2818 , σₗ^{sen}=0.2383, ρ_{k,l}^{sen}=0.2669

ᵢU_{k,l}(g^{j}ₖ,g^{j}ₗ)=0.0438

P(Cᵢ^{sensitive})=0.1628, P(Cᵢ^{insensitive})=0.8372

Rule 36

Gene 1: SID 289361 ESTs [5′:N99589 3′:N92652]

Gene 2: EST Chr.1 [137318 (I) 5′: 3′:R36703]

Drug: Fluorouracil (5FU)

Parameters:

μₖ^{sen}=0.03614, μₗ^{sen}=−0.3758, σₖ^{sen}=0.186, σₗ^{sen}=0.4475, ρ_{k,l}^{sen}=−0.1074

ᵢU_{k,l}(g^{j}ₖ,g^{j}ₗ)=0.06362

P(Cᵢ^{sensitive})=0.1628, P(Cᵢ^{insensitive})=0.8372

Rule 37

Gene 1: LAMA3 Laminin alpha 3 (nicein (150 kD) kalinin (165 kD) BM600 (150 kD) epilegrin) Chr.18 [362059 (IRW) 5′:AA001431 3′:AA001432]

Gene 2: Prostacyclin-stimulating factor [human cultured diploid fibroblast cells mRNA 1124 nt] Chr.4 [488721 (IW) 5′:AA046078 3′:AA046026]

Drug: Cytarabine (araC)

Parameters:

μₖ^{sen}=−0.3545, μₗ^{sen}=−0.4411, σₖ^{sen}=0.7334, σₗ^{sen}=0.5863, ρ_{k,l}^{sen}=0.8148

ᵢU_{k,l}(g^{j}ₖ,g^{j}ₗ)=0.06236

P(Cᵢ^{sensitive})=0.2661, P(Cᵢ^{insensitive})=0.7339

Rule 38

Gene 1: ESTs Chr.14 [244047 (I) 5′:N45439 3′:N38807]

Gene 2: SID 307717 Homo sapiens KIAA0430 mRNA complete cds [5′: 3′:N92942]

Drug: Cyclocytidine

Parameters:

μₖ^{sen}=0.536, μₗ^{sen}=0.004825, σₖ^{sen}=0.4307, σₗ^{sen}=0.232, ρ_{k,l}^{sen}=0.1655

ᵢU_{k,l}(g^{j}ₖ,g^{j}ₗ)=0.03336

P(Cᵢ^{sensitive})=0.2553, P(Cᵢ^{insensitive})=0.7467

Rule 39

Gene 1: ESTs Chr.1 [31905 (I) 5′:R17893 3′:R43139]

Gene 2: SID 307717 Homo sapiens KIAA0430 mRNA complete cds [5′: 3′:N92942]

Drug: Cyclocytidine

Parameters:

ti μₖ^{sen}=0.1955, μₗ^{sen}=0.004825, σₖ^{sen}=0.7301, σₗ^{sen}=0.232, ρ_{k,l}^{sen}=0.685

ᵢU_{k,l}(g^{j}ₖ,g^{j}ₗ)=0.03972

P(Cᵢ^{sensitive})=0.2553, P(Cᵢ^{insensitive})=0.7467

Rule 40

Gene 1: SD W 193562 Homo sapiens nuclear autoantigen GS2NA mRNA complete cds [5′:H47460 3′:H47370]

Gene 2: SID 307717 Homo sapiens KIAAO430 mRNA complete cds [5′: 3′:N92942]

Drug: Cyclocytidine

Parameters:

μₖ^{sen}=0.3942, μₗ^{sen}=0.004825, σₖ^{sen}=0.7788, σₗ^{sen}=0.232, ρ_{k,l}^{sen}=0.5508

ᵢU_{k,l}(g^{j}ₖ,g^{j}ₗ)=0.04087

P(Cᵢ^{sensitive})=0.2553, P(Cᵢ^{insensitive})=0.7467

Rule 41

Gene 1: ALDOC Aldolase C fructose-bisphosphate Chr.17 [229961 (IW) 5′:H67774 3′:H67775]

Gene 2: SID 470499 Human mRNA for KIAA0249 gene complete cds [5′:AA031742 3′:AA031651]

Drug: Anthrapyrazole-derivative

Parameters:

μₖ^{sen}=−0.2373, μₗ^{sen}=0.4104, σₖ^{sen}=0.3786, σₗ^{sen}=0.5297, ρ_{k,l}^{sen}−0.7901

ᵢU_{k,l}(g^{j}ₖ,g^{j}ₗ)=0.05241

P(Cᵢ^{sensitive})=0.2006, P(Cᵢ^{insensitive})=0.7994

Rule 42

Gene 1: SID 471855 Lumican [5′: 3′:AA035657]

Gene 2: Thioredoxin Reductase mRNA-log

Drug: Menogaril

Parameters:

μₖ^{sen}=−0.5946, μₗ^{sen}=0.4827, σₖ^{sen}=0.3149, σₗ^{sen}=0.4498, ρ_{k,l}^{sen}=0.8286

ᵢU_{k,l}(g^{j}ₖ,g^{j}ₗ)=0.03953

P(Cᵢ^{sensitive})=0.1944, P(Cᵢ^{insensitive})=0.8056

Rule 43

Gene 1: ESTSSID 327435 [5′:W32467 3′:W19830]

Gene 2: PROBABLE TRANS-1.2-DIHYDROBENZENE-1.2-DIOL DEHYDROGENASESID 211995 [5′:H75805 3′:H68500]

Drug: Hydroxyurea

Parameters:

μₖ^{sen}=−0.3875, μₗ^{sen}=−0.05828, σₖ^{sen}=0.3831, σₗ^{sen}=0.3997, ρ_{k,l}^{sen}=0.8287

ᵢU_{k,l}(g^{j}ₖ,g^{j}ₗ)=0.05168

P(Cᵢ^{sensitive})=0.1944, P(Cᵢ^{insensitive})=0.8517

Rule 44

Gene 1: ESTs Chr.1 [62232 (IR) 5′:T40284 3′:T41149]

Gene 2: SID W 488455 Cathepsin D (lysosomal aspartyl protease) [5′:AA047512 3′:AA047455]

Drug: CPT,10-OH

Parameters:

μₖ^{sen}=0.07749, μₗ^{sen}=0.249, σₖ^{sen}=0.7379, σₗ^{sen}=0.4558, ρ_{k,l}^{sen}=0.6965

ᵢU_{k,l}(g^{j}ₖ,g^{j}ₗ)=0.05378

P(Cᵢ^{sensitive})=0.1856, P(Cᵢ^{insensitive})=0.8144

Rule 45

Gene 1: SID W 417320 Plasminogen activator tissue type (t-PA) [5′:W88922 3′:W89129]

Gene 2: Homo sapiens Cyr61 mRNA complete cds Chr.1 [486700 (DIW) 5′:AA044451 3′:AA044574]

Drug: CPT,10-OH

Parameters:

μₖ^{sen}=0.614, μₗ^{sen}=0.6231, σₖ^{sen}=0.4658, σₗ^{sen}=0.6676, ρ_{k,l}^{sen}=−0.7235

ᵢU_{k,l}(g^{j}ₖ,g^{j}ₗ)=0.05368

P(Cᵢ^{sensitive})=0.1856, P(Cᵢ^{insensitive})=0.8144

Rule 46

Gene 1: ESTs Chr.6 [471083 (IW) 5′:AA034335 3′:AA033710]

Gene 2: SID W 488148 H.sapiens mRNA for 3′UTR of unknown protein [5′:AA057239 3′:AA058703]

Drug: CPT

Parameters:

μₖ^{sen}=−0.2213, μₗ^{sen}=0.8224, σₖ^{sen}=0.6777, σₗ^{sen}=0.5588, ρ_{k,l}^{sen}=0.62

ᵢU_{k,l}(g^{j}ₖ,g^{j}ₗ)=0.04033

P(Cᵢ^{sensitive})=0.2594, P(Cᵢ^{insensitive})=0.7406

Rule 47

Gene 1: *Homo sapiens lysosomal neuraminidase precursor mRNA complete cds SID W 487887 Hexabrachion (tenascin C cytotactin) [5′:AA046543 3′:AA045473]

Gene 2: ESTs Weakly similar to !!!! ALU SUBFAMILY J WARNING ENTRY !!!! [H.sapiens] Chr. [21955 (I) 5′:T66210 3′:T66144]

Drug: CPT

Parameters:

μₖ^{sen}=0.3188, μₗ^{sen}=0.5775, σₖ^{sen}=0.7221, σₗ^{sen}=0.5522, ρ_{k,l}^{sen}=−0.8619

ᵢU_{k,l}(g^{j}ₖ,g^{j}ₗ)=0.06477

P(Cᵢ^{sensitive})=0.2594, P(Cᵢ^{insensitive})=0.7406

Rule 48

Gene 1: SID W 365476 Protein S (alpha) [5′:AA009419 3′:AA009723]

Gene 2: SID W 488148 H.sapiens mRNA for 3′UTR of unknown protein [5′:AA057239 3′:AA058703]

Drug: CPT

Parameters:

μₖ^{sen}=−0.03662, μₗ^{sen}=0.8224, σₖ^{sen}=0.6534, σₗ^{sen}=0.5588, ρ_{k,l}^{sen}=−0.6764

ᵢU_{k,l}(g^{j}ₖ,g^{j}ₗ)=0.06166

P(Cᵢ^{sensitive})=0.2594, P(Cᵢ^{insensitive})=0.7406

Rule 49

Gene 1: SID 469530 H.sapiens mRNA for ragA protein [5′: 3′:AA026944]

Gene 2: Homo sapiens clone 24477 mRNA sequence Chr.18 [33059 (IEW) 5′:R19498 3′:R43846]

Drug: CPT

Parameters:

μₖ^{sen}=0.459, μₗ^{sen}=−0.2041, σₖ^{sen}=0.5722, σₗ^{sen}0.6597, ρ_{k,l}^{sen}=−0.8312

ᵢU_{k,l}(g^{j}ₖ,g^{j}ₗ)=0.04669

P(Cᵢ^{sensitive})=0.2594, P(Cᵢ^{insensitive})=0.7406

Rule 50

Gene 1: SID W 469299 ETS-RELATED PROTEIN ERM [5′:AA026205 3′:AA026121]

Gene 2: SID W 415693 Homo sapiens mRNA for phosphatidylinositol 4-kinase complete cds [5′:W78879 3′:W84724]

Drug: CPT

Parameters:

μₖ^{sen}=−0.0352, μₗ^{sen}=0.664, σₖ^{sen}=0.5333, σₗ^{sen}=0.6375, ρ_{k,l}^{sen} =−0.8029

ᵢU_{k,l}(g^{j}ₖ,g^{j}ₗ)=0.0497

P(Cᵢ^{sensitive})=0.2594, P(Cᵢ^{insensitive})=0.7406

Rule 51

Gene 1: SID W 488148 H.sapiens mRNA for 3!UTR of unknown protein [5′:AA057239 3′:AA058703]

Gene 2: HLA-DRB5 Major histocompatibility complex class II DR beta 5 Chr.6 [321230 (IEW) 5′:W52918 3′:AA037380]

Drug: CPT

Parameters:

μₖ^{sen}=0.8224, μₗ^{sen}=−0.07462, σₖ^{sen}=0.5588, σₗ^{sen}=0.7144, ρ_{k,l}^{sen}=−0.8079

ᵢU_{k,l}(g^{j}ₖ,g^{j}ₗ)=0.05766

P(Cᵢ^{sensitive})=0.2594, P(Cᵢ^{insensitive})=0.7406

Rule 52

Gene 1: ESTs Chr.5 [322749 (I) 5′: 3′:W15473]

Gene 2: SID 469530 H.sapiens mRNA for ragA protein [5′: 3′:AA026944]

Drug: CPT

Parameters:

μₖ^{sen}=−0.02124, μₗ^{sen}=0.459, σₖ^{sen}=0.5919, σₗ^{sen}0.5722, ρ_{k,l}^{sen}=−0.8235

ᵢU_{k,l}(g^{j}ₖ,g^{j}ₗ)=0.05028

P(Cᵢ^{sensitive})=0.2594, P(Cᵢ^{insensitive})=0.7406

Rule 53

Gene 1: SID W 159512 Integrin alpha 6 [5′:H16046 3′:H15934]

Gene 2: SID 301276 ESTs Highly similar to VALYL-TRNA SYNTHETASE [Fugu rubripes] [5′:W07581 3′:N80811]

Drug: CPT

Parameters:

μₖ^{sen}=0.7291, μₗ^{sen}=0.6257, σₖ^{sen}=0.6557, σₗ^{sen}=0.6193, ρ_{k,l}^{sen}=−0.1667

ᵢU_{k,l}(g^{j}ₖ,g^{j}ₗ)=0.05021

P(Cᵢ^{sensitive})=0.2594, P(Cᵢ^{insensitive})=0.7406

Rule 54

Gene 1: SID W 125268 H.sapiens mRNA for human giant larvae homolog [5′:R05862 3′:R05776]

Gene 2: G6PD Glucose-6-phosphate dehydrogenase Chr.X [430251 (IW) 5′:AA010317 3′:AA010382]

Drug: Chlorambucil

Parameters:

μₖ^{sen}=−0.4569, μₗ^{sen}=−0.2982, σₖ^{sen}=0.4595, σₗ^{sen}=0.2945, ρ_{k,l}^{sen}=−0.1414

ᵢU_{k,l}(g^{j}ₖ,g^{j}ₗ)=0.06214

P(Cᵢ^{sensitive})=0.2206, P(Cᵢ^{insensitive})=0.7794

Rule 55

Gene 1: SID W 510534 MAJOR GASTROINTESTINAL TUMOR-ASSOCIATED PROTEIN GA733-2 PRECURSOR [5′:AA055858 3′:AA055808]

Gene 2: G6PD Glucose-6-phosphate dehydrogenase Chr.X [430251 (IW) 5′:AA010317 3′:AA010382]

Drug: Chlorambucil

Parameters:

μₖ^{sen}=−0.7249, μₗ^{sen}=−0.2982, σₖ^{sen}=0.5634, σₗ^{sen}=0.2945, ρ_{k,l}^{sen}=−0.3986

ᵢU_{k,l}(g^{j}ₖ,g^{j}ₗ)=0.06933

P(Cᵢ^{sensitive})=0.2206, P(Cᵢ^{insensitive})=0.7794

Rule 56

Gene 1: SID 29828 ESTs [5′:R16390 3′:R42331]

Gene 2: SID W 485645 KERATIN TYPE II CYTOSKELETAL 7 [5′:AA039817 3′:AA041344]

Drug: 5-Hydroxypicolinaldehyde-thiose

Parameters:

μₖ^{sen}=−0.1536, μₗ^{sen}=0.8712, σₖ^{sen}=0.5974, σₗ^{sen}=0.6735, ρ_{k,l}^{sen}=0.6716

ᵢU_{k,l}(g^{j}ₖ,g^{j}ₗ)=0.03954

P(Cᵢ^{sensitive})=0.1789, P(Cᵢ^{insensitive})=0.8211

Rule 57

Gene 1: SID 381780 ESTs [5′:AA059257 3′:AA059223]

Gene 2: SID 130482 ESTs [5′:R21876 3′:R21877]

Drug: Paclitaxel—Taxol

Parameters:

μₖ^{sen}=0.1618, μₗ^{sen}=−0.8271, σₖ^{sen}=0.1828, σₗ^{sen}=0.3413, ρ_{k,l}^{sen}=−0.3935

ᵢU_{k,l}(g^{j}ₖ,g^{j}ₗ)=0.05375

P(Cᵢ^{sensitive})=0.1789, P(Cᵢ^{insensitive})=0.8378

Rule 58

Gene 1: SID 381780 ESTs [5′:AA059257 3′:AA059223]

Gene 2: SID 512355 ESTs Highly similar to SRC SUBSTRATE P80/85 PROTEINS [Gallus gallus] [5′:AA059424 3′:AA057835]

Drug: Paclitaxel—Taxol

Parameters:

μₖ^{sen}=0.1618, μₗ^{sen}=−0.8354, σₖ^{sen}=0.1828, σₗ^{sen}=0.4935, ρ_{k,l}^{sen}=−0.09957

ᵢU_{k,l}(g^{j}ₖ,g^{j}ₗ)=0.06437

P(Cᵢ^{sensitive})=0.1622, P(Cᵢ^{insensitive})=0.8378

Rule 59

Gene 1: *Paired basic amino acid cleaving enzyme (furin membrane associated receptor protein) SID W 114116 Syndecan 2 (heparan sulfate proteoglycan 1 cell surface-associated fibroglycan) [5′:T79562 3′:T79471]

Gene 2: SID 240167 ESTs [5′:H79634 3′:H79635]

Drug: Pyrazoloacridine

Parameters:

μₖ^{sen}=−0.6405, μₗ^{sen}=0.3087, σₖ^{sen}=0.5377, σₗ^{sen}=0.4283, ρ_{k,l}^{sen}=0.7929

ᵢU_{k,l}(g^{j}ₖ,g^{j}ₗ)=0.05053

P(Cᵢ^{sensitive})=0.1811, P(Cᵢ^{insensitive})=0.8189

Linear Discriminant Analysis—1-dimensional (LDA 1D)

This method computes a Bayesian conditional probability P(jεCᵢ^{sensitive}|gₖ^{j}) that a cell line j is sensitive to drug i, given the gene k abundance gₖ^{j} in cell line j.

The probability is computed using the following equation:

$$P ( j ∈ {C}_{i}^{sensitive} \vert {g}_{k}^{j} ) = \frac{{}_{i}^{}{G}{}_{k}^{sensitive} ( {g}_{k}^{j} ) \cdot P ( {C}_{i}^{sensitive} )}{{}_{i}^{}{G}{}_{k}^{sensitive} ( {g}_{k}^{j} ) \cdot P ( {C}_{i}^{sensitive} ) + {}_{i}^{}{G}{}_{k}^{insensitive} ( {g}_{k}^{j} ) \cdot P ( {C}_{i}^{insensitive} )}$$

where

P(Cᵢ^{sensitive})=prior probability of the sensitive set=|Cᵢ^{senitive}|/(|Cᵢ^{sensitive}|+|Cᵢ^{insensitive}|),

P(Cᵢ^{insensitive})=prior probability of the insensitive set=|Cᵢ^{insensitive}|/(|Cᵢ^{sensitive}|+|Cᵢ^{insensitive}|),

ᵢGₖ^{sensitive}(gₖ^{j})=probability of abundance value g I from the gaussian density fitted to the histogram of the gene k abundances over the sensitive cell lines when subjected to drug i.

$${}_{i}^{}{G}{}_{k}^{sensitive} ( {g}_{k}^{j} ) = \frac{1}{{σ}_{k}^{avg} \sqrt{2 π}} {ⅇ}^{- {( {g}_{k}^{j} - {μ}_{k}^{sen} )}^{2} / 2 {( {σ}_{k}^{avg} )}^{2}} ,$$

where

μₖ^{sen}=mean of gene k abundances in the sensitive cell lines

σₖ^{avg}=sensitiveinsensitive class-weighted average standard deviation of gene k abundances in the sensitive cell lines

ᵢGₖ^{insensitive}(gₖ^{j})=probability of abundance value gₖ^{j} from the gaussian density fitted to the histogram of the gene k abundances over the insensitive cell lines when subjected to drug i.

$${}_{i}^{}{G}{}_{k}^{sensitive} ( {g}_{k}^{j} ) = \frac{1}{{σ}_{k}^{avg} \sqrt{2 π}} {ⅇ}^{- {( {g}_{k}^{j} - {μ}_{k}^{insen} )}^{2} / 2 {( {σ}_{k}^{avg} )}^{2}} ,$$

where

μₖ^{insen}=mean of gene k abundances in the insensitive cell lines

Sample parameters for the LDA 1D analysis on the NCI60 Dataset are set out below:

Rule 1

Gene: SID W 470947 Human scaffold protein Pbp1 mRNA complete cds [5′:AA032174 3′:AA032175]

Drug: Inosine-glycodialdehyde

Parameters:

μₖ^{sen}=−0.8115

μₖ^{insen}=0.2001

σₖ^{avg}=0.9394

P(Cᵢ^{sensitive})=0.1978, P(Cᵢ^{insensitive})=0.8022

Rule 2

Gene: Human mRNA for reticulocalbin complete cds Chr. 11 [485209 (IW) 5′:AA039292 3′:AA039334]

Drug: Inosine-glycodialdehyde

Parameters:

μₖ^{sen}=−0.7618

μₖ^{insen}=0.1878

σₖ^{avg}=0.9598

P(Cᵢ^{sensitive})=0.1978, P(Cᵢ^{insensitive})=0.8022

Rule 3

Gene: Homo sapiens cyclin-dependent kinase inhibitor (CDKN2C) mRNA complete cds Chr. [291057 (RW) 5′:W00390 3′:N72115]

Drug: L-Alanosine

Parameters:

μₖ^{sen}=−0.8435

μₖ^{insen}=0.25

σₖ^{avg}=0.8722

P(Cᵢ^{sensitive})=0.2283, P(Cᵢ^{insensitive})=0.7717

Rule 4

Gene: SID W 254085 ESTs Moderately similar to synaptonemal complex protein [M.musculus] [5′:N71532 3′:N22165]

Drug: Baker's-soluble-antifoliate

Parameters:

μₖ^{sen}=0.7847

μₖ^{insen}=0.2423

σₖ^{avg}=0.8539

P(Cᵢ^{sensitive})=0.2361, P(Cᵢ^{insensitive})=0.7639

Rule 5

Gene: M-PHASE INDUCER PHOSPHATASE 2 Chr.20 [179373 (EW) 5′:H50437 3′:H50438]

Drug: 5-6-Dihydro-5-azacytidine

Parameters:

μₖ^{sen}=−0.9251

μₖ^{insen}=0.2324

σₖ^{avg}=0.8567

P(Cᵢ^{sensitive})=0.2011, P(Cᵢ^{insensitive})=0.7989

Rule 6

Gene: THY-1 MEMBRANE GLYCOPROTEIN PRECURSOR Chr.11 [183950 (E) 5′:H30297 3′:H28104]

Drug: Mitozolamide

Parameters:

μₖ^{sen}=0.1073

μₖ^{insen}=−0.2694

σₖ^{avg}=0.8153

P(Cᵢ^{sensitive})=0.2006, P(Cᵢ^{insensitive})=0.7994

Rule 7

Gene: PTN Pleiotrophin (heparin binding growth factor 8 neurite growth-promoting factor 1) Chr.7 [488801 (IW) 5′:AA045053 3′:AA045054]

Drug: Mitozolamide

Parameters:

μₖ^{sen}=1.019

μₖ^{insen}=−0.2557

σₖ^{avg}=0.8554

P(Cᵢ^{sensitive})=0.2006, P(Cᵢ^{insensitive})=0.7994

Rule 8

Gene: SID W 380674 ESTs [5′:AA053720 3′:AA053711]

Drug: Mitozolamide

Parameters:

μₖ^{sen}=1.093

μₖ^{insen}=−0.2739

σₖ^{avg}=0.8441

P(Cᵢ^{sensitive})=0.2006, P(Cᵢ^{insensitive})=0.7994

Rule 9

Gene: Glutathoine S-Tranferase Pi-log

Drug: Mitozolamide

Parameters:

μₖ^{sen}=−0.917

μₖ^{insen}=0.2307

σₖ^{avg}=0.8411

P(Cᵢ^{sensitive})=0.2006, P(Cᵢ^{insensitive})=0.7994

Rule 10

Gene: SID W 242844 ESTs Moderately similar to !!! ALU SUBFAMILY J WARNING ENTRY!!!! [H.sapiens] [5′:H94138 3′:H94064]

Drug: Mitozolamide

Parameters:

μₖ^{sen}=−1.008

μₖ^{insen}=0.2536

σₖ^{avg}=0.8681

P(Cᵢ^{sensitive})=0.2006, P(Cᵢ^{insensitive})=0.7994

Rule 11

Gene: *Hs.648 Cut (Drosophila)-like 1 (CCAAT displacement protein) SID W 26677 ESTs [5′:R13994 3′:R39117]

Drug: Mitozolamide

Parameters:

μₖ^{sen}=0.8138

μₖ^{insen}=−0.2039

σₖ^{avg}=0.9103

P(Cᵢ^{sensitive})=0.2006, P(Cᵢ^{insensitive})=0.7994

Rule 12

Gene: SID W 488387 Exostoses (multiple) 2 [5′:AA046786 3′:AA046656]

Drug: Cyclodisone

Parameters:

μₖ^{sen}=1.043

μₖ^{insen}=−0.2128

σₖ^{avg}=0.8985

P(Cᵢ^{sensitive})=0.1689, P(Cᵢ^{insensitive})=0.8311

Rule 13

Gene: THY-1 MEMBRANE GLYCOPROTEIN PRECURSOR Chr.11 [183950 (E) 5′:H30297 3′:H28104]

Drug: Cyclodisone

Parameters:

μₖ^{sen}=1.135

μₖ^{insen}=−0.2308

σₖ^{avg}=0.8251

P(Cᵢ^{sensitive})=0.1689, P(Cᵢ^{insensitive})=0.8311

Rule 14

Gene: SID W 487535 Human mRNA for KIAAO080 gene partial cds [5′:AA043528 3′:AA043529]

Drug: Clomesone

Parameters:

μₖ^{sen}=1.184

μₖ^{insen}=−0.2817

σₖ^{avg}=0.829

P(Cᵢ^{sensitive})=0.1917, P(Cᵢ^{insensitive})=0.8083

Rule 15

Gene: PTN Pleiotrophin (heparin binding growth factor 8 neurite growth-promoting factor 1) Chr.7 [488801 (IW) 5′:AA045053 3′:AA045054]

Drug: Clomesone

Parameters:

μₖ^{sen}=1.14

μₖ^{insen}=−0.2703

σₖ^{avg}=0.8309

P(Cᵢ^{sensitive})=0.1917, P(Cᵢ^{insensitive})=0.8083

Rule 16

Gene: THY-1 MEMBRANE GLYCOPROTEIN PRECURSOR Chr.11 [183950 (E) 5′:H30297 3′:H28104]

Drug: Clomesone

Parameters:

μₖ^{sen}=1.157

μₖ^{insen}=−0.2746

σₖ^{avg}=0.8226

P(Cᵢ^{sensitive})=0.1917, P(Cᵢ^{insensitive})=0.8083

Rule 17

Gene: SID W 242844 ESTs Moderately similar to !!!! ALU SUBFAMILY J WARNING ENTRY!!!! [H.sapiens] [5′:H94138 3′:H94064]

Drug: Clomesone

Parameters:

μₖ^{sen}=−1.079

μₖ^{insen}=0.2564

σₖ^{avg}=0.8587

P(Cᵢ^{sensitive})=0.1917, P(Cᵢ^{insensitive})=0.8083

Rule 18

Gene: SID W 487535 Human mRNA for KLAA0080 gene partial cds [5′:AA043528 3′:AA043529]

Drug: PCNU

Parameters:

μₖ^{sen}=1.081

μₖ^{insen}=−0.2435

σₖ^{avg}=0.8791

P(Cᵢ^{sensitive})=0.1833, P(Cᵢ^{insensitive})=0.8167

Rule 19

Gene: SID W 242844 ESTs Moderately similar to !!!! ALU SUBFAMILY J WARNING ENTRY!!!! [H.sapiens] [5′:H94138 3′:H94064)

Drug: PCNU

Parameters:

μₖ^{sen}=−1.078

μₖ^{insen}=0.2427

σₖ^{avg}=0.8755

P(Cᵢ^{sensitive})=0.1833, P(Cᵢ^{insensitive})=0.8167

Rule 20

Gene: PTN Pleiotrophin (heparin binding growth factor 8 neurite growth-promoting factor 1) Chr.7 [488801 (IW) 5′:AA045053 3′:AA045054]

Drug: PCNU

Parameters:

μₖ^{sen}=1.115

μₖ^{insen}=−0.2502

σₖ^{avg}=0.8538

P(Cᵢ^{sensitive})=0.1833, P(Cᵢ^{insensitive})=0.8167

Rule 21

Gene: Human thymosin beta-4 mRNA complete cds Chr.20 [305890(IW) 5′:W19923 3′:N91268]

Drug: Cytarabine (araC)

Parameters:

μₖ^{sen}=−0.7694

μₖ^{insen}=0.2788

σₖ^{avg}=0.8663

P(Cᵢ^{sensitive})=0.2661, P(Cᵢ^{insensitive})=0.7339

Rule 22

Gene: SID W 291620 Restin (Reed-Steinberg cell-expressed intermediate filament-associated protein) [5′:W03421 3′:N67817]

Drug: Porfiromycin

Parameters:

μₖ^{sen}=0.9491

μₖ^{insen}=−0.2431

σₖ^{avg}=0.8965

P(Cᵢ^{sensitive})=0.2039, P(Cᵢ^{insensitive})=0.7961

Rule 23

Gene: Human extracellular protein (S1-5) mRNA complete cds Chr.2 [485875 (EW) 5′:AA040442 3′:AA040443]

Drug: Oxanthrazole (piroxantrone)

Parameters:

μₖ^{sen}=1.155

μₖ^{insen}=−0.2805

σₖ^{avg}=0.7962

P(Cᵢ^{sensitive})=0.1956, P(Cᵢ^{insensitive})=0.8044

Rule 24

Gene: SID W 299539 Human fibroblast growth factor homologous factor 1 (FHF-1) mRNA complete cds [5′:W05845 3′:N71102]

Drug: Oxanthrazole piroxantrone)

Parameters:

μₖ^{sen}=0.9238

μₖ^{insen}=−0.2254

σₖ^{avg}=0.862

P(Cᵢ^{sensitive})=0.1956, P(Cᵢ^{insensitive})=0.8044

Rule 25

Gene: SID W 488148 H.sapiens mRNA for 3′UTR of unknown protein [5′:AA057239 3′:AA058703]

Drug: Oxanthrazole (piroxantrone)

Parameters:

μₖ^{sen}=0.8896

μₖ^{insen}=−0.2163

σₖ^{avg}=0.8858

P(Cᵢ^{sensitive})=0.1956, P(Cᵢ^{insensitive})=0.8044

Rule 26

Gene: Human extracellular protein (S1-5) mRNA complete cds Chr.2 [485875 (EW) 5′:AA040442 3′:AA040443]

Drug: Anthrapyrazole-derivative

Parameters:

μₖ^{sen}=1.016

μₖ^{insen}=−0.2458

σₖ^{avg}=0.8692

P(Cᵢ^{sensitive})=0.2006, P(Cᵢ^{insensitive})=0.7994

Rule 27

Gene: SID W 380674 ESTs [5′:AA053720 3′:AA053711]

Drug: Anthrapyrazole-derivative

Parameters:

μₖ^{sen}=0.9038

μₖ^{insen}=−0.2265

σₖ^{avg}=0.8898

P(Cᵢ^{sensitive})=0.2006, P(Cᵢ^{insensitive})=0.7994

Rule 28

Gene: ESTs Chr.2 [365120 (IW) 5′:AA025204 3′:AA025124]

Drug: Anthrapyrazole-derivative

Parameters:

μₖ^{sen}=0.9014

μₖ^{insen}=−0.2264

σₖ^{avg}=0.9007

P(Cᵢ^{sensitive})=0.2006, P(Cᵢ^{insensitive})=0.7994

Rule 29

Gene: SID 229535 [5′:H66594 3′:H66595]

Drug: Teniposide

Parameters:

μₖ^{sen}=−0.9209

μₖ^{insen}=0.2154

σₖ^{avg}=0.9114

P(Cᵢ^{sensitive})=0.1894, P(Cᵢ^{insensitive})=0.8106

Rule 30

Gene: ESTs Chr.2 [149542 (DW) 5′:H00283 3′:H00284]

Drug: Daunorubicin

Parameters:

μₖ^{sen}=−1.052

μₖ^{insen}=0.2324

σₖ^{avg}=0.8508

P(Cᵢ^{sensitive})=0.1811, P(Cᵢ^{insensitive})=0.8189

Rule 31

Gene: SID W 510030 ESTs Weakly similar to N-methyl-D-aspartate receptor glutamate-binding chain [R.norvegicus] [5′:AA053050 3′:AA053392]

Drug: Daunorubicin

Parameters:

μₖ^{sen}=−1.088

μₖ^{insen}=0.2401

σₖ^{avg}=0.8526

P(Cᵢ^{sensitive})=0.1811, P(Cᵢ^{insensitive})=0.8189

Rule 32

Gene: SID 260288 ESTs [5′:H97716 3′:H96798]

Drug: Daunorubicin

Parameters:

μₖ^{sen}=−0.9929

μₖ^{insen}=0.2192

σₖ^{avg}=0.9063

P(Cᵢ^{sensitive})=0.1811, P(Cᵢ^{insensitive})=0.8189

Rule 33

Gene: AK1 Adenylate kinase 1 Chr.9 [488381 (IW) 5′:AA046783 3′:AA046653]

Drug: Daunorubicin

Parameters:

μₖ^{sen}=−0.9847

μₖ^{insen}=0.2169

σₖ^{avg}=0.8611

P(Cᵢ^{sensitive})=0.1811, P(Cᵢ^{insensitive})=0.8189

Rule 34

Gene: Homo sapiens T245 protein (T245) mRNA complete eds Chr.X [343063 (IW) 5′:W67989 3′:W68001]

Drug: Daunorubicin

Parameters:

μₖ^{sen}=−1.061

μₖ^{insen}=0.234

σₖ^{avg}=0.8647

P(Cᵢ^{sensitive})=0.1811, P(Cᵢ^{insensitive})=0.8189

Rule 35

Gene: *Prothymosin alpha SID W 271976 AMINOACYLASE-1 [5′:N44687 3′:N35315]

Drug: Daunorubicin

Parameters:

μₖ^{sen}=−1.032

μₖ^{insen}=0.2284

σₖ^{avg}=0.858

P(Cᵢ^{sensitive})=0.1811, P(Cᵢ^{insensitive})=0.8189

Rule 36

Gene: SID W 345683 ESTs Highly similar to INTEGRAL MEMBRANE GLYCOPROTEIN GP210 PRECURSOR [Rattus norvegicus] [5′:W76432 3′:W72039]

Drug: Daunorubicin

Parameters:

μₖ^{sen}=−0.918

μₖ^{insen}=0.2022

σₖ^{avg}=0.8758

P(Cᵢ^{sensitive})=0.1811, P(Cᵢ^{insensitive})=0.8189

Rule 37

Gene: Homo sapiens clone 24477 mRNA sequence Chr.18 [33059 (IEW) 5′:R19498 3′:R43846]

Drug: Daunorubicin

Parameters:

μₖ^{sen}=−0.966

μₖ^{insen}=0.2126

σₖ^{avg}=0.8952

P(Cᵢ^{sensitive})=0.1811, P(Cᵢ^{insensitive})=0.8189

Rule 38

Gene: SID 43609 ESTs [5′:H06454 3′:H06184]

Drug: Amsacrine

Parameters:

μₖ^{sen}=0.9136

μₖ^{insen}=−0.2581

σₖ^{avg}=0.8733

P(Cᵢ^{sensitive})=0.22, P(Cᵢ^{insensitive})=0.78

Rule 39

Gene: GAMMA-INTERFERON-INDUCIBLE PROTEIN IP-30 PRECURSOR Chr.19 [310021 (I) 5′: 3′:N99151]

Drug: CPT,10-OH

Parameters:

μₖ^{sen}=−0.9086

μₖ^{insen}=0.2078

σₖ^{avg}=0.8915

P(Cᵢ^{sensitive})=0.1856, P(Cᵢ^{insensitive})=0.8144

Rule 40

Gene: SID W 346587 Homo sapiens quiescin (Q6) mRNA complete cds [5′:W79188 3′:W74434]

Drug: CPT,10-OH

Parameters:

μₖ^{sen}=1.001

μₖ^{insen}=−0.2285

σₖ^{avg}=0.8549

P(Cᵢ^{sensitive})=0.1856, P(Cᵢ^{insensitive})=0.8144

Rule 41

Gene: SID 39144 ESTs Weakly similar to Rep-8 [H.sapiens] [5′:R51769 3′:R51770]

Drug: CPT,20-ester (S)

Parameters:

μₖ^{sen}=−0.8367

μₖ^{insen}=0.2555

σₖ^{avg}=0.8798

P(Cᵢ^{sensitive})=0.2344, P(Cᵢ^{insensitive})=0.7656

Rule 42

Gene: SID W 358526 ESTs [5′:W96039 3′:W94821]

Drug: CPT,14-Cl (S)

Parameters:

μₖ^{sen}=−0.8436

μₖ^{insen}=0.2136

σₖ^{avg}=0.9027

P(Cᵢ^{sensitive})=0.2022, P(Cᵢ^{insensitive})=0.7978

Rule 43

Gene: GAMMA-INTERFERON-INDUCIBLE PROTEIN IP-30 PRECURSOR Cbr.19 [310021 (I) 5′: 3′:N99151]

Drug: CPT,20-acetate

Parameters:

μₖ^{sen}=−0.8754

μₖ^{insen}=0.1973

σₖ^{avg}=0.8929

P(Cᵢ^{sensitive})=0.1833, P(Cᵢ^{insensitive})=0.8167

Rule 44

Gene: SID 512355 ESTs Highly similar to SRC SUBSTRATE P80/85 PROTEINS [Gallus gallus] [5′:AA059424 3′:AA057835]

Drug: CPT

Parameters:

μₖ^{sen}=0.8614

μₖ^{insen}=−0.3016

σₖ^{avg}=0.8698

P(Cᵢ^{sensitive})=0.2594, P(Cᵢ^{insensitive})=0.7406

Rule 45

Gene: SID W 488148 H.sapiens mRNA for 3′UTR of unknown protein [5′:AA057239 3′:AA058703]

Drug: CPT

Parameters:

μₖ^{sen}=0.8224

μₖ^{insen}=−0.2881

σₖ^{avg}=0.8739

P(Cᵢ^{sensitive})=0.2594, P(Cᵢ^{insensitive})=0.7406

Rule 46

Gene: ESTs Chr.19 [485804 (EW) 5′:AA040350 3′:AA040351]

Drug: CPT,20-ester (S)

Parameters:

μₖ^{sen}=−0.7505

μₖ^{insen}=0.2562

σₖ^{avg}=0.8843

P(Cᵢ^{sensitive})=0.255, P(Cᵢ^{insensitive})=0.745

Rule 47

Gene: SID W 358526 ESTs [5′:W96039 3′:W94821]

Drug: CPT,11-formyl (RS)

Parameters:

μₖ^{sen}=−1.055

μₖ^{insen}=0.2536

σₖ^{avg}=0.8569

P(Cᵢ^{sensitive})=0.1939, P(Cᵢ^{insensitive})=0.8061

Rule 48

Gene: SID W 135118 GATA-bindingprotein3 [5′:R31441 3′:R31442]

Drug: CPT, 11 -formyl (RS)

Parameters:

μₖ^{sen}=0.9817

μₖ^{insen}=−0.2359

σₖ^{avg}=0.9021

P(Cᵢ^{sensitive})=0.1939, P(Cᵢ^{insensitive})=0.8061

Rule 49

Gene: ESTs Chr.16 [154654 (RW) 5′:R55184 3′:R55185]

Drug: CPT,11-formyl (RS)

Parameters:

μₖ^{sen}=0.874

μₖ^{insen}=−0.2102

σₖ^{avg}=0.9112

P(Cᵢ^{sensitive})=0.1939, P(Cᵢ^{insensitive})=0.8061

Rule 50

Gene: SID 43609 ESTs [5′:H06454 3′:H06184]

Drug: Mechlorethamine

Parameters:

μₖ^{sen}=1.042

μₖ^{insen}=−0.2493

σₖ^{avg}=0.8728

P(Cᵢ^{sensitive})=0.1928, P(Cᵢ^{insensitive})=0.8072

Rule 51

Gene: SID W 133851 ESTs [5′:R28233 3′:R27977]

Drug: Triethylenemelamine

Parameters:

μₖ^{sen}=−0.7551

μₖ^{insen}=0.2248

σₖ^{avg}=0.9176

P(Cᵢ^{sensitive})=0.2294, P(Cᵢ^{insensitive})=0.7706

Rule 52

Gene: SID W 133851 ESTs [5′:R28233 3′:R27977]

Drug: Chlorambucil

Parameters:

μₖ^{sen}=−0.8278

μₖ^{insen}=0.2342

σₖ^{avg}=0.8901

P(Cᵢ^{sensitive})=0.2206, P(Cᵢ^{insensitive})=0.7794

Rule 53

Gene: Human mRNA for KIAA0382 gene partial cds Chr.11 [486712 (IEW) 5′:AA043173 3′:AA043174]

Drug: Chlorambucil

Parameters:

μₖ^{sen}=−0.8832

μₖ^{insen}=0.2497

σₖ^{avg}=0.8826

P(Cᵢ^{sensitive})=0.2206, P(Cᵢ^{insensitive})=0.7794

Rule 54

Gene: CDH2 Cadherin 2 N-cadherin (neuronal) Chr. [325182 (DIRW) 5′:W48793 3′:W49619]

Drug: Geldanamycin

Parameters:

μₖ^{sen}=−0.8842

μₖ^{insen}=0.225

σₖ^{avg}=0.8839

P(Cᵢ^{sensitive})=0.2033, P(Cᵢ^{insensitive})=0.7967

Rule 55

Gene: Human nicotinamide nucleotide transhydrogenase mRNA nuclear gene encoding mitochondrial protein Chr. [287568 (I) 5′: 3′:N62116]

Drug: Morpholino-adriamycin

Parameters:

μₖ^{sen}=−1.072

μₖ^{insen}=0.2139

σₖ^{avg}=0.8933

P(Cᵢ^{sensitive})=0.1661, P(Cᵢ^{insensitive})=0.8339

Rule 56

Gene: H.sapiens mRNA for TRAMP protein Chr.8 [149355 (IEW) 5′:H01598 3′:H01495]

Drug: Amonafide

Parameters:

μₖ^{sen}=1.095

μₖ^{insen}=−0.2498

σₖ^{avg}=0.8687

P(Cᵢ^{sensitive})=0.1861, P(Cᵢ^{insensitive})=0.8139

Rule 57

Gene: SID W 415811 ESTs [5′:W84831 3′:W84784]

Drug: Pyrazoloacridine

Parameters:

μₖ^{sen}=−0.873

μₖ^{insen}=0.1935

σₖ^{avg}=0.8924

P(Cᵢ^{sensitive})=0.1811, P(Cᵢ^{insensitive})=0.8189

Quadratic Discriminant Analysis—1-dimensional (QDA 1D)

This method computes a Bayesian conditional probability P(jεCᵢ^{sensitive}|gₖ^{j}) that a cell line j is sensitive to drug i, given the gene k abundance [symbol] ₖ^{j} in cell line j.

The probability is computed using the following equation:

$$P ( j ∈ {C}_{i}^{sensitive} \vert {g}_{k}^{j} ) = \frac{{}_{i}^{}{G}{}_{k}^{sensitive} ( {g}_{k}^{j} ) \cdot P ( {C}_{i}^{sensitive} )}{{}_{i}^{}{G}{}_{k}^{sensitive} ( {g}_{k}^{j} ) \cdot P ( {C}_{i}^{sensitive} ) + {}_{i}^{}{G}{}_{k}^{insensitive} ( {g}_{k}^{j} ) \cdot P ( {C}_{i}^{insensitive} )}$$

where

P(Cᵢ^{sensitive})=prior probability of the sensitive set=|Cᵢ^{sensitive}|/(|Cᵢ^{sensitive}|+|Cᵢ^{sensitive}|),

P(Cᵢ^{sensitive})=prior probability of the insensitive set=|Cᵢ^{insensitive}|/(|Cᵢ^{sensitive}|+|Cᵢ^{sensitive}|),

ᵢGₖ^{sensitive}(gₖ^{j})=probability of abundance value gₖ^{j} from the gaussian density fitted to the histogram of the gene k abundances over the sensitive cell lines when subjected to drug i.

$${}_{i}^{}{G}{}_{k}^{sensitive} ( {g}_{k}^{j} ) = \frac{1}{{σ}_{k}^{avg} \sqrt{2 π}} {ⅇ}^{- {( {g}_{k}^{j} - {μ}_{k}^{sen} )}^{2} / 2 {( {σ}_{k}^{sen} )}^{2}} ,$$

where

μₖ^{sen}=mean of gene k abundances in the sensitive cell lines

σₖ^{sen}=standard deviation of gene k abundances in the sensitive cell lines

ᵢ^{G}ₖ^{insensitive}(gₖ^{j})=probability of abundance value gₖ^{j} from the gaussian density fitted to the histogram of the gene k abundances over the insensitive cell lines when subjected to drug i.

$${}_{i}^{}{G}{}_{k}^{insensitive} ( {g}_{k}^{j} ) = \frac{1}{{σ}_{k}^{insen} \sqrt{2 π}} {ⅇ}^{- {( {g}_{k}^{j} - {μ}_{k}^{insen} )}^{2} / 2 {( {σ}_{k}^{insen} )}^{2}} ,$$

where

μₖ^{insen}=mean of gene k abundances in the insensitive cell lines

σₖ^{insen}=standard deviation of gene k abundances in the insensitive cell lines

Sample parameters for QDA1 analysis on the NCI60 dataset are:

Rule 1

Gene: Human mRNA for reticulocalbin complete cds Chr.11 [485209 (IW) 5′:AA039292 3′:AA039334]

Drug: Inosine-glycodialdehyde

Parameters:

μₖ^{sen}=−0.7618, σₖ^{sen}=1.57

μₖ^{insen}=0.1878, σₖ^{insen}=0.6952

P(Cᵢ^{sensitive})=0.1978, P(Cᵢ^{insensitive})=0.8022

Rule 2

Gene: SID W 470947 Human scaffold protein Pbp1 mRNA complete cds [5′:AA032174 3′:AA032175]

Drug: Inosine-glycodialdehyde

Parameters:

μₖ^{sen}=−0.8115, σₖ^{sen}=1.161

μₖ^{insen}=0.2001, σₖ^{insen}=0.8443

P(Cᵢ^{sensitive})=0.1978, P(Cᵢ^{insensitive})=0.8022

Rule 3

Gene: SID W 254085 ESTs Moderately similar to synaptonemal complex protein [M.musculus] [5′:N71532 3′:N22165]

Drug: Baker's-soluble-antifoliate

Parameters:

μₖ^{sen}=0.7847, σₖ^{sen}=0.6875

μₖ^{insen}=−0.2423, σₖ^{insen}=0.8722

P(Cᵢ^{sensitive})=0.2361, P(Cᵢ^{insensitive})=0.7639

Rule 4

Gene: THY-1 MEMBRANE GLYCOPROTEIN PRECURSOR Chr.11 [183950 (E) 5′:H30297 3′:H28104]

Drug: Mitozolamide

Parameters:

μₖ^{sen}=1.073, σₖ^{sen}=1.284

μₖ^{insen}=−0.2694, σₖ^{insen}=0.6137

P(Cᵢ^{sensitive})=0.2006, P(Cᵢ^{insensitive})=0.7994

Rule 5

Gene: PTN Pleiotrophin (heparin binding growth factor 8 neurite growth-promoting factor 1) Chr.7 [488801 (IW) 5′:AA045053 3′:AA045054]

Drug: Mitozolamide

Parameters:

μₖ^{sen}=1.019, σₖ^{sen}=1.354

μₖ^{insen}=−0.2557, σₖ^{insen}=0.64

P(Cᵢ^{sensitive})=0.2006, P(Cᵢ^{insensitive})=0.7994

Rule 6

Gene: SID W 242844 ESTs Moderately similar to !!!! ALU SUBFAMILY J WARNING ENTRY !!!! [H.sapiens] [5′:H94138 3′:H94064]

Drug: Mitozolamide

Parameters:

μₖ^{sen}=−1.008, σₖ^{sen}=0.5668

μₖ^{insen}=0.2536, σₖ^{insen}=0.9027

P(Cᵢ^{sensitive})=0.2006, P(Cᵢ^{insensitive})=0.7994

Rule 7

Gene: Human mRNA for reticulocalbin complete cds Chr.11 [485209 (IW) 5′:AA039292 3′:AA039334]

Drug: Cyclodisone

Parameters:

μₖ^{sen}=0.6598, σₖ^{sen}=0.2562

μₖ^{insen}=−0.1341, σₖ^{insen}=1.038

P(Cᵢ^{sensitive})=0.1689, P(Cᵢ^{insensitive})=0.8311

Rule 8

Gene: SID W 488387 Exostoses (multiple) 2 [5′:AA046786 3′:AA046656]

Drug: Cyclodisone

Parameters:

μₖ^{sen}=1.043, σₖ^{sen}=1.087

μₖ^{insen}=−0.2128, σₖ^{insen}=0.8262

P(Cᵢ^{sensitive})=0.1689, P(Cᵢ^{insensitive})=0.8311

Rule 9

Gene: SID W 487535 Human mRNA for KIAA0080 gene partial cds [5′:AA043528 3′:AA043529]

Drug: Clomesone

Parameters:

μₖ^{sen}=1.184, σₖ^{sen}=0.9042

μₖ^{insen}=−0.2817, σₖ^{insen}=0.7835

P(Cᵢ^{sensitive})=0.1917, P(Cᵢ^{insensitive})=0.8083

Rule 10

Gene: PIN Pleiotrophin (heparin binding growth factor 8 neurite growth-promoting factor 1) Chr.7 [488801 (IW) 5′:AA045053 3′:AA045054]

Drug: Clomesone

Parameters:

μₖ^{sen}=1.14, σₖ^{sen}=1.31

μₖ^{insen}=−0.2703, σₖ^{insen}=0.636

P(Cᵢ^{sensitive})=0.1917, P(Cᵢ^{insensitive})=0.8083

Rule 11

Gene: THY-1 MEMBRANE GLYCOPROTEIN PRECURSOR Chr.1 [183950 (E) 5′:H30297 3′:H28104]

Drug: Clomesone

Parameters:

μₖ^{sen}=1.157, σₖ^{sen}=1.312

μₖ^{insen}=−0.2746, σₖ^{insen}=0.6219

P(Cᵢ^{sensitive})=0.1917, P(Cᵢ^{insensitive})=0.8083

Rule 12

Gene: SID W 487535 Human mRNA for KIAA0080 gene partial cds [5′:AA043528 3′:AA043529]

Drug: PCNU

Parameters:

μₖ^{sen}=1.081, σₖ^{sen}=1.083

μₖ^{insen}=0.2435, σₖ^{insen}=0.7973

P(Cᵢ^{sensitive})=0.1833, P(Cᵢ^{insensitive})=0.8167

Rule 13

Gene: SID 289361 ESTs [5′:N99589 3′:N92652]

Drug: Fluorouracil (5FU)

Parameters:

μₖ^{sen}=0.03614, σₖ^{sen}=0.186

μₖ^{insen}=−0.007432, σₖ^{insen}=1.074

P(Cᵢ^{sensitive})=0.1628, P(Cᵢ^{insensitive})=0.8372

Rule 14

Gene: SID 287239 ESTs [5′: 3′:N66980]

Drug: Fluorodopan

Parameters:

μₖ^{sen}=−0.1888, σₖ^{sen}=1.767

μₖ^{insen}=0.04924, σₖ^{insen}=0.6817

P(Cᵢ^{sensitive})=0.2061, P(Cᵢ^{insensitive})=0.7939

Rule 15

Gene: SID 307717 Homo sapiens KIAA0430 mRNA complete cds [5′: 3′:N92942]

Drug: Cyclocytidine

Parameters:

μₖ^{sen}=0.004825, σₖ^{sen}=0.232

μₖ^{insen}=−0.002083, σₖ^{insen}=1.151

P(Cᵢ^{sensitive})=0.2533, P(Cᵢ^{insensitive})=0.7467

Rule 16

Gene: SID W 291620 Restin (Reed-Steinberg cell-expressed intermediate filament-associated protein) [5′:W03421 3′:N67817]

Drug: Porfiromycin

Parameters:

μₖ^{sen}=0.9491, σₖ^{sen}=0.8827

μₖ^{insen}=−0.2431, σₖ^{insen}=0.8715

P(Cᵢ^{sensitive})=0.2039, P(Cᵢ^{insensitive})=0.7961

Rule 17

Gene: Human extracellular protein (S1-5) mRNA complete cds Chr.2 [485875 (EW) 5′:AA040442 3′:AA040443]

Drug: Oxanthrazole (piroxantrone)

Parameters:

μₖ^{sen}=1.155, σₖ^{sen}=0.8967

μₖ^{insen}=−0.2805, σₖ^{insen}=0.7438

P(Cᵢ^{sensitive})=0.1956, P(Cᵢ^{insensitive})=0.8044

Rule 18

Gene: Human extracellular protein (S1-5) mRNA complete cds Chr.2 [485875 (EW) 5′:AA040442 3′:AA040443]

Drug: Anthrapyrazole-derivative

Parameters:

μₖ^{sen}=1.016, σₖ^{sen}=1.089

μₖ^{insen}=0.2548, σₖ^{insen}=0.7749

P(Cᵢ^{sensitive})=0.2006, P(Cᵢ^{insensitive})=0.7994

Rule 19

Gene: SID 229535 [5′:H66594 3′:H66595]

Drug: Teniposide

Parameters:

μₖ^{sen}=−0.9209, σₖ^{sen}=1.487

μₖ^{insen}=0.2154, σₖ^{insen}=0.6755

P(Cᵢ^{sensitive})=0.1894, P(Cᵢ^{insensitive})=0.8106

Rule 20

Gene: ESTs Chr.2 [149542 (DW) 5′:H00283 3′:H00284]

Drug: Daunorubicin

Parameters:

μₖ^{sen}=−1.052, σₖ^{sen}=1.344

μₖ^{insen}=0.2324, σₖ^{insen}=0.6635

P(Cᵢ^{sensitive})=0.1811, P(Cᵢ^{insensitive})=0.8189

Rule 21

Gene: AK1 Adenylate kinase 1 Chr.9 [488381 (IW) 5′:AA046783 3′:AA046653]

Drug: Daunorubicin

Parameters:

μₖ^{sen}=−0.9847, σₖ^{sen}=1.33

μₖ^{insen}=0.2169, σₖ^{insen}=0.6847

P(Cᵢ^{sensitive})=0.1811, P(Cᵢ^{insensitive})=0.8189

Rule 22

Gene: SID 260288 ESTs [5′:H97716 3′:H96798]

Drug: Daunorubicin

Parameters:

μₖ^{sen}=−0.9929, σₖ^{sen}=1.81

μₖ^{insen}=0.2192, σₖ^{insen}=0.4776

P(Cᵢ^{sensitive})=0.1811, P(Cᵢ^{insensitive})=0.8189

Rule 23

Gene: SID W 345683 ESTs Highly similar to INTEGRAL MEMBRANE GLYCOPROTEIN GP210 PRECURSOR [Rattus norvegicus] [5′:W76432 3′:W72039]

Drug: Daunorubicin

Parameters:

μₖ^{sen}=−0.918, σₖ^{sen}=0.3704

μₖ^{insen}=−0.2022, σₖ^{insen}=0.9271

P(Cᵢ^{sensitive})=0.1811, P(Cᵢ^{insensitive})=0.8189

Rule 24

Gene: GAMMA-INTERFERON-INDUCIBLE PROTEIN IP-30 PRECURSOR Chr.19 [310021 (I) 5′: 3′:N99151]

Drug: CPT,10-OH

Parameters:

μₖ^{sen}=−0.9086, σₖ^{sen}=0.8266

μₖ^{insen}=0.2078, σₖ^{insen}=0.8782

P(Cᵢ^{sensitive})=0.1856, P(Cᵢ^{insensitive})=0.8144

Rule 25

Gene: SID 512355 ESTs Highly similar to SRC SUBSTRATE P80/85 PROTEINS [Gallus gallus] [5′:AA059424 3′:AA057835]

Drug: CPT

Parameters:

μₖ^{sen}=0.8614, σₖ^{sen}=0.8019

μₖ^{insen}=−0.3016, σₖ^{insen}=0.8633

P(Cᵢ^{sensitive})=0.2594, P(Cᵢ^{insensitive})=0.7406

Rule 26

Gene: SID W 488148 H.sapiens mRNA for 3′UTR of unknown protein [5′:AA057239 3′:AA058703]

Drug: CPT

Parameters:

μₖ^{sen}=0.8224, σₖ^{sen}=0.5588

μₖ^{insen}=−0.2881, σₖ^{insen}=0.9329

P(Cᵢ^{sensitive})=0.2594, P(Cᵢ^{insensitive})=0.7406

Rule 27

Gene: SID W 358526 ESTs [5′:W96039 3′:W94821]

Drug: CPT,11-formyl (RS)

Parameters:

μₖ^{sen}=−1.055, σₖ^{sen}=1.241

μₖ^{insen}=0.2536, σₖ^{insen}=0.7034

P(Cᵢ^{sensitive})=0.1939, P(Cᵢ^{insensitive})=0.8061

Rule 28

Gene: SID W 135118 GATA-binding protein 3 [5′:R31441 3′:R31442]

Drug: CPT,11-formyl (RS)

Parameters:

μₖ^{sen}=0.9817, σₖ^{sen}=1.5

μₖ^{insen}=−0.2359, σₖ^{insen}=0.6465

P(Cᵢ^{sensitive})=0.1939, P(Cᵢ^{insensitive})=0.8061

Rule 29

Gene: SID 43609 ESTs [5′:H06454 3′:H06184]

Drug: CPT,11-formyl (RS)

Parameters:

μₖ^{sen}=0.6312, σₖ^{sen}=1.498

μₖ^{insen}=−0.1522, σₖ^{insen}=0.7671

P(Cᵢ^{sensitive})=0.1939, P(Cᵢ^{insensitive})=0.8061

Rule 30

Gene: ESTs Chr.16 [154654 (RW) 5′:R55184 3′:R55185]

Drug: CPT,11-formyl (S)

Parameters:

μₖ^{sen}=0.874, σₖ^{sen}=1.247

μₖ^{insen}=0.2102, σₖ^{insen}=0.7775

P(Cᵢ^{sensitive})=0.1939, P(Cᵢ^{insensitive})=0.8061

Rule 31

Gene: AK1 Adenylate kinase 1 Chr.9 [488381 (IW) 5′:AA046783 3′:AA046653]

Drug: Mechlorethamine

Parameters:

μₖ^{sen}=−0.4881, σₖ^{sen}=1.786

μₖ^{insen}=0.1157, σₖ^{insen}=0.6286

P(Cᵢ^{sensitive})=0.1928, P(Cᵢ^{insensitive})=0.8072

Rule 32

Gene: SID 43609 ESTs [5′:H06454.3′:H06184]

Drug: Mechlorethamine

Parameters:

μₖ^{sen}=1.042, σₖ^{sen}=0.9895

μₖ^{insen}=−0.2493, σₖ^{insen}=0.814

P(Cᵢ^{sensitive})=0.1928, P(Cᵢ^{insensitive})=0.8072

Rule 33

Gene: SID 43609 ESTs [5′:H06454 3′:H06184]

Drug: Triethylenemelamine

Parameters:

μₖ^{sen}=0.6685, σₖ^{sen}=1.405

μₖ^{insen}=−0.1995, σₖ^{insen}=0.7269

P(Cᵢ^{sensitive})=0.2294, P(Cᵢ^{insensitive})=0.7706

Rule 34

Gene: SID W 133851 ESTs [5′:R28233 3′:R27977]

Drug: Triethylenemelamine

Parameters:

μₖ^{sen}=−0.7551, σₖ^{sen}=1.506

μₖ^{insen}=0.2248, σₖ^{insen}=0.6021

P(Cᵢ^{sensitive})=0.2294, P(Cᵢ^{insensitive})=0.7706

Rule 35

Gene: SID 43609 ESTs [5′:H06454 3′:H06184]

Drug: Thiotepa

Parameters:

μₖ^{sen}=0.6796, σₖ^{sen}=1.35

μₖ^{insen}=−0.2073, σₖ^{insen}=0.728

P(Cᵢ^{sensitive})=0.2333, P(Cᵢ^{insensitive})=0.7667

Rule 36

Gene: SID W 291620 Restin (Reed-Steinberg cell-expressed intermediate filament-associated protein) [5′:W03421 3′:N67817]

Drug: Chlorambucil

Parameters:

μₖ^{sen}=−0.01776, σₖ^{sen}=1.597

μₖ^{insen}=0.005025, σₖ^{insen}=0.7447

P(Cᵢ^{sensitive})=0.2206, P(Cᵢ^{insensitive})=0.7794

Rule 37

Gene: SID W 133851 ESTs [5′:R28233 3′:R27977]

Drug: Chlorambucil

Parameters:

μₖ^{sen}=−0.8278, σₖ^{sen}=1.471

μₖ^{insen}=0.2342, σₖ^{insen}=0.5941

P(Cᵢ^{sensitive})=0.2206, P(Cᵢ^{insensitive})=0.7794

Rule 38

Gene: SID W 510230 Homo sapiens (clone CC6) NADH-ubiquinone oxidoreductase subunit mRNA 3′ end cds [5′:AA053568 3′:AA053557]

Drug: Geldanamycin

Parameters:

μₖ^{sen}=0.1441, σₖ^{sen}=1.609

μₖ^{insen}=−0.03698, σₖ^{insen}=0.7474

P(Cᵢ^{sensitive})=0.2033, P(Cᵢ^{insensitive})=0.7967

Rule 39

Gene: SID 381780 ESTs [5′:AA059257 3′:AA059223]

Drug: Paclitaxel—Taxol

Parameters:

μₖ^{sen}=0.1618, σₖ^{sen}=0.1828

μₖ^{insen}=−0.03218, σₖ^{insen}=1.06

P(Cᵢ^{sensitive})=0.1622, P(Cᵢ^{insensitive})=0.8378

Rule 40

Gene: H.sapiens mRNA for TRAMP protein Chr.8 [149355 (IEW) 5′:H01598 3′:H01495]

Drug: Amonafide

Parameters:

μₖ^{sen}=1.905, σₖ^{sen}=1.188

μₖ^{insen}=−0.2498, σₖ^{insen}=0.7473

P(Cᵢ^{sensitive})=0.1861, P(Cᵢ^{insensitive})=0.8139

Linear Discriminant Analysis—2-dimensional (LDA 2D)

This method computes a Bayesian conditional probability P(jεCᵢ^{sensitive}|gₖ^{j}, gₗ^{j}) that a cell line j is sensitive to drug i, given the abundances of genes k and l, gₖ^{j}, gₗ^{j}, respectively, in cell line j.

The probability is computed using the following equation:

$$P ( j ∈ {C}_{i}^{sensitive} \vert {g}_{k}^{j} , {g}_{l}^{j} ) = \frac{{}_{i}^{}{G}{}_{k , l}^{sensitive} ( {g}_{k}^{j} , {g}_{l}^{j} ) \cdot P ( {C}_{i}^{sensitive} )}{{}_{i}^{}{G}{}_{k , l}^{sensitive} ( {g}_{k}^{j} , {g}_{l}^{j} ) \cdot P ( {C}_{i}^{sensitive} ) + {}_{i}^{}{G}{}_{k , l}^{insensitive} ( {g}_{k}^{j} , {g}_{l}^{j} ) \cdot P ( {C}_{i}^{insensitive} )} ,$$

where

P(Cᵢ^{sensitive})=prior probability of the sensitive set=|Cᵢ^{sensitive}|/(|Cᵢ^{sensitive}|+|Cᵢ^{insensitive}|),

P(Cᵢ^{insensitive})=prior probability of the insensitive set=|Cᵢ^{insensitive}|/(|Cᵢ^{sensitive}|+|Cᵢ^{insensitive}|),

ᵢG_{k,l}^{sensitive}(gₖ^{j}, gₗ^{j})=joint probability of abundance values gₖ^{j} and gₗ^{j} from the bivariate gaussian density fitted to the histogram of gene k and l abundances over the sensitive cell lines when subjected to drug i.

ᵢG_{k,l}^{sensitive}(gₖ^{j}, gₗ^{j})=

$${}_{i}^{}{G}{}_{k , l}^{sensitive} ( {g}_{k}^{j} , {g}_{l}^{j} ) = \frac{1}{2 π {σ}_{k}^{avg} {σ}_{l}^{avg} \sqrt{1 - {( {ρ}_{k , l}^{avg} )}^{2}}} exp \{ \frac{- [ {( \frac{{g}_{k}^{j} - {μ}_{k}^{sen}}{{σ}_{k}^{avg}} )}^{2} - 2 {ρ}_{k , l}^{avg} ( \frac{{g}_{k}^{j} - {μ}_{k}^{sen}}{{σ}_{k}^{avg}} ) ( \frac{{g}_{l}^{j} - {μ}_{l}^{sen}}{{σ}_{l}^{avg}} ) + {( \frac{{g}_{l}^{j} - {μ}_{l}^{sen}}{{σ}_{l}^{avg}} )}^{2} ]}{2 ( 1 - {( {ρ}_{k , l}^{avg} )}^{2} )} \}$$

where

μₖ^{sen}=mean of gene k abundances over the sensitive cell lines

σₖ^{avg}=sensitive\insensitive class-weighted average standard deviation of gene k abundances in the sensitive and insensitive cell lines

μₗ^{sen}=mean of gene 1 abundances over the sensitive cell lines

σₗ^{avg}=sensitive\insensitive class-weighted average standard deviation of gene 1 abundances in the sensitive and insensitive cell lines

ρ_{k,l}^{avg}=sensitive\insensitive class-weighted average correlation coefficient of gene k and gene l abundances in the sensitive and insensitive cell lines

ᵢG_{k,l}^{insensitive}(gₖ^{j}, gₗ^{j})=joint probability of abundance values gₖ^{j} and gₗ^{j} from the bivariate gaussian density fitted to the histogram of gene k and l abundances over the insensitive cell lines when subjected to drug i.

ᵢG_{k,l}^{insensitive}(gₖ^{j}, gₗ^{j})=

$${}_{i} {G}_{k , l}^{insensitive} ( {g}_{k}^{j} , {g}_{l}^{j} ) = \frac{1}{2 {πσ}_{k}^{avg} {σ}_{l}^{avg} \sqrt{1 - {( {ρ}_{k , l}^{avg} )}^{2}}} exp \{ \frac{- [ {( \frac{{g}_{k}^{j} - {μ}_{k}^{insen}}{{σ}_{k}^{avg}} )}^{2} - 2 {ρ}_{k , l}^{avg} ( \frac{{g}_{k}^{j} - {μ}_{k}^{insen}}{{σ}_{k}^{avg}} ) ( \frac{{g}_{l}^{j} - {μ}_{l}^{insen}}{{σ}_{l}^{avg}} ) + ( \frac{{g}_{l}^{j} - {μ}_{l}^{insen}}{{σ}_{l}^{avg}}}{2 ( 1 - {( {ρ}_{k , l}^{avg} )}^{2} )}$$

where

μₖ^{insen} is the mean of gene k abundances over the insensitive cell lines

μₗ^{insen} is the mean of gene k abundances over the insensitive cell lines

Sample parameters for the LDA 2D analysis on the NCI60 dataset are:

Rule 1

Gene 1: Glyoxalase-I-log

Gene 2: Homo sapiens mRNA for HYA22 complete cds Chr.3 [358957 (EW) 5′:W91969 3′:W94916]

Drug: Acivicin

Parameters:

μₖ^{sen}=−0.9056, μₗ^{sen}=0.3517

μₖ^{insen}=0.2197, μₗ^{sen}=−0.08527

σₖ^{avg}=0.8751, σₗ^{avg}=0.9817, ρ_{k,l}^{avg}=0.531

P(Cᵢ^{sensitive})=0.1956, P(Cᵢ^{insensitive})=0.8044

Rule 2

Gene 1: SID W 254085 ESTs Moderately similar to synaptonemal complex protein [M.musculus] [5′:N71532 3′:N22165]

Gene 2: SID 118593 [5′:T92821 3′:T92741]

Drug: Baker's-soluble-antifoliate

Parameters:

μₖ^{sen}=0.7847, μₗ^{sen}=−0.5796

μₖ^{insen}=−0.2423, μₗ^{insen}=0.1796

σₖ^{avg}=0.8539, σₗ^{avg}=0.8599, ρ_{k,l}^{avg}=0.2493

P(Cᵢ^{sensitive})=0.2361, P(Cᵢ^{insensitive})=0.7639

Rule 3

Gene 1: SID W 254085 ESTs Moderately similar to synaptonemal complex protein [M.musculus] [5′:N71532 3′:N22165]

Gene 2: ESTs Chr.5 [46694 (RW) 5′:H10240.3′:H10192]

Drug: Baker's-soluble-antifoliate

Parameters:

μₖ^{sen}=0.7847, μₗ^{sen}=−0.4403

μₖ^{insen}=−0.2423, μₗ^{insen}=0.1363

σₖ^{avg}=0.8539, σₗ^{avg}=0.9706, ρ_{k,l}^{avg}=0.1844

P(Cᵢ^{sensitive})=0.2361, P(Cᵢ^{insensitive})=0.7639

Rule 4

Gene 1: SID W 242844 ESTs Moderately similar to !!!! ALU SUBFAMILY J WARNING ENTRY !!!! [H.sapiens] [5′:H94138 3′:H94064]

Gene 2: *Hs.648 Cut (Drosophila)-like 1 (CCAAT displacement protein) SID W 26677 ESTs [5′:R13994 3′:R39117]

Drug: Mitozolamide

Parameters:

μₖ^{sen}=−1.008, μₗ^{sen}=0.8138

μₖ^{insen}=0.2536, μₗ^{insen}=−0.2039

σₖ^{avg}=0.8681, σₗ^{avg}=0.9103, ρ_{k,l}^{avg}=0.07755

P(Cᵢ^{sensitive})=0.2006, P(Cᵢ^{insensitive})=0.7994

Rule 5

Gene 1: Homo sapiens delta7-sterol reductase mRNA complete cds Chr.10 [417125 (E) 5′:3′:W87472]

Gene 2: SID W 380674 ESTs [5′:AA053720 3′:AA053711]

Drug: Mitozolamide

Parameters:

μₖ^{sen}=−0.7211, μₗ^{sen}=1.093

μₖ^{insen}=0.1813, μₗ^{insen}=−0.2739

σₖ^{avg}=0.9411, σₗ^{avg}=0.8441, ρ_{k,l}^{avg}=0.1253

P(Cᵢ^{sensitive})=0.2006, P(Cᵢ^{insensitive})=0.7994

Rule 6

Gene 1: Glutathoine S-Tranferase Pi-log

Gene 2: *Hs.648 Cut (Drosophila)-like 1 (CCAAT displacement protein) SID W 26677 ESTs [5′:R13994 3′:R39117]

Drug: Mitozolamide

Parameters:

μₖ^{sen}=−0.917, μₗ^{sen}=0.8138

μₖ^{insen}=0.2307, μₗ^{insen}=−0.2039

σₖ^{avg}=0.8411, σₗ^{avg}=0.9103, ρ_{k,l}^{avg}=0.04772

P(Cᵢ^{sensitive})=0.2006, P(Cᵢ^{insensitive})=0.7994

Rule 7

Gene 1: ESTs Chr.X [48536 (E) 5′:H14669 3′:H14579]

Gene 2: SID W 242844 ESTs Moderately similar to !!!! ALU SUBFAMILY J WARNING ENTRY!!!! [H.sapiens] [5′:H94138 3′:H94064]

Drug: Clomesone

Parameters:

μₖ^{sen}=−0.8957, μₗ^{sen}=−1.079

μₖ^{insen}=0.2117, μₗ^{insen}=0.2564

σₖ^{avg}=0.8904, σₗ^{avg}=0.8587, ρ_{k,l}^{avg}=−0.165

P(Cᵢ^{sensitive})=0.1917, P(Cᵢ^{insensitive})=0.8083

Rule 8

Gene 1: SID W 36809 Homo sapiens neural cell adhesion molecule (CALL) mRNA complete cds [5′:R34648 3′:R49177]

Gene 2: SID W 487535 Human mRNA for KIAA0080 gene partial cds [5′:AA043528 3′:AA043529]

Drug: Clomesone

Parameters:

μₖ^{sen}=0.6335, μₗ^{sen}=1.184

μₖ^{insen}=−0.1498, μₗ^{insen}=−0.2817

σₖ^{avg}=0.9603, σₗ^{avg}=0.829, ρ_{k,l}^{avg}=−0.2448

P(Cᵢ^{sensitive})=0.1917, P(Cᵢ^{insensitive})=0.8083

Rule 9

Gene 1: M-PHASE INDUCER PHOSPHATASE 2 Chr.20 [179373 (EW) 5′:H50437 3′:H50438]

Gene 2: SID W 487535 Human mRNA for KIAA0080 gene partial cds [5′:AA043528 3′:AA043529]

Drug: Clomesone

Parameters:

μₖ^{sen}=0.3874, μₗ^{sen}=1.184

μₖ^{insen}=−0.9229, μₗ^{insen}=−0.2817

σₖ^{avg}=0.9766, σₗ^{avg}=0.829, ρ_{k,l}^{avg}=0.2704

P(Cᵢ^{sensitive})=0.1917, P(Cᵢ^{insensitive})=0.8083

Rule 10

Gene 1: SID W 242844 ESTs Moderately similar to !!!! ALU SUBFAMILY J WARNING ENTRY !!!! [H.sapiens] [5′:H94138 3′:H94064]

Gene 2: SID 469842 Homo sapiens mRNA for fatty acid binding protein complete cds [5′:AA029794 3′:AA029795]

Drug: Clomesone

Parameters:

μₖ^{sen}=−1.079, μₗ^{sen}=0.8757

μₖ^{insen}=0.2564, μₗ^{insen}=−0.2074

σₖ^{avg}=0.8587, σₗ^{avg}=0.9151, ρ_{k,l}^{avg}=0.1636

P(Cᵢ^{sensitive})=0.1917, P(Cᵢ^{insensitive})=0.8083

Rule 11

Gene 1: ESTsSID 327435 [5′:W32467 3′:W19830]

Gene 2: SID 469842 Homo sapiens mRNA for fatty acid binding protein complete cds [5′:AA029794 3′:AA029795]

Drug: Clomesone

Parameters:

μₖ^{sen}=−0.793, μₗ^{sen}=0.8757

μₖ^{insen}=0.1878, μₗ^{insen}=−0.2074

σₖ^{avg}=0.9388, σₗ^{avg}=0.9151, ρ_{k,l}^{avg}=0.4476

P(Cᵢ^{sensitive})=0.1917, P(Cᵢ^{insensitive})=0.8083

Rule 12

Gene 1: SID 512164 Human clathrin assembly protein 50 (AP50) mRNA complete cds [5′:3′:AA057396]

Gene 2: SID W 345624 Human homeobox protein (PHOX1) mRNA 3′ end [5′:W76402 3′:W72050]

Drug: Clomesone

Parameters:

μₖ^{sen}=0.8248, μₗ^{sen}=−0.253

μₖ^{insen}=−0.1956, μₗ^{insen}=0.06021

σₖ^{avg}=0.9014, σₗ^{avg}=1.015, ρ_{k,l}^{avg}=0.72

P(Cᵢ^{sensitive})=0.1917, P(Cᵢ^{insensitive})=0.8083

Rule 13

Gene 1: SID W 376951 ESTs [5′:AA047756 3′:AA047641]

Gene 2: SID W 487535 Human mRNA for KIAA0080 gene partial cds [5′:AA043528 3′:AA043529]

Drug: Clomesone

Parameters:

μₖ^{sen}=0.8665, μₗ^{sen}=1.184

μₖ^{insen}=−0.2063, μₗ^{insen}=−0.2817

σₖ^{avg}=0.9396, σₗ^{avg}=0.829, ρ_{k,l}^{avg}=0.1106

P(Cᵢ^{sensitive})=0.1917, P(Cᵢ^{insensitive})=0.8083

Rule 14

Gene 1: Glutathoine S-Tranferase Pi-log

Gene 2: SID W 487535 Human mRNA for KIAA0080 gene partial cds [5′:AA043528 3′:AA043529]

Drug: Clomesone

Parameters:

μₖ^{sen}=−0.8961, μₗ^{sen}=1.184

μₖ^{insen}=0.2131, μₗ^{insen}=−0.2817

σₖ^{avg}=0.8991, σₗ^{avg}=0.829, ρ_{k,l}^{avg}=0.1075

P(Cᵢ^{sensitive})=0.1917, P(Cᵢ^{insensitive})=0.8083

Rule 15

Gene 1: XRCC4 DNA repair protein XRCC4 Chr.5 [26811 (RW) 5′:R14027 3′:R39148]

Gene 2: SID W 242844 ESTs Moderately similar to !!!! ALU SUBFAMILY J WARNING ENTRY!!!! [H.sapiens] [5′:H94138 3′:H94064]

Drug: Clomesone

Parameters:

μₖ^{sen}=−0.583, μₗ^{sen}=−1.079

μₖ^{insen}=0.1387, μₗ^{insen}=0.2564

σₖ^{avg}=0.9879, σₗ^{avg}=0.8587, ρ_{k,l}^{avg}=−0.3373

P(Cᵢ^{sensitive})=0.1917, P(Cᵢ^{insensitive})=0.8083

Rule 16

Gene 1: Homo sapiens clone 24711 mRNA sequence Chr.2 [345084 (IW) 5′:W76362 3′:W72306]

Gene 2: *Homo sapiens lysosomal neuraminidase precursor mRNA complete cds SID W 487887 Hexabrachion (tenascin C cytotactin) [5′:AA046543 3′:AA045473]

Drug: Clomesone

Parameters:

μₖ^{sen}=−0.5805, μₗ^{sen}=0.8678

μₖ^{insen}=0.137, μₗ^{insen}=−0.2056

σₖ^{avg}=0.968, σₗ^{avg}=0.911, ρ_{k,l}^{avg}=0.5627

P(Cᵢ^{sensitive})=0.1917, P(Cᵢ^{insensitive})=0.8083

Rule 17

Gene 1: SID 260048 Homo sapiens intermediate conductance calcium-activated potassium channel (hKCa4) mRNA complete [5′:3′:N32010]

Gene 2: SID W 487535 Human mRNA for KIAA0080 gene partial cds [5′:AA043528 3′:AA043529]

Drug: Clomesone

Parameters:

μₖ^{sen}=0.3774, μₗ^{sen}=1.184

μₖ^{insen}=−0.09052, μₗ^{insen}=−0.2817

σₖ^{avg}=1.015, σₗ^{avg}=0.829, ρ_{k,l}^{avg}=−0.2375

P(Cᵢ^{sensitive})=0.1917, P(Cᵢ^{insensitive})=0.8083

Rule 18

Gene 1: ESTs Weakly similar to R06B9.b [C.elegans] Chr.1 [365488 (IW) 5′:AA009557 3′:AA009558]

Gene 2: SID W 487535 Human mRNA for KIAA0080 gene partial cds [5′:AA043528 3′:AA043529]

Drug: Clomesone

Parameters:

μₖ^{sen}=0.6026, μₗ^{sen}=1.184

μₖ^{insen}=−0.1433, μₗ^{insen}=−0.2817

σₖ^{avg}=0.9451, σₗ^{avg}=0.829, ρ_{k,l}^{avg}=−0.0427

P(Cᵢ^{sensitive})=0.1917, P(Cᵢ^{insensitive})=0.8083

Rule 19

Gene 1: ESTs Moderately similar to DUAL SPECIFICITY PROTEIN PHOSPHATASE VHR [H.sapiens] Chr.17 [49293 (E) 5′:H15616 3′:H15557]

Gene 2: SID W 487535 Human mRNA for KIAA0080 gene partial cds [5′:AA043528 3′:AA043529]

Drug: Clomesone

Parameters:

μₖ^{sen}=−0.1122, μₗ^{sen}=1.184

μₖ^{insen}=0.02618, μₗ^{insen}=−0.2817

σₖ^{avg}=1.019, σₗ^{avg}=0.829, ρ_{k,l}^{avg}=0.4234

P(Cᵢ^{sensitive})=0.1917, P(Cᵢ^{insensitive})=0.8083

Rule 20

Gene 1: SID W 242844 ESTs Moderately similar to !!!! ALU SUBFAMILY J WARNING ENTRY!!!! [H.sapiens] [5′:H94138 3′:H94064]

Gene 2: SID W 487535 Human mRNA for KIAA0080 gene partial cds [5′:AA043528 3′:AA043529]

Drug: Clomesone

Parameters:

μₖ^{sen}=−1.079, μₗ^{sen}=1.184

μₖ^{insen}=0.2564, μₗ^{insen}=−0.2817

σₖ^{avg}=0.8587, σₗ^{avg}=0.829, ρ_{k,l}^{avg}=0.02375

P(Cᵢ^{sensitive})=0.1917, P(Cᵢ^{insensitive})=0.8083

Rule21

Gene 1: SID W 487535 Human mRNA for KIAA0080 gene partial cds [5′:AA043528 3′:AA043529]

Gene 2: ESTs Chr.6 [144805 (EW) 5′:R76279 3′:R76556]

Drug: Clomesone

Parameters:

μₖ^{sen}=1.184, μₗ^{sen}=0.4822

μₖ^{insen}=−0.2817, μₗ^{insen}=−0.1143

σₖ^{avg}=0.829, σₗ^{avg}=0.9949, ρ_{k,l}^{avg}=−0.2002

P(Cᵢ^{sensitive})=0.1917, P(Cᵢ^{insensitive})=0.8083

Rule 22

Gene 1: SID W 487535 Human mRNA for KIAA0080 gene partial cds [5′:AA043528 3′:AA043529]

Gene 2: SID W 488333 ESTs [5′:AA046755 3′:AA046642]

Drug: Clomesone

Parameters:

μₖ^{sen}=1.184, μₗ^{sen}=−0.1604

μₖ^{insen}=−0.2817, μₗ^{insen}=0.03825

σₖ^{avg}=0.829, σₗ^{avg}=1.011, ρ_{k,l}^{avg}=0.3461

P(Cᵢ^{sensitive})=0.1917, P(Cᵢ^{insensitive})=0.8083

Rule 23

Gene 1: ANX3 Annexin III (lipocortin III) Chr.4 [328683 (IW) 5′:W40286 3′:W45327]

Gene 2: SID W 487535 Human mRNA for KIAA0080 gene partial cds [5′:AA043528 3′:AA043529]

Drug: Clomesone

Parameters:

μₖ^{sen}=−0.7239, μₗ^{sen}=1.184

μₖ^{insen}=0.1714, μₗ^{insen}=−0.2817

σₖ^{avg}=0.9663, σₗ^{avg}=0.829, ρ_{k,l}^{avg}=−0.1129

P(Cᵢ^{sensitive})=0.1917, P(Cᵢ^{insensitive})=0.8083

Rule 24

Gene 1: SID 308729 ESTs [5′:W25229 3′:N95389]

Gene 2: SID W 487535 Human mRNA for KIAA0080 gene partial cds [5′:AA043528 3′:AA043529]

Drug: Clomesone

Parameters:

μₖ^{sen}=−0.6074, μₗ^{sen}=1.184

μₖ^{insen}=0.1438, μₗ^{insen}=−0.2817

σₖ^{avg}=0.9876, σₗ^{avg}=0.829, ρ_{k,l}^{avg}=0.1155

P(Cᵢ^{sensitive})=0.1917, P(Cᵢ^{insensitive})=0.8083

Rule 25

Gene 1: Metallothionein content-log

Gene 2: SID W 487535 Human mRNA for KIAA0080 gene partial cds [5′:AA043528 3′:AA043529]

Drug: Clomesone

Parameters:

μₖ^{sen}=0.5109, μₗ^{sen}=1.184

μₖ^{insen}=−0.1211, μₗ^{insen}=−0.2817

σₖ^{avg}=0.9435, σₗ^{avg}=0.829, ρ_{k,l}^{avg}=−0.3179

P(Cᵢ^{sensitive})=0.1917, P(Cᵢ^{insensitive})=0.8083

Rule 26

Gene 1: ESTs Chr.14 [160605 (E) 5′:H25013 3′:H25014]

Gene 2: SID W 487535 Human mRNA for KIAA0080 gene partial cds [5′:AA043528 3′:AA043529]

Drug: Clomesone

Parameters:

μₖ^{sen}=−0.7174, μₗ^{sen}=1.184

μₖ^{insen}=0.1703, μₗ^{insen}=−0.2817

σₖ^{avg}=0.9506, σₗ^{avg}=0.829, ρ_{k,l}^{avg}=0.01308

P(Cᵢ^{sensitive})=0.1917, P(Cᵢ^{insensitive})=0.8083

Rule 27

Gene 1: SID W 510534 MAJOR GASTROINTESTINAL TUMOR-ASSOCIATED PROTEIN GA733-2 PRECURSOR [5′:AA055858 3′:AA055808]

Gene 2: SID W 242844 ESTs Moderately similar to !!!! ALU SUBFAMILY J WARNING ENTRY !!!! [H.sapiens] [5′:H94138 3′:H94064]

Drug: Clomesone

Parameters:

μₖ^{sen}=−0.867, μₗ^{sen}=−1.079

μₖ^{insen}=0.2052, μₗ^{insen}=0.2564

σₖ^{avg}=0.9304, σₗ^{avg}=0.8587, ρ_{k,l}^{avg}=−0.08247

P(Cᵢ^{sensitive})=0.1917, P(Cᵢ^{insensitive})=0.8083

Rule 28

Gene 1: SID W 489262 Allograft inflammatory factor 1 [5′:AA045718 3′:AA045719]

Gene 2: SID W 489301 ESTs [5′:AA054471 3′:AA058511]

Drug: PCNU

Parameters:

μₖ^{sen}=−0.1844, μₗ^{sen}=0.7991

μₖ^{insen}=0.04227, μₗ^{insen}=−0.1796

σₖ^{avg}=0.9895, σₗ^{avg}=0.9465, ρ_{k,l}^{avg}=0.7317

P(Cᵢ^{sensitive})=0.1833, P(Cᵢ^{insensitive})=0.8167

Rule 29

Gene 1: p53 mutation-log

Gene 2: SID 43555 MALATE OXIDOREDUCTASE [5′:H13370 3′:H06037]

Drug: Fluorouracil (5FU)

Parameters:

μₖ^{sen}=0.9274, μₗ^{sen}=0.9686

μₖ^{insen}=−0.1772, μₗ^{insen}=−0.1883

σₖ^{avg}=0.899, σₗ^{avg}=0.9219, ρ_{k,l}^{avg}=−0.186

P(Cᵢ^{sensitive})=0.1628, P(Cᵢ^{insensitive})=0.8372

Rule 30

Gene 1: ME2 Malic enzyme 2 mitochondrial Chr.18 [109375 (IW) 5′:T80865 3′:T70290]

Gene 2: SID W 488806 Thioredoxin [5′:AA045051 3′:AA045052]

Drug: Asaley

Parameters:

μₖ^{sen}=0.7873, μₗ^{sen}=−0.922

μₖ^{insen}=−0.182, μₗ^{insen}=0.2136

σₖ^{avg}=0.9409, σₗ^{avg}=0.9102, ρ_{k,l}^{avg}=0.3849

P(Cᵢ^{sensitive})=0.1878, P(Cᵢ^{insensitive})=0.8122

Rule 31

Gene 1: X-ray induction of mdm2-log

Gene 2: Human thymosin beta-4 mRNA complete cds Chr.20 [305890 (IW) 5′:W19923 3′:N91268]

Drug: Cytarabine (araC)

Parameters:

μₖ^{sen}=0.5649, μₗ^{sen}=−0.7694

μₖ^{insen}=−0.2054, μₗ^{insen}=0.2788

σₖ^{avg}=0.8243, σₗ^{avg}=0.8663, ρ_{k,l}^{avg}=0.2969

P(Cᵢ^{sensitive})=0.2661, P(Cᵢ^{insensitive})=0.7339

Rule 32

Gene 1: *EST H49897 SID 429460 ESTs [5′:3′:AA007629]

Gene 2: TXNRD1 Thioredoxin reductase Chr.12 [510377 (IW) 5′:AA055407 3′:AA055408]

Drug: Anthrapyrazole-derivative

Parameters:

μₖ^{sen}=−0.8238, μₗ^{sen}=0.8618

μₖ^{insen}=0.2071, μₗ^{insen}=−0.2166

σₖ^{avg}=0.934, σₗ^{avg}=0.9084, ρ_{k,l}^{avg}=0.2681

P(Cᵢ^{sensitive})=0.2006, P(Cᵢ^{insensitive})=0.7994

Rule 33

Gene 1: PTN Pleiotrophin (heparin binding growth factor 8 neurite growth-promoting factor 1) Chr.7 [488801 (IW) 5′:AA045053 3′:AA045054]

Gene 2: TXNRD1 Thioredoxin reductase Chr.12 [510377 (IW) 5′:AA055407 3′:AA055408]

Drug: Anthrapyrazole-derivative

Parameters:

μₖ^{sen}=0.8776, μₗ^{sen}=0.8618

μₖ^{insen}=−0.2227, μₗ^{insen}=−0.2166

σₖ^{avg}=0.8932, σₗ^{avg}=0.9084, ρ_{k,l}^{avg}=−0.3478

P(Cᵢ^{sensitive})=0.2006, P(Cᵢ^{insensitive})=0.7994

Rule 34

Gene 1: SID W 345683 ESTs Highly similar to INTEGRAL MEMBRANE GLYCOPROTEIN GP210 PRECURSOR [Rattus norvegicus] [5′:W76432 3′:W72039]

Gene 2: ESTs Chr.5 [322749 (I) 5′:3′:W15473]

Drug: Daunorubicin

Parameters:

μₖ^{sen}=0.918, μₗ^{sen}=−0.7006

μₖ^{insen}=−0.2022, μₗ^{insen}=0.1549

σₖ^{avg}=0.8758, σₗ^{avg}=0.9296, ρ_{k,l}^{avg}=0.2797

P(Cᵢ^{sensitive})=0.1811, P(Cᵢ^{insensitive})=0.8189

Rule 35

Gene 1: L-LACTATE DEHYDROGENASE M CHAIN Chr. 11 [510595 (IW) 5′:AA057759 3′:AA057760]

Gene 2: Homo sapiens T245 protein (T245) mRNA complete cds Chr.X [343063 (IW) 5′:W67989 3′:W68001]

Drug: Daunorubicin

Parameters:

μₖ^{sen}=−0.7199, μₗ^{sen}=−1.061

μₖ^{insen}=0.1588, μₗ^{insen}=−0.234

σₖ^{avg}=0.9279, σₗ^{avg}=0.8647, ρ_{k,l}^{avg}=−0.2833

P(Cᵢ^{sensitive})=0.1811, P(Cᵢ^{insensitive})=0.8189

Rule 36

Gene 1: SID W 345683 ESTs Highly similar to INTEGRAL MEMBRANE GLYCOPROTEIN GP210 PRECURSOR [Rattus norvegicus] [5′:W76432 3′:W72039]

Gene 2: SID W 510534 MAJOR GASTROINTESTINAL TUMOR-ASSOCIATED PROTEIN GA733-2 PRECURSOR [5′:AA055858 3′:AA055808]

Drug: Daunorubicin

Parameters:

μₖ^{sen}=0.918, μₗ^{sen}=−0.437

μₖ^{insen}=−0.2022, μₗ^{insen}=0.09623

σₖ^{avg}=0.8758, σₗ^{avg}=0.9836, ρ_{k,l}^{avg}=0.525

P(Cᵢ^{sensitive})=0.1811, P(Cᵢ^{insensitive})=0.8189

Rule 37

Gene 1: ESTs Chr.2 [149542 (DW) 5′:H00283 3′:H00284]

Gene 2: ESTsSID 429074 [5′:AA005275 3′:AA005169]

Drug: Daunorubicin

Parameters:

μₖ^{sen}=−1.052, μₗ^{sen}=−0.647

μₖ^{insen}=0.2324, μₗ^{insen}=0.1424

σₖ^{avg}=0.8508, σₗ^{avg}=0.9537, ρ_{k,l}^{avg}=0.06225

P(Cᵢ^{sensitive})=0.1811, P(Cᵢ^{insensitive})=0.8189

Rule 38

Gene 1: SID W 345683 ESTs Highly similar to INTEGRAL MEMBRANE GLYCOPROTEIN GP210 PRECURSOR [Rattus norvegicus] [5′:W76432 3′:W72039]

Gene 2: Human clone 23933 mRNA sequence Chr.17 [23933 (W) 5′:T77288 3′:R39465]

Drug: Daunorubicin

Parameters:

μₖ^{sen}=0.918, μₗ^{sen}=0.4489

μₖ^{insen}=−0.2022, μₗ^{insen}=−0.09989

σₖ^{avg}=0.8758, σₗ^{avg}=1.004, ρ_{k,l}^{avg}=−0.5196

P(Cᵢ^{sensitive})=0.1811, P(Cᵢ^{insensitive})=0.8189

Rule 39

Gene 1: GRL Glucocorticoid receptor Chr.5 [262691 (E) 5′:3′:H99414]

Gene 2: *Prothymosin alpha SID W 271976 AMINOACYLASE-1 [5′:N44687 3′:N35315]

Drug: Daunorubicin

Parameters:

μₖ^{sen}=0.3732, μₗ^{sen}=−1.032

μₖ^{insen}=−0.08233, μₗ^{insen}=0.2284

σₖ^{avg}=0.9501, σₗ^{avg}=0.858, ρ_{k,l}^{avg}=0.3514

P(Cᵢ^{sensitive})=0.1811, P(Cᵢ^{insensitive})=0.8189

Rule 40

Gene 1: *Prothymosin alpha SID W 271976 AMINOACYLASE-1 [5′:N44687 3′:N35315]

Gene 2: PLAUR Plasminogen activator urokinase receptor Chr.19 [325077 (DIW) 5′:W49705 3′:W49706]

Drug: Daunorubicin

Parameters:

μₖ^{sen}=−1.032, μₗ^{sen}=0.1522

μₖ^{insen}=0.2284, μₗ^{insen}=−0.03346

σₖ^{avg}=0.858, σₗ^{avg}=0.9987, ρ_{k,l}^{avg}=0.5897

P(Cᵢ^{sensitive})=0.1811, P(Cᵢ^{insensitive})=0.8189

Rule 41

Gene 1: ESTs Chr.2 [149542 (DW) 5′:H00283 3′:H00284]

Gene 2: ESTs Chr.2 [365120 (IW) 5′:AA025204 3′:AA025124]

Drug: Daunorubicin

Parameters:

μₖ^{sen}=−1.052, μₗ^{sen}=0.2085

μₖ^{insen}=0.2324, μₗ^{insen}=−0.04633

σₖ^{avg}=0.8508, σₗ^{avg}=1.018, ρ_{k,l}^{avg}=0.376

P(Cᵢ^{sensitive})=0.1811, P(Cᵢ^{insensitive})=0.8189

Rule 42

Gene 1: ESTs Chr.2 [149542 (DW) 5′:H00283 3′:H00284]

Gene 2: Ribosomal protein L17SID 60561 [5′:T39375 3′:T40540]

Drug: Daunorubicin

Parameters:

μₖ^{sen}=−1.052, μₗ^{sen}=−0.5213

μₖ^{insen}=0.2324, μₗ^{insen}=0.1147

σₖ^{avg}=0.8508, σₗ^{avg}=0.9713, ρ_{k,l}^{avg}=−0.2356

P(Cᵢ^{sensitive})=0.1811, P(Cᵢ^{insensitive})=0.8189

Rule 43

Gene 1: ESTs Chr.2 [149542 (DW) 5′:H00283 3′:H00284]

Gene 2: Glutathione S-Tranferase M1a-log

Drug: Daunorubicin

Parameters:

μₖ^{sen}=−1.052, μₗ^{sen}=0.1809

μₖ^{insen}=0.2324, μₗ^{insen}=−0.03737

σₖ^{avg}=0.8508, σₗ^{avg}=1.033, ρ_{k,l}^{avg}=0.1657

P(Cᵢ^{sensitive})=0.1811, P(Cᵢ^{insensitive})=0.8189

Rule 44

Gene 1: SID 260288 ESTs [5′:H97716 3′:H96798]

Gene 2: SID W 358185 Human mitochondrial 2,4-dienoyl-CoA reductase mRNA complete cds [5′:W95455 3′:W95406]

Drug: Daunorubicin

Parameters:

μₖ^{sen}=−0.9929, μₗ^{sen}=−0.5507

μₖ^{insen}=0.2192, μₗ^{insen}=0.1224

σₖ^{avg}=0.9063, σₗ^{avg}=0.9734, ρ_{k,l}^{avg}=−0.4799

P(Cᵢ^{sensitive})=0.1811, P(Cᵢ^{insensitive})=0.8189

Rule 45

Gene 1: ESTs Chr.2 [149542 (DW) 5′:H00283 3′:H00284]

Gene 2: L-LACTATE DEHYDROGENASE M CHAIN Chr.11 [510595 (IW) 5′:AA057759 3′:AA057760]

Drug: Daunorubicin

Parameters:

μₖ^{sen}=−1.052, μₗ^{sen}=−0.7199

μₖ^{insen}=0.2324, μₗ^{insen}=−0.1588

σₖ^{avg}=0.8508, σₗ^{avg}=0.9279, ρ_{k,l}^{avg}=−0.1035

P(Cᵢ^{sensitive})=0.1811, P(Cᵢ^{insensitive})=0.8189

Rule 46

Gene 1: SID W 471763 Crystallin zeta (quinone reductase) [5′:AA035179 3′:AA035180]

Gene 2: ESTs Chr.2 [149542 (DW) 5′:H00283 3′:H00284]

Drug: Daunorubicin

Parameters:

μₖ^{sen}=−0.5185, μₗ^{sen}=−1.052

μₖ^{insen}=0.1147, μₗ^{insen}=0.2324

σₖ^{avg}=0.9683, σₗ^{avg}=0.8508, ρ_{k,l}^{avg}=−0.06753

P(Cᵢ^{sensitive})=0.1811, P(Cᵢ^{insensitive})=0.8189

Rule 47

Gene 1: SID W 345683 ESTs Highly similar to INTEGRAL MEMBRANE GLYCOPROTEIN GP210 PRECURSOR [Rattus norvegicus] [5′:W76432 3′:W72039]

Gene 2: SID W 489301 ESTs [5′:AA054471 3′:AA058511]

Drug: Daunorubicin

Parameters:

μₖ^{sen}=0.918, μₗ^{sen}=0.7391

μₖ^{insen}=−0.2022, μₗ^{insen}=−0.1637

σₖ^{avg}=0.8758, σₗ^{avg}=0.9515, ρ_{k,l}^{avg}=−0.3077

P(Cᵢ^{sensitive})=0.1811, P(Cᵢ^{insensitive})=0.8189

Rule 48

Gene 1: ESTs Chr.2 [149542 (DW) 5′:H00283 3′:H00284]

Gene 2: *Aldehyde reductase 1 (low Km aldose reductase) SID W 418212 ESTs [5′:W90268 3′:W90593]

Drug: Daunorubicin

Parameters:

μₖ^{sen}=−1.052, μₗ^{sen}=0.09908

μₖ^{insen}=0.2324, μₗ^{insen}=−0.02151

σₖ^{avg}=0.8508, σₗ^{avg}=1.014, ρ_{k,l}^{avg}=0.4702

P(Cᵢ^{sensitive})=0.1811, P(Cᵢ^{insensitive})=0.8189

Rule 49

Gene 1: ESTs Chr.2 [149542 (DW) 5′:H00283 3′:H00284]

Gene 2: SID W 484773 PYRROLINE-5-CARBOXYLATE REDUCTASE [5′:AA037688 3′:AA037689]

Drug: Daunorubicin

Parameters:

μₖ^{sen}=−1.052, μₗ^{sen}=−0.7351

μₖ^{insen}=0.2324, μₗ^{insen}=0.1628

σₖ^{avg}=0.8508, σₗ^{avg}=0.9291, ρ_{k,l}^{avg}=−0.1858

P(Cᵢ^{sensitive})=0.1811, P(Cᵢ^{insensitive})=0.8189

Rule 50

Gene 1: SID W 484773 PYRROLINE-5-CARBOXYLATE REDUCTASE [5′:AA037688 3′:AA037689]

Gene 2: *Prothymosin alpha SID W 271976 AMINOACYLASE-1 [5′:N44687 3′:N35315]

Drug: Daunorubicin

Parameters:

μₖ^{sen}=−0.7351, μₗ^{sen}=−1.032

μₖ^{insen}=0.1628, μₗ^{insen}=0.2284

σₖ^{avg}=0.9291, σₗ^{avg}=0.858, ρ_{k,l}^{avg}=0.2602

P(Cᵢ^{sensitive})=0.1811, P(Cᵢ^{insensitive})=0.8189

Rule 51

Gene 1: ESTs Chr.16 [154654 (RW) 5′:R55184 3′:R55185]

Gene 2: ELONGATION FACTOR TU MITOCHONDRIAL PRECURSOR Chr. 16 [429540 (W) 5′:AA011453 3′:AA011397]

Drug: Daunorubicin

Parameters:

μₖ^{sen}=0.8271, μₗ^{sen}=−0.994

μₖ^{insen}=−0.1829, μₗ^{insen}=0.2199

σₖ^{avg}=0.9198, σₗ^{avg}=0.8654, ρ_{k,l}^{avg}=0.223

P(Cᵢ^{sensitive})=0.1811, P(Cᵢ^{insensitive})=0.8189

Rule 52

Gene 1: SID 234072 EST Highly similar to RETROVIRUS-RELATED POL POLYPROTEIN [Homo sapiens] [5′:3′:H69001]

Gene 2: ESTs Chr.2 [149542 (DW) 5′:H00283 3′:H00284]

Drug: Daunorubicin

Parameters:

μₖ^{sen}=−0.5103, μₗ^{sen}=−1.052

μₖ^{insen}=0.1131, μₗ^{insen}=−0.2324

σₖ^{avg}=0.9797, σₗ^{avg}=0.8508, ρ_{k,l}^{avg}=−0.1946

P(Cᵢ^{sensitive})=0.1811, P(Cᵢ^{insensitive})=0.8189

Rule 53

Gene 1: ELONGATION FACTOR TU MITOCHONDRIAL PRECURSOR Chr. 16 [429540 (IW) 5′:AA011453 3′:AA011397]

Gene 2: ESTs Chr.2 [365120 (IW) 5′:AA025204 3′:AA025124]

Drug: Amsacrine

Parameters:

μₖ^{sen}=−0.7939, μₗ^{sen}=0.558

μₖ^{insen}=0.2239, μₗ^{insen}=−0.1576

σₖ^{avg}=0.8691, σₗ^{avg}=0.9701, ρ_{k,l}^{avg}=0.4985

P(Cᵢ^{sensitive})=0.22, P(Cᵢ^{insensitive})=0.78

Rule 54

Gene 1: SID W 489301 ESTs [5′:AA054471 3′:AA058511]

Gene 2: H.sapiens mRNA for TRAMP protein Chr.8 [149355 (IEW) 5′:H01598 3′:H01495]

Drug: Pyrazoloimidazole

Parameters:

μₖ^{sen}=0.9637, μₗ^{sen}=0.7678

μₖ^{insen}=−0.2165, μₗ^{insen}=−0.1717

σₖ^{avg}=0.8641, σₗ^{avg}=0.9249, ρ_{k,l}^{avg}=−0.4318

P(Cᵢ^{sensitive})=0.1833, P(Cᵢ^{insensitive})=0.8167

Rule 55

Gene 1: GAMMA-INTERFERON-INDUCIBLE PROTEIN IP-30 PRECURSOR Chr.19 [310021 (I) 5′:3′:N99151]

Gene 2: SID W 487113 Msh (Drosophila) homeo box homolog 1 (formerly homeo box 7) [5′:AA045226 3′:AA045325]

Drug: CPT,10-OH

Parameters:

μₖ^{sen}=−0.9086, μₗ^{sen}=0.8196

μₖ^{insen}=0.2078, μₗ^{insen}=−0.1876

σₖ^{avg}=0.8915, σₗ^{avg}=0.8784, ρ_{k,l}^{avg}=0.3086

P(Cᵢ^{sensitive})=0.1856, P(Cᵢ^{insensitive})=0.8144

Rule 56

Gene 1: GAMMA-INTERFERON-INDUCIBLE PROTEIN IP-30 PRECURSOR Chr.19 [310021 (I) 5′:3′:N99151]

Gene 2: SID W 346587 Homo sapiens quiescin (Q6) mRNA complete cds [5′:W79188 3′:W74434]

Drug: CPT,10-OH

Parameters:

μₖ^{sen}=−0.9086, μₗ^{sen}=1.001

μₖ^{insen}=0.2078, μₗ^{insen}=−0.2285

σₖ^{avg}=0.8915, σₗ^{avg}=0.8549, ρ_{k,l}^{avg}=−0.09544

P(Cᵢ^{sensitive})=0.1856, P(Cᵢ^{insensitive})=0.8144

Rule 57

Gene 1: SID W 510189 Homo sapiens CAG-isl 7 mRNA complete cds [5′:AA053648 3′:AA053259]

Gene 2: SID W 510534 MAJOR GASTROINTESTINAL TUMOR-ASSOCIATED PROTEIN GA733-2 PRECURSOR [5′:AA055858 3′:AA055808]

Drug: CPT,10-OH

Parameters:

μₖ^{sen}=0.4935, μₗ^{sen}=−0.6863

μₖ^{insen}=−0.1128, μₗ^{insen}=0.1559

σₖ^{avg}=0.9732, σₗ^{avg}=0.9458, ρ_{k,l}^{avg}=0.6221

P(Cᵢ^{sensitive})=0.1856, P(Cᵢ^{insensitive})=0.8144

Rule 58

Gene 1: GAMMA-INTERFERON-INDUCIBLE PROTEIN IP-30 PRECURSOR Chr.19 [310021 (I) 5′:3′:N99151]

Gene 2: COL4A1 Collagen type IV alpha 1 Chr.13 [489467 (IEW) 5′:AA054624 3′:AA054564]

Drug: CPT,10-OH

Parameters:

μₖ^{sen}=−0.9086, μₗ^{sen}=0.8311

μₖ^{insen}=0.2078, μₗ^{insen}=−0.1889

σₖ^{avg}=0.8915, σₗ^{avg}=0.9008, ρ_{k,l}^{avg}=0.04514

P(Cᵢ^{sensitive})=0.1856, P(Cᵢ^{insensitive})=0.8144

Rule 59

Gene 1: GAMMA-INTERFERON-INDUCIBLE PROTEIN IP-30 PRECURSOR Chr.19 [310021 (I) 5′:3′:N99151]

Gene 2: SID 512355 ESTs Highly similar to SRC SUBSTRATE P80/85 PROTEINS [Gallus gallus] [5′:AA059424 3′:AA057835]

Drug: CPT,10-OH

Parameters:

μₖ^{sen}=−0.9086, μₗ^{sen}=0.8282

μₖ^{insen}=0.2078, μₗ^{insen}=−0.1885

σₖ^{avg}=0.8915, σₗ^{avg}=0.9162, ρ_{k,l}^{avg}=−0.1186

P(Cᵢ^{sensitive})=0.1856, P(Cᵢ^{insensitive})=0.8144

Rule 60

Gene 1: GAMMA-INTERFERON-INDUCIBLE PROTEIN IP-30 PRECURSOR Chr.19 [310021 (I) 5′:3′:N99151]

Gene 2: SID W 324073 Human lysyl oxidase-like protein mRNA complete cds [5′:W46647 3′:W465643]

Drug: CPT,10-OH

Parameters:

μₖ^{sen}=−0.9086, μₗ^{sen}=0.7583

μₖ^{insen}=0.2078, μₗ^{insen}=−0.1738

σₖ^{avg}=0.8915, σₗ^{avg}=0.9205, ρ_{k,l}^{avg}=0.2083

P(Cᵢ^{sensitive})=0.1856, P(Cᵢ^{insensitive})=0.8144

Rule 61

Gene 1: GAMMA-INTERFERON-INDUCIBLE PROTEIN IP-30 PRECURSOR Chr.19 [310021 (I) 5′:3′:N99151]

Gene 2: SID W 376472 Homo sapiens clone 24429 mRNA sequence [5′:AA041443 3′:AA041360]

Drug: CPT,10-OH

Parameters:

μₖ^{sen}=−0.9086, μₗ^{sen}=0.7273

μₖ^{insen}=0.2078, μₗ^{insen}=−0.1653

σₖ^{avg}=0.8915, σₗ^{avg}=0.927, ρ_{k,l}^{avg}=0.02373

P(Cᵢ^{sensitive})=0.1856, P(Cᵢ^{insensitive})=0.8144

Rule 62

Gene 1: SID W 487535 Human mRNA for KIAA0080 gene partial cds [5′:AA043528 3′:AA043529]

Gene 2: Homo sapiens (clone 35.3) DRAL mRNA complete cds Chr.2 [324636 (IW) 5′:W46933 3′:W46835]

Drug: CPT,10-OH

Parameters:

μₖ^{sen}=0.8729, μₗ^{sen}=0.7843

μₖ^{insen}=0.1997, μₗ^{insen}=−0.1778

σₖ^{avg}=0.8949, σₗ^{avg}=0.9125, ρ_{k,l}^{avg}=−0.1147

P(Cᵢ^{sensitive})=0.1856, P(Cᵢ^{insensitive})=0.8144

Rule 63

Gene 1: GAMMA-INTERFERON-INDUCIBLE PROTEIN IP-30 PRECURSOR Chr.19 [310021 (I) 5′:3′:N99151]

Gene 2: SID W 487878 SPARC/osteonectin [5′:AA046533 3′:AA045463]

Drug: CPT,10-OH

Parameters:

μₖ^{sen}=−0.9086, μₗ^{sen}=0.8472

μₖ^{insen}=0.2078, μₗ^{insen}=−0.1926

σₖ^{avg}=0.8915, σₗ^{avg}=0.898, ρ_{k,l}^{avg}=0.04153

P(Cᵢ^{sensitive})=0.1856, P(Cᵢ^{insensitive})=0.8144

Rule 64

Gene 1: GAMMA-INTERFERON-INDUCIBLE PROTEIN IP-30 PRECURSOR Chr.19 [310021 (I) 5′:3′:N99151]

Gene 2:

Drug: CPT,10-OH

Parameters:

μₖ^{sen}=−0.9086, μₗ^{sen}=0.6293

μₖ^{insen}=0.2078, μₗ^{insen}=−0.1436

σₖ^{avg}=0.8915, σₗ^{avg}=0.9536, ρ_{k,l}^{avg}=0.1463

P(Cᵢ^{sensitive})=0.1856, P(Cᵢ^{insensitive})=0.8144

Rule 65

Gene 1: ESTs Chr.X [254029 (IRW) 5′:N75199 3′:N22323]

Gene 2: SID W 346587 Homo sapiens quiescin (Q6) mRNA complete cds [5′:W79188 3′:W74434]

Drug: CPT,10-OH

Parameters:

μₖ^{sen}=0.1804, μₗ^{sen}=1.001

μₖ^{insen}=−0.04026, μₗ^{insen}=−0.2285

σₖ^{avg}=1.01, σₗ^{avg}=0.8549, ρ_{k,l}^{avg}=−0.04875

P(Cᵢ^{sensitive})=0.1856, P(Cᵢ^{insensitive})=0.8144

Rule 66

Gene 1: SID W 364810 ESTs [5′:AA034430 3′:AA053921]

Gene 2: GAMMA-INTERFERON-INDUCIBLE PROTEIN IP-30 PRECURSOR Chr.19 [310021 (I) 5′:3′:N99151]

Drug: CPT,10-OH

Parameters:

μₖ^{sen}=−0.6399, μₗ^{sen}=−0.9086

μₖ^{insen}=0.1449, μₗ^{insen}=0.2078

σₖ^{avg}=0.9312, σₗ^{avg}=0.8915, ρ_{k,l}^{avg}=−0.1262

P(Cᵢ^{sensitive})=0.1856, P(Cᵢ^{insensitive})=0.8144

Rule 67

Gene 1: GAMMA-INTERFERON-INDUCIBLE PROTEIN IP-30 PRECURSOR Chr.19 [310021 (I) 5′:3′:N99151]

Gene 2: SID 257009 ESTs [5′:N39759 3′:N26801]

Drug: CPT,10-OH

Parameters:

μₖ^{sen}=−0.9086, μₗ^{sen}=0.5127

μₖ^{insen}=0.2078, μₗ^{insen}=−0.1168

σₖ^{avg}=0.8915, σₗ^{avg}=0.9602, ρ_{k,l}^{avg}=0.1779

P(Cᵢ^{sensitive})=0.1856, P(Cᵢ^{insensitive})=0.8144

Rule 68

Gene 1: SID 512355 ESTs Highly similar to SRC SUBSTRATE P80/85 PROTEINS [Gallus gallus] [5′:AA059424 3′:AA057835]

Gene 2: SID W 346587 Homo sapiens quiescin (Q6) mRNA complete cds [5′:W79188 3′:W74434]

Drug: CPT,10-OH

Parameters:

μₖ^{sen}=0.8282, μₗ^{sen}=1.001

μₖ^{insen}=−0.1885, μₗ^{insen}=−0.2285

σₖ^{avg}=0.9162, σₗ^{avg}=0.8549, ρ_{k,l}^{avg}=0.18

P(Cᵢ^{sensitive})=0.1856, P(Cᵢ^{insensitive})=0.8144

Rule 69

Gene 1: ASNS Asparagine synthetase Chr.7 [510206 (W) 5′:AA053213 3′:AA053461]

Gene 2: SID W 346587 Homo sapiens quiescin (Q6) mRNA complete cds [5′:W79188 3′:W74434]

Drug: CPT,10-OH

Parameters:

μₖ^{sen}=−0.7243, μₗ^{sen}=1.001

μₖ^{insen}=0.1648, μₗ^{insen}=−0.2285

σₖ^{avg}=0.9358, σₗ^{avg}=0.8549, ρ_{k,l}^{avg}=−0.06293

P(Cᵢ^{sensitive})=0.1856, P(Cᵢ^{insensitive})=0.8144

Rule 70

Gene 1: GAMMA-INTERFERON-INDUCIBLE PROTEIN IP-30 PRECURSOR Chr.19 [310021 (I) 5′:3′:N99151]

Gene 2: Human extracellular protein (S1-5) mRNA complete cds Chr.2 [485875 (EW) 5′:AA040442 3′:AA040443]

Drug: CPT,10-OH

Parameters:

μₖ^{sen}=−0.9086, μₗ^{sen}=0.7657

μₖ^{insen}=0.2078, μₗ^{insen}=−0.1743

σₖ^{avg}=0.8915, σₗ^{avg}=0.9202, ρ_{k,l}^{avg}=−0.1283

P(Cᵢ^{sensitive})=0.1856, P(Cᵢ^{insensitive})=0.8144

Rule 71

Gene 1: GAMMA-INTERFERON-INDUCIBLE PROTEIN IP-30 PRECURSOR Chr.19 [310021 (I) 5′:3′:N99151]

Gene 2: Homo sapiens lysyl hydroxylase isoform 2 (PLOD2) mRNA complete cds Chr.3 [310449 (IW) 5′:W30982 3′:N98463]

Drug: CPT,10-OH

Parameters:

μₖ^{sen}=−0.9086, μₗ^{sen}=0.6335

μₖ^{insen}=0.2078, μₗ^{insen}=−0.1445

σₖ^{avg}=0.8915, σₗ^{avg}=0.9558, ρ_{k,l}^{avg}=0.1739

P(Cᵢ^{sensitive})=0.1856, P(Cᵢ^{insensitive})=0.8144

Rule 72

Gene 1: GAMMA-INTERFERON-INDUCIBLE PROTEIN IP-30 PRECURSOR Chr.19 [310021 (I) 5′:3′:N99151]

Gene 2: SID W 486110 Profilin 2 [5′:AA043167 3′:AA040703]

Drug: CPT,10-OH

Parameters:

μₖ^{sen}=−0.9086, μₗ^{sen}=0.7038

μₖ^{insen}=0.2078, μₗ^{insen}=−0.1605

σₖ^{avg}=0.8915, σₗ^{avg}=0.9573, ρ_{k,l}^{avg}=0.08051

P(Cᵢ^{sensitive})=0.1856, P(Cᵢ^{insensitive})=0.8144

Rule 73

Gene 1: GAMMA-INTERFERON-INDUCIBLE PROTEIN IP-30 PRECURSOR Chr.19 [310021 (I) 5′:3′:N99151]

Gene 2: SID 42787 ESTs [5′:R59827 3′:R59717]

Drug: CPT,10-OH

Parameters:

μₖ^{sen}=−0.9086, μₗ^{sen}=0.5759

μₖ^{insen}=0.2078, μₗ^{insen}=−0.1318

σₖ^{avg}=0.8915, σₗ^{avg}=0.961, ρ_{k,l}^{avg}=0.06258

P(Cᵢ^{sensitive})=0.1856, P(Cᵢ^{insensitive})=0.8144

Rule 74

Gene 1: GAMMA-INTERFERON-INDUCIBLE PROTEIN IP-30 PRECURSOR Chr.19 [310021 (I) 5′:3′:N99151]

Gene 2: SID 50243 ESTs [5′:H17681 3′:H17066]

Drug: CPT,10-OH

Parameters:

μₖ^{sen}=−0.9086, μₗ^{sen}=0.8677

μₖ^{insen}=0.2078, μₗ^{insen}=−0.1977

σₖ^{avg}=0.8915, σₗ^{avg}=0.9058, ρ_{k,l}^{avg}=−0.1472

P(Cᵢ^{sensitive})=0.1856, P(Cᵢ^{insensitive})=0.8144

Rule 75

Gene 1: SID W 346587 Homo sapiens quiescin (Q6) mRNA complete cds [5′:W79188 3′:W74434]

Gene 2: SID 359504 ESTs [5′:3′:AA010589]

Drug: CPT,10-OH

Parameters:

μₖ^{sen}=1.001, μₗ^{sen}=−0.336

μₖ^{insen}=−0.2285, μₗ^{insen}=0.07633

σₖ^{avg}=0.8549, σₗ^{avg}=0.9733, ρ_{k,l}^{avg}=0.3387

P(Cᵢ^{sensitive})=0.1856, P(Cᵢ^{insensitive})=0.8144

Rule 76

Gene 1: SID 39144 ESTs Weakly similar to Rep-8 [H.sapiens] [5′:R51769 3′:R51770]

Gene 2: SID W 358526 ESTs [5′:W96039 3′:W94821]

Drug: CPT,20-ester (S)

Parameters:

μₖ^{sen}=−0.8367, μₗ^{sen}=−0.771

μₖ^{insen}=0.2555, μₗ^{insen}=−0.2359

σₖ^{avg}=0.879881, σₗ^{avg}=0.9049, ρ_{k,l}^{avg}=−0.2237

P(Cᵢ^{sensitive})=0.2344, P(Cᵢ^{insensitive})=0.7656

Rule 77

Gene 1: SID 39144 ESTs Weakly similar to Rep-8 [H.sapiens] [5′:R51769 3′:R51770]

Gene 2: SID W 509633 ESTs Moderately similar to Kryn [M.musculus] [5′:AA045560 3′:AA045561]

Drug: CPT,20-ester (S)

Parameters:

μₖ^{sen}=−0.8367, μₗ^{sen}=−0.8637

μₖ^{insen}=0.255, μₗ^{insen}=−0.2643

σₖ^{avg}=0.8798, σₗ^{avg}=0.8771, ρ_{k,l}^{avg}=0.2147

P(Cᵢ^{sensitive})=0.2344, P(Cᵢ^{insensitive})=0.7656

Rule 78

Gene 1: SID 39144 ESTs Weakly similar to Rep-8 [H.sapiens] [5′:R51769 3′:R51770]

Gene 2: *Hs.648 Cut (Drosophila)-like 1 (CCAAT displacement protein) SID W 26677 ESTs [5′:R13994 3′:R39117]

Drug: CPT,20-ester (S)

Parameters:

μₖ^{sen}=−0.8367, μₗ^{sen}=−0.652

μₖ^{insen}=0.2555, μₗ^{insen}=0.1999

σₖ^{avg}=0.8798, σₗ^{avg}=0.9431, ρ_{k,l}^{avg}=−0.3363

P(Cᵢ^{sensitive})=0.2344, P(Cᵢ^{sensitive})=0.7656

Rule 79

Gene 1: SID W 510189 Homo sapiens CAG-isl 7 mRNA complete cds [5′:AA053648 3′:AA053259]

Gene 2: SID W 346510 Homo sapiens hCPE-R mRNA for CPE-receptor complete cds [5′:W79089 3′:W74492]

Drug: CPT

Parameters:

μₖ^{sen}=0.4583, μₗ^{sen}=−0.4683

μₖ^{insen}=−0.161, μₗ^{insen}=0.1634

σₖ^{avg}=0.9838, σₗ^{avg}=0.9573, ρ_{k,l}^{avg}=0.6575

P(Cᵢ^{sensitive})=0.2594, P(Cᵢ^{sensitive})=0.7406

Rule 80

Gene 1: ESTs Chr.19 [485804 (EW) 5′:AA040350 3′:AA040351]

Gene 2: Glyoxalase-I-log

Drug: CPT,20-ester (S)

Parameters:

μₖ^{sen}=−0.7177, μₗ^{sen}=−0.5058

μₖ^{insen}=0.2573, μₗ^{insen}=0.1814

σₖ^{avg}=0.8936, σₗ^{avg}=0.9632, ρ_{k,l}^{avg}=−0.3337

P(Cᵢ^{sensitive})=0.2644, P(Cᵢ^{sensitive})=0.7356

Rule 81

Gene 1: Human G/T mismatch-specific thymine DNA glycosylase mRNA complete cds Chr.X [321997 (IW) 5′:W37234 3′:W37817]

Gene 2: SID W 358526 ESTs [5′:W96039 3′:W94821]

Drug: CPT,11-formyl (RS)

Parameters:

μₖ^{sen}=0.626, μₗ^{sen}=−1.055

μₖ^{insen}=−0.151, μₗ^{insen}=0.2536

σₖ^{avg}=0.977, σₗ^{avg}=0.8569, ρ_{k,l}^{avg}=0.3776

P(Cᵢ^{sensitive})=0.1939, P(Cᵢ^{sensitive})=0.8061

Rule 82

Gene 1: SID W 135118 GATA-binding protein 3 [5′:R31441 3′:R31442]

Gene 2: SID W 358526 ESTs [5′:W96039 3′:W94821]

Drug: CPT,11-formyl (RS)

Parameters:

μₖ^{sen}=0.9817, μₗ^{sen}=−1.055

μₖ^{insen}=−0.2359, μₗ^{insen}=0.2536

σₖ^{avg}=0.9021, σₗ^{avg}=0.8569, ρ_{k,l}^{avg}=−0.08481

P(Cᵢ^{sensitive})=0.1939, P(Cᵢ^{sensitive})=0.8061

Rule 83

Gene 1: ESTs Chr.16 [154654 (W) 5′:R55184 3′:R55185]

Gene 2: SOD2 Superoxide dismutase 2 mitochondrial Chr.6 [144758 (EW) 5′:R76245 3′:R76527]

Drug: CPT,11-formyl (RS)

Parameters:

μₖ^{sen}=0.874, μₗ^{sen}=−0.7046

μₖ^{insen}=−0.2102, μₗ^{insen}=0.1693

σₖ^{avg}=0.9112, σₗ^{avg}=0.9543, ρ_{k,l}^{avg}=0.3184

P(Cᵢ^{sensitive})=0.1939, P(Cᵢ^{sensitive})=0.8061

Rule 84

Gene 1: SID W 358526 ESTs [5′:W96039 3′:W94821]

Gene 2: Glutathione S-Tranferase A1-log

Drug: CPT,11-formyl (RS)

Parameters:

μₖ^{sen}=−1.055, μₗ^{sen}=−0.6283

μₖ^{insen}=0.2536, μₗ^{insen}=0.1488

σₖ^{avg}=0.8569, σₗ^{avg}=0.9702, ρ_{k,l}^{avg}=−0.125

P(Cᵢ^{sensitive})=0.1939, P(Cᵢ^{sensitive})=0.8061

Rule 85

Gene 1: SID W 358526 ESTs [5′:W96039 3′:W94821]

Gene 2: PIGF Phosphatidylinositol glycan class F Chr.2 [486751 (IEW) 5′:AA042803 3′:AA044616]

Drug: CPT,11-formyl (RS)

Parameters:

μₖ^{sen}=−1.055, μₗ^{sen}=−0.4069

μₖ^{insen}=0.2569, μₗ^{insen}=0.09808

σₖ^{avg}=0.8569, σₗ^{avg}=1.003, ρ_{k,l}^{avg}=−0.3618

P(Cᵢ^{sensitive})=0.1939, P(Cᵢ^{sensitive})=0.8061

Rule 86

Gene 1; PROTEASOME COMPONENT C13 PRECURSOR Chr.6 [344774(IW) 5′:W74742 3′:W74705]

Gene 2: SID W 484681 Homo sapiens ES/130 mRNA complete cds [5′:AA037568 3′:AA037487]

Drug: Mechlorethamine

Parameters:

μₖ^{sen}=0.6562, μₗ^{sen}=−0.8883

μₖ^{insen}=−0.1565, μₗ^{insen}=0.2119

σₖ^{avg}=0.9627, σₗ^{avg}=0.9254, ρ_{k,l}^{avg}=−0.5304

P(Cᵢ^{sensitive})=0.1928, P(Cᵢ^{sensitive})=0.8072

Rule 87

Gene 1: SID 43609 ESTs [5′:H06454 3′:H06184]

Gene 2: SID W 53251 Human Zn-15 related zinc finger protein (rlf) mRNA complete cds [5′:R15988 3′:R15987]

Drug: Mechlorethamine

Parameters:

μₖ^{sen}=1.042, μₗ^{sen}=−0.5622

μₖ^{insen}=−0.2493, μₗ^{insen}=0.1345

σₖ^{avg}=0.8728, σₗ^{avg}=0.9712, ρ_{k,l}^{avg}=0.3407

P(Cᵢ^{sensitive})=0.1928, P(Cᵢ^{sensitive})=0.8072

Rule 88

Gene 1: CDH2 Cadherin 2 N-cadherin (neuronal) Chr. [325182 (DIRW) 5′:W48793 3′:W49619]

Gene 2: Homo sapiens (clone 35.3) DRAL mRNA complete cds Chr.2 [324636 (IW) 5′:W46933 3′:W46835]

Drug: Geldanamycin

Parameters:

μₖ^{sen}=−0.8842, μₗ^{sen}=0.09839

μₖ^{insen}=0.225, μₗ^{insen}=−0.02426

σₖ^{avg}=0.8839, σₗ^{avg}=1, ρ_{k,l}^{avg}=−0.6697

P(Cᵢ^{sensitive})=0.2033, P(Cᵢ^{sensitive})=0.7967

Rule 89

Gene 1: ESTsSID 327435 [5′:W32467 3′:W19830]

Gene 2: ESTs Chr.3 [377430 (IW) 5′:AA055159 3′:AA055043]

Drug: Morpholino-adriamycin

Parameters:

μₖ^{sen}=0.7559, μₗ^{sen}=1.064

μₖ^{insen}=−0.1508, μₗ^{insen}=−0.212

σₖ^{avg}=0.9646, σₗ^{avg}=0.9006, ρ_{k,l}^{avg}=−0.2502

P(Cᵢ^{sensitive})=0.1661, P(Cᵢ^{sensitive})=0.8339

Quadratic Discriminant Analysis—2-dimensional (QDA 2D)

This method computes a Bayesian conditional probability P(jεCᵢ^{sensitive}|g^{k}^{j}, gₗ^{j}) that a cell line j is sensitive to drug i, given the abundances of genes k and l, gₖ^{j} and gₗ^{j}, respectively, in cell line j.

The probability is computed using the following equation:

$$P ( j ∈ {C}_{i}^{sensitive} \vert {g}_{k}^{j} , {g}_{l}^{j} ) = \frac{{}_{i} {G}_{k , l}^{sensitive} ( {g}_{k}^{j} , {g}_{l}^{j} ) \cdot P ( {C}_{i}^{sensitive} )}{{}_{i} {G}_{k , l}^{sensitive} ( {g}_{k}^{j} , {g}_{l}^{j} ) \cdot P ( {C}_{i}^{sensitive} ) {+}_{i} {G}_{k , l}^{insensitive} ( {g}_{k}^{j} , {g}_{l}^{j} ) \cdot P ( {C}_{i}^{insensitive} )} ,$$

where

P(Cᵢ^{sensitive})=prior probability of the sensitive set=|Cᵢ^{sensitive}|/(Cᵢ^{sensitive}|+|Cᵢ^{sensitive}|),

P(Cᵢ^{insensitive})=prior probability of the insensitive set=|Cᵢ^{insensitive}|/(Cᵢ^{sensitive}|+|Cᵢ^{insensitive}|),

ᵢG_{k,l}^{sensitive}(gₖ^{j}, gₗ^{j})=joint probability of abundance values gₖ^{j} and gₗ^{j} from the bivariate gaussian density fitted to the histogram of gene k and l abundances over the sensitive cell lines when subjected to drug i.

$${}_{i} {G}_{k , l}^{sensitive} ( {g}_{k}^{j} , {g}_{l}^{j} ) = \frac{1}{2 {πσ}_{k}^{sen} {σ}_{l}^{sen} \sqrt{1 - {( {ρ}_{k , l}^{sen} )}^{2}}} exp \{ \frac{- [ {( \frac{{g}_{k}^{j} - {μ}_{k}^{sen}}{{σ}_{k}^{sen}} )}^{2} - 2 {ρ}_{k , l}^{sen} ( \frac{{g}_{k}^{j} - {μ}_{k}^{sen}}{{σ}_{k}^{sen}} ) ( \frac{{g}_{l}^{j} - {μ}_{l}^{sen}}{{σ}_{l}^{sen}} ) + {( \frac{{g}_{l}^{j} - {μ}_{l}^{sen}}{{σ}_{l}^{sen}} )}^{2} ]}{2 ( 1 - {( {ρ}_{k , l}^{sen} )}^{2} )} \}$$

where

μₖ^{sen}=mean of gene k abundances over the sensitive cell lines

σₖ^{sen}=standard deviation of gene k abundances in the sensitive cell lines

μₗ^{sen}=mean of gene 1 abundances over the sensitive cell lines

σₗ^{sen}=standard deviation of gene 1 abundances in the sensitive cell lines

ρ_{k,l}^{sen}=correlation coefficient of gene k and gene l abundances in the sensitive cell lines

ᵢ^{G}_{k,l}^{insensitive}(gₖ^{j}, gₗ^{j})=joint probability of abundance values gₖ^{j} and gₗ^{j} from the bivariate gaussian density fitted to the histogram of gene k and l abundances over the insensitive cell lines when subjected to drug i.

$${}_{i} {G}_{k , l}^{insensitive} ( {g}_{k}^{j} , {g}_{l}^{j} ) = \frac{1}{2 {πσ}_{k}^{insen} {σ}_{l}^{insen} \sqrt{1 - {( {ρ}_{k , l}^{insen} )}^{2}}} exp \{ \frac{- [ {( \frac{{g}_{k}^{j} - {μ}_{k}^{insen}}{{σ}_{k}^{insen}} )}^{2} - 2 {ρ}_{k , l}^{insen} ( \frac{{g}_{k}^{j} - {μ}_{k}^{insen}}{{σ}_{k}^{insen}} ) ( \frac{{g}_{l}^{j} - {μ}_{l}^{insen}}{{σ}_{l}^{insen}} ) + {( \frac{{g}_{l}^{j} - {μ}_{l}^{insen}}{{σ}_{l}^{insen}} )}^{2}}{2 ( 1 - {( {ρ}_{k , l}^{insen} )}^{2} )}$$

where

μₖ^{insen}=mean of gene k abundances over the insensitive cell lines

σₖ^{insen}=standard deviation of gene k abundances in the insensitive cell lines

μₗ^{insen}=mean of gene 1 abundances over the insensitive cell lines

σₗ^{insen}=standard deviation of gene 1 abundances in the insensitive cell lines

ρ_{k,l}^{insen}=correlation coefficient of gene k and gene l abundances in the insensitive cell lines

Sample parameters for the QDA 2D analsis of the NCI60 dataset are:

Rule 1

Gene 1: BMI1 Murine leukemia viral (bmi-1) oncogene homolog Chr.10 [418004 (REW) 5′:W90704 3′:W90705]

Gene 2: Human small GTP binding protein Rab7 mRNA complete cds Chr.3 [486233 ([W) 5′:AA043679 3′:AA043680]

Drug: Baker's-soluble-antifoliate

Parameters:

μₖ^{sen}=0.2314, μₗ^{sen}=0.3177, σₖ^{sen}=1.437, σₗ^{sen}=1.51, ρ_{k,l}^{sen}=−0.06216

μₖ^{insen}=−0.07175, μₗ^{insen}=−0.0982, σₖ^{insen}=0.7941, σₗ^{insen}=0.7097, ρ_{k,l}^{insen}=−0.3688

P(Cᵢ^{sensitive})=0.2361, P(Cᵢ^{insensitive})=0.7639

Rule 2

Gene 1: IL8 Interleukin 8 Chr.4 [328692 (DW) 5′:W40283 3′:W45324]

Gene 2: X-ray induction of CIP1/WAF1-log

Drug: Cyanomorpholinodoxorubicin

Parameters:

μₖ^{sen}=0.856, μₗ^{sen}=0.6131, σₖ^{sen}=0.6623, σₗ^{sen}=0.9005, ρ_{k,l}^{sen}=0.4391

μₖ^{insen}=−0.224, μₗ^{insen}=−0.1602, σₖ^{insen}=0.9401, σₗ^{insen}=0.9451, ρ_{k,l}^{insen}=−0.5299

P(Cᵢ^{sensitive})=0.2067, P(Cᵢ^{insensitive})=0.7933

Rule 3

Gene 1: SID W 45954 H.sapiens mRNA for testican [5′:H08669 3′:H08670]

Gene 2: SID W 359443 Human ORF mRNA complete cds [5′:AA010705 3′:AA010706]

Drug: Cyanomorpholinodoxorubicin

Parameters:

μₖ^{sen}=0.8178, μₗ^{sen}=0.7159, σₖ^{sen}=0.9544, σₗ^{sen}=0.6062, ρ_{k,l}^{sen}=−0.8806

μₖ^{insen}=−0.2139, μₗ^{insen}=−0.1865, σₖ^{insen}=0.8419, σₗ^{insen}=0.9949, ρ_{k,l}^{insen}=−0.3109

P(Cᵢ^{sensitive})=0.2067, P(Cᵢ^{insensitive})=0.7933

Rule 4

Gene 1: SID W 242844 ESTs Moderately similar to !!!! ALU SUBFAMILY J WARNING ENTRY !!!! [H.sapiens] [5′:H94138 3′:H94064]

Gene 2: ESTs Chr.1 [488132 (IW) 5′:AA047420 3′:AA047421]

Drug: Mitozolamide

Parameters:

μₖ^{sen}=−1.008, μₗ^{sen}=0.4755, σₖ^{sen}=0.5668, σₗ^{sen}=0.3355, ρ_{k,l}^{sen}=0.3703

μₖ^{insen}=0.2536, μₗ^{insen}=−0.1193, σₖ^{insen}=0.9027, σₗ^{insen}=0.1066, ρ_{k,l}^{insen}=−0.2131

P(Cᵢ^{sensitive})=0.2006, P(Cᵢ^{insensitive})=0.7994

Rule 5

Gene 1: SID W 242844 ESTs Moderately similar to !!!! ALU SUBFAMILY J WARNING ENTRY !!!! [H.sapiens] [5′:H94138 3′:H94064]

Gene 2: ZFP36 Zinc finger protein homologous to Zf-36 in mouse Chr.19 [486668 (DIW) 5′:AA043477 3′:AA043478]

Drug: Mitozolamide

Parameters:

μₖ^{sen}=−0.3906, μₗ^{sen}=−1.008, σₖ^{sen}=0.5337, σₗ^{sen}=0.5668, ρ_{k,l}^{sen}=−0.1073

μₖ^{insen}=0.09821, μₗ^{insen}=0.2536, σₖ^{insen}=1.044, σₗ^{insen}=0.9027, ρ_{k,l}^{insen}=−0.3729

P(Cᵢ^{sensitive})=0.2006, P(Cᵢ^{insensitive})=0.7994

Rule 6

Gene 1: SID W 242844 ESTs Moderately similar to !!!! ALU SUBFAMILY J WARNING ENTRY !!!! [H.sapiens] [5′:H94138 3′:H94064]

Gene 2: SID W 323824 NADH-CYTOCHROME B5 REDUCTASE [5′:W46211 3′:W46212]

Drug: Mitozolamide

Parameters:

μₖ^{sen}=−1.008, μₗ^{sen}=0.2421, σₖ^{sen}=0.5668, σₗ^{sen}=0.4385, ρ_{k,l}^{sen}=−0.04634

μₖ^{insen}=0.2536, μₗ^{insen}=−0.06095, σₖ^{insen}=0.9027, σₗ^{insen}=1.078, ρ_{k,l}^{insen}=−0.1944

P(Cᵢ^{sensitive})=0.2006, P(Cᵢ^{insensitive})=0.7994

Rule 7

Gene 1: ESTs Chr.6 [146640 (I) 5′:R80056 3′:R79962]

Gene 2: SID W 242844 ESTs Moderately similar to !!!! ALU SUBFAMILY J WARNING ENTRY!!!! [H.sapiens] [5′:H94138 3′:H94064]

Drug: Mitozolamide

Parameters:

μₖ^{sen}=−0.3763, μₗ^{sen}=−1.008, σₖ^{sen}=0.5482, σₗ^{sen}=0.5668, ρ_{k,l}^{sen}=−0.7153

μₖ^{insen}=0.09352, μₗ^{insen}=0.2356, σₖ^{insen}=1.034, σₗ^{insen}=0.9027, ρ_{k,l}^{insen}=−0.1007

P(Cᵢ^{sensitive})=0.2006, P(Cᵢ^{insensitive})=0.7994

Rule 8

Gene 1: SID 276915 ESTs [5′:N48564 3′:N39452]

Gene 2: SID 301144 ESTs [5′:W16630 3′:N78729]

Drug: Mitozolamide

Parameters:

μₖ^{sen}=0.001165, μₗ^{sen}=0.7785, σₖ^{sen}=0.4, σₗ^{sen}=0.2994, ρ_{k,l}^{sen}=−0.3594

μₖ^{insen}=−0.0009506, μₗ^{insen}=−0.1951, σₖ^{insen}=1.068, σₗ^{insen}=1.014, ρ_{k,l}^{insen}=−0.2265

P(Cᵢ^{sensitive})=0.2006, P(Cᵢ^{insensitive})=0.7994

Rule 9

Gene 1: Homo sapiens HuUAP1 mRNA for UDP-N-acetylglucosamine pyrophosphorylase complete cds Chr.1 [486035 (DIW) 5′:AA043109 3′:AA040861]

Gene 2: SID W 242844 ESTs Moderately similar to !!!! ALU SUBFAMILY J WARNING ENTRY !!!! [H.sapiens] [5′:H94138 3′:H94064]

Drug: Mitozolamide

Parameters:

μₖ^{sen}=0.3574, μₗ^{sen}=1.008, σₖ^{sen}=0.5869, σₗ^{sen}=0.5668, ρ_{k,l}^{sen}=0.3711

μₖ^{insen}=−0.09028, μₗ^{insen}=0.2536, σₖ^{insen}=1.028, σₗ^{insen}=0.9027, ρ_{k,l}^{insen}=−0.1971

P(Cᵢ^{sensitive})=0.2006, P(Cᵢ^{insensitive})=0.7994

Rule 10

Gene 1: SID W 510182 H.sapiens mRNA for kinase A anchor protein [5′:AA053156 3′:AA053135]

Gene 2: SID W 242844 ESTs Moderately similar to !!!! ALU SUBFAMILY J WARNING ENTRY !!!! [H.sapiens] [5′:H94138 3′:H94064]

Drug: Mitozolamide

Parameters:

μₖ^{sen}=−0.4282, μₗ^{sen}=−1.008, σₖ^{sen}=0.4124, σₗ^{sen}=0.5668, ρ_{k,l}^{sen}=0.1487

μₖ^{insen}=0.1064, μₗ^{insen}=0.2536, σₖ^{insen}=1.07, σₗ^{insen}=0.9027, ρ_{k,l}^{insen}=0.03962

P(Cᵢ^{sensitive})=0.2006, P(Cᵢ^{insensitive})=0.7994

Rule 11

Gene 1: SID W 242844 ESTs Moderately similar to !!!! ALU SUBFAMILY J WARNING ENTRY !!!! [H.sapiens] [5′:H94138 3′:H94064]

Gene 2: SID 488362 ESTs [5′:AA046764 3′:AA046492]

Drug: Mitozolamide

Parameters:

μₖ^{sen}=−1.008, μₗ^{sen}=0.5996, σₖ^{sen}=0.5668, σₗ^{sen}=0.3048, ρ_{k,l}^{sen}=−0.238

μₖ^{insen}=0.2536, μₗ^{insen}=−0.1504, σₖ^{insen}=0.9027, σₗ^{insen}=0.1035, ρ_{k,l}^{insen}=0.1442

P(Cᵢ^{sensitive})=0.2006, P(Cᵢ^{insensitive})=0.7994

Rule 12

Gene 1: SID W 242844 ESTs Moderately similar to !!!! ALU SUBFAMILY J WARNING ENTRY !!!! [H.sapiens] [5′:H94138 3′:H94064]

Gene 2: ESTs Highly similar to HYPOTHETICAL 13.6 KD PROTEIN IN NUP170-ILS1 INTERGENIC REGION [Saccharo Chr.12 [415646 (IW) 5′:W78722 3′:W80529]

Drug: Mitozolamide

Parameters:

μₖ^{sen}=−1.008, μₗ^{sen}=0.4566, σₖ^{sen}=0.5668, σₗ^{sen}=0.413, ρ_{k,l}^{sen}=0.02745

μₖ^{insen}=0.2536, μₗ^{insen}=−0.1139, σₖ^{insen}=0.9027, σₗ^{insen}=0.1038, ρ_{k,l}^{insen}=0.3175

P(Cᵢ^{sensitive})=0.2006, P(Cᵢ^{insensitive})=0.7994

Rule 13

Gene 1: ESTs Weakly similar to R06B9.b [C.elegans] Chr.1 [365488 (IW) 5′:AA009557 3′:AA009558]

Gene 2: SID W 380674 ESTs [5′:AA053720 3′:AA053711]

Drug: Mitozolamide

Parameters:

μₖ^{sen}=0.5214, μₗ^{sen}=1.093, σₖ^{sen}=0.4503, σₗ^{sen}=1.032, ρ_{k,l}^{sen}=0.2533

μₖ^{insen}=−0.1312, μₗ^{insen}=−0.2739, σₖ^{insen}=1.016, σₗ^{insen}=0.7614, ρ_{k,l}^{insen}=−0.2896

P(Cᵢ^{sensitive})=0.2006, P(Cᵢ^{insensitive})=0.7994

Rule 14

Gene 1: ESTs Chr.1 [366242 (I) 5′:3′:AA025593]

Gene 2: SID W 242844 ESTs Moderately similar to !!!! ALU SUBFAMILY J WARNING ENTRY !!!! [H.sapiens] [5′:H94138 3′:H94064]

Drug: Mitozolamide

Parameters:

μₖ^{sen}=−0.2007, μₗ^{sen}=−1.008, σₖ^{sen}=0.4757, σₗ^{sen}=0.5668, ρ_{k,l}^{sen}=−0.2512

μₖ^{insen}=0.04952, μₗ^{insen}=0.2536, σₖ^{insen}=1.076, σₗ^{insen}=0.9027, ρ_{k,l}^{insen}=−0.1109

P(Cᵢ^{sensitive})=0.2006, P(Cᵢ^{insensitive})=0.7994

Rule 15

Gene 1: Human mRNA for reticulocalbin complete cds Chr.11 [485209 (IW) 5′:AA039292 3′:AA039334]

Gene 2: SID 147338 ESTs [5′:3′:H01302]

Drug: Cyclodisone

Parameters:

μₖ^{sen}=0.6598, μₗ^{sen}=0.1958, σₖ^{sen}=0.2562, σₗ^{sen}=0.3673, ρ_{k,l}^{sen}=−0.6593

μₖ^{insen}=−0.1341, μₗ^{insen}=−0.04021, σₖ^{insen}=1.038, σₗ^{insen}=1.061, ρ_{k,l}^{insen}=0.2816

P(Cᵢ^{sensitive})=0.1689, P(Cᵢ^{insensitive})=0.8311

Rule 16

Gene 1: SID W 51940 BETA-2-MICROGLOBULIN PRECURSOR [5′:H24236 3′:H24237]

Gene 2: SID W 486110 Profilin 2 [5′:AA043167 3′:AA040703]

Drug: Cyclodisone

Parameters:

μₖ^{sen}=0.6766, μₗ^{sen}=0.615, σₖ^{sen}=0.5551, σₗ^{sen}=0.4072, ρ_{k,l}^{sen}=−0.9224

μₖ^{insen}=−0.1373, μₗ^{insen}=−0.1252, σₖ^{insen}=0.996, σₗ^{insen}=1.031, ρ_{k,l}^{insen}=−0.313

P(Cᵢ^{sensitive})=0.1689, P(Cᵢ^{insensitive})=0.8311

Rule 17

Gene 1: Human DNA sequence from clone 14O9 on chromosome Xp11.1-11.4. Contains a Inter-Alpha-Trypsin Inh Chr.X [485194 (I) 5′:AA039416 3′:AA039316]

Gene 2: Human mRNA for reticulocalbin complete cds Chr.11 [485209 (IW) 5′:AA039292 3′:AA039334]

Drug: Cyclodisone

Parameters:

μₖ^{sen}=0.2487, μₗ^{sen}=0.6598, σₖ^{sen}=0.4569, σₗ^{sen}=0.2562, ρ_{k,l}^{sen}=−0.4186

μₖ^{insen}=−0.05158, μₗ^{insen}=−0.1341, σₖ^{insen}=1.039, σₗ^{insen}=1.038, ρ_{k,l}^{insen}=0.2219

P(Cᵢ^{sensitive})=0.1689, P(Cᵢ^{insensitive})=0.8311

Rule 18

Gene 1: SID 512164 Human clathrin assembly protein 50 (AP50) mRNA complete cds [5′:3′:AA057396]

Gene 2: SID W 345624 Human homeobox protein (PHOX1) mRNA 3′ end [5′:W76402 3′:W72050]

Drug: Clomesone

Parameters:

μₖ^{sen}=0.8248, μₗ^{sen}=−0.253, σₖ^{sen}=0.7407, σₗ^{sen}=0.7545, ρ_{k,l}^{sen}=0.793

μₖ^{insen}=−0.1956, μₗ^{insen}=0.006021, σₖ^{insen}=0.9082, σₗ^{insen}=1.037, ρ_{k,l}^{insen}=0.7103

P(Cᵢ^{sensitive})=0.1917, P(Cᵢ^{insensitive})=0.8083

Rule 19

Gene 1: MSN Moesin Chr.X [486864 (W) 5′:AA043008 3′:AA042882]

Gene 2: Human mRNA for reticulocalbin complete cds Chr.11 [485209 (IW) 5′:AA039292 3′:AA039334]

Drug: Clomesone

Parameters:

μₖ^{sen}=0.6791, μₗ^{sen}=0.4913, σₖ^{sen}=0.4486, σₗ^{sen}=0.4435, ρ_{k,l}^{sen}=0.8962

μₖ^{insen}=−0.1612, μₗ^{insen}=−0.1165, σₖ^{insen}=1.026, σₗ^{insen}=1.058, ρ_{k,l}^{insen}=0.04721

P(Cᵢ^{sensitive})=0.1917, P(Cᵢ^{insensitive})=0.8083

Rule 20

Gene 1: SID W 36809 Homo sapiens neural cell adhesion molecule (CALL) mRNA complete cds [5′:R34648 3′:R49177]

Gene 2: SID W 487535 Human mRNA for KIAA0080 gene partial cds [5′:AA043528 3′:AA043529]

Drug: Clomesone

Parameters:

μₖ^{sen}=0.6335, μₗ^{sen}=1.184, σₖ^{sen}=0.7063, σₗ^{sen}=0.9042, ρ_{k,l}^{sen}=0.2103

μₖ^{insen}=−0.1498, μₗ^{insen}=−0.2817, σₖ^{insen}=0.9826, σₗ^{insen}=0.7835, ρ_{k,l}^{insen}=−0.3389

P(Cᵢ^{sensitive})=0.1917, P(Cᵢ^{insensitive})=0.8083

Rule 21

Gene 1: SID W 471748 ESTs [5′:AA035018 3′:AA035486]

Gene 2: SID 147338 ESTs [5′:3′:H01302]

Drug: Clomesone

Parameters:

μₖ^{sen}=1.066, μₗ^{sen}=0.1604, σₖ^{sen}=0.9178, σₗ^{sen}=0.37, ρ_{k,l}^{sen}=−0.3953

μₖ^{insen}=−0.2526, μₗ^{insen}=−0.03847, σₖ^{insen}=0.7849, σₗ^{insen}=1.074, ρ_{k,l}^{insen}=0.494

P(Cᵢ^{sensitive})=0.1917, P(Cᵢ^{insensitive})=0.8083

Rule 22

Gene 1: ESTs Chr.X [48536 (E) 5′:H14669 3′:H14579]

Gene 2: SID W 242844 ESTs Moderately similar to !!!! ALU SUBFAMILY J WARNING ENTRY !!!! [H.sapiens] [5′:H94138 3′:H94064]

Drug: Clomesone

Parameters:

μₖ^{sen}=0.8957, μₗ^{sen}=1.079, σₖ^{sen}=0.7433, σₗ^{sen}=0.7048, ρ_{k,l}^{sen}=−0.6495

μₖ^{insen}=0.2117, μₗ^{insen}=0.2564, σₖ^{insen}=0.8949, σₗ^{insen}=0.8653, ρ_{k,l}^{insen}=−0.08726

P(Cᵢ^{sensitive})=0.1917, P(Cᵢ^{insensitive})=0.8083

Rule 23

Gene 1: SID W 487535 Human mRNA for KIAA0080 gene partial cds [5′:AA043528 3′:AA043529]

Gene 2: SID W 488333 ESTs [5′:AA046755 3′:AA046642]

Drug: Clomesone

Parameters:

μₖ^{sen}=1.184, μₗ^{sen}=−0.1604, σₖ^{sen}=0.9042, σₗ^{sen}=0.8711, ρ_{k,l}^{sen}=−0.1011

μₖ^{insen}=−0.2817, μₗ^{insen}=0.03825, σₖ^{insen}=0.7835, σₗ^{insen}=1.011, ρ_{k,l}^{insen}=0.4544

P(Cᵢ^{sensitive})=0.1917, P(Cᵢ^{insensitive})=0.8083

Rule 24

Gene 1: ESTs Chr.8 [470141 (IW) 5′:AA029870 3′:AA029318]

Gene 2: SID W 487535 Human mRNA for KIAA0080 gene partial cds [5′:AA043528 3′:AA043529]

Drug: Clomesone

Parameters:

μₖ^{sen}=0.4978, μₗ^{sen}=1.184, σₖ^{sen}=0.4895, σₗ^{sen}=0.9042, ρ_{k,l}^{sen}=0.6156

μₖ^{insen}=−0.1176, μₗ^{insen}=−0.2817, σₖ^{insen}=1.056, σₗ^{insen}=0.7835, ρ_{k,l}^{insen}=0.1011

P(Cᵢ^{sensitive})=0.1917, P(Cᵢ^{insensitive})=0.8083

Rule 25

Gene 1: BINDING REGULATORY FACTOR Chr.1 [485933 (IW) 5′:AA040819 3′:AA040156]

Gene 2: SID 43555 MALATE OXIDOREDUCTASE [5′:H13370 3′:H06037]

Drug: Fluorouracil (5FU)

Parameters:

μₖ^{sen}=0.5584, μₗ^{sen}=0.9686, σₖ^{sen}=1.073, σₗ^{sen}=0.4053, ρ_{k,l}^{sen}=−0.839

μₖ^{insen}=−0.1082, μₗ^{insen}=−0.1883, σₖ^{insen}=0.9367, σₗ^{insen}=0.9657, ρ_{k,l}^{insen}=−0.3566

P(Cᵢ^{sensitive})=0.1628, P(Cᵢ^{insensitive})=0.8372

Rule 26

Gene 1: ESTsSID 327435 [5′:W32467 3′:W19830]

Gene 2: SID 289361 ESTs [5′:N99589 3′:N92652]

Drug: Fluorouracil (5FU)

Parameters:

μₖ^{sen}=0.9982, μₗ^{sen}=0.03614, σₖ^{sen}=1.157, σₗ^{sen}=0.186, ρ_{k,l}^{sen}=−0.4795

μₖ^{insen}=−0.1943, μₗ^{insen}=−0.007432, σₖ^{insen}=0.8258, σₗ^{insen}=1.074, ρ_{k,l}^{insen}=0.09915

P(Cᵢ^{sensitive})=0.1628, P(Cᵢ^{insensitive})=0.8372

Rule 27

Gene 1: ESTsSID 327435 [5′:W32467 3′:W19830]

Gene 2: H.sapiens mRNA for Gal-beta(1-3/1-4)GlcNAc alpha-2,3-sialyltransferase Chr.11 [324181 (IW) 5′:W47425 3′:W47395]

Drug: Fluorouracil (5FU)

Parameters:

μₖ^{sen}=0.9982, μₗ^{sen}=−0.3532, σₖ^{sen}=1.157, σₗ^{sen}=0.2383, ρ_{k,l}^{sen}=0.01963

μₖ^{insen}=−0.1943, μₗ^{insen}=0.06805, σₖ^{insen}=0.8258, σₗ^{insen}=1.049, ρ_{k,l}^{insen}=0.2537

P(Cᵢ^{sensitive})=0.1628, P(Cᵢ^{insensitive})=0.8372

Rule 28

Gene 1: SID W 116819 Homo sapiens clone 23887 mRNA sequence [5′:T93821 3′:T93776]

Gene 2: ELONGATION FACTOR TU MITOCHONDRIAL PRECURSOR Chr.16 [429540 (IW) 5′:AA011453 3′:AA011397]

Drug: Fluorodopan

Parameters:

μₖ^{sen}=0.4215, μₗ^{sen}=−0.3324, σₖ^{sen}=1.115, σₗ^{sen}=1.519, ρ_{k,l}^{sen}=0.5573

μₖ^{insen}=−0.1101, μₗ^{insen}=−0.0863, σₖ^{insen}=0.9491, σₗ^{insen}=0.7573, ρ_{k,l}^{insen}=−0.786

P(Cᵢ^{sensitive})=0.2061, P(Cᵢ^{insensitive})=0.7939

Rule 29

Gene 1: ESTs Chr.14 [244047 (I) 5′:N45439 3′:N38807]

Gene 2: SID 307717 Homo sapiens KIAA0430 mRNA complete cds [5′:3′:N92942]

Drug: Cyclocytidine

Parameters:

μₖ^{sen}=0.536, μₗ^{sen}=0.004825, σₖ^{sen}=0.4307, σₗ^{sen}=0.232, ρ_{k,l}^{sen}=0.1655

μₖ^{insen}=−0.1816, μₗ^{insen}=−0.002083, σₖ^{insen}=1.03, σₗ^{insen}=1.151, ρ_{k,l}^{insen}=0.08986

P(Cᵢ^{sensitive})=0.2533, P(Cᵢ^{insensitive})=0.7467

Rule 30

Gene 1: SID W 510230 Homo sapiens (clone CC6) NADH-ubiquinone oxidoreductase subunit mRNA 3′ end cds [5′:AA053568 3′:AA053557]

Gene 2: SID 307717 Homo sapiens KIAA0430 mRNA complete cds [5′:3′:N92942]

Drug: Cyclocytidine

Parameters:

μₖ^{sen}=0.1566, μₗ^{sen}=0.04825, σₖ^{sen}=0.4745, σₗ^{sen}=0.232, ρ_{k,l}^{sen}=−0.4326

μₖ^{insen}=−0.05336, μₗ^{insen}=−0.002083, σₖ^{insen}=1.116, σₗ^{insen}=1.151, ρ_{k,l}^{insen}=0.3113

P(Cᵢ^{sensitive})=0.2533, P(Cᵢ^{insensitive})=0.7467

Rule 31

Gene 1: DNA POLYMERASE EPSILON CATALYTIC SUBUNIT A Chr.12 [321207 (IW) 5′:W52910 3′:AA037353]

Gene 2: SID 307717 Homo sapiens KIAA0430 mRNA complete cds [5′:3′:N92942]

Drug: Cyclocytidine

Parameters:

μₖ^{sen}=0.7918, μₗ^{sen}=0.004825, σₖ^{sen}=1.042, σₗ^{sen}=0.232, ρ_{k,l}^{sen}=0.176

μₖ^{insen}=−0.2694, μₗ^{insen}=−0.002083, σₖ^{insen}=0.762, σₗ^{insen}=1.151, ρ_{k,l}^{insen}=−0.06434

P(Cᵢ^{sensitive})=0.2533, P(Cᵢ^{insensitive})=0.7467

Rule 32

Gene 1: TXNRD1 Thioredoxin reductase Chr.12 [510377 (1W) 5′:AA055407 3′:AA055408]

Gene 2: ESTs Chr.1 [362126 (I) 5′:AA001086 3′:AA001049]

Drug: Mitomycin

Parameters:

μₖ^{sen}=0.9736, μₗ^{sen}=0.4653, σₖ^{sen}=0.752, σₗ^{sen}=0.3908, ρ_{k,l}^{sen}=0.1693

μₖ^{insen}=−0.2247, μₗ^{insen}=−0.107, σₖ^{insen}=0.8952, σₗ^{insen}=1.053, ρ_{k,l}^{insen}=0.3972

P(Cᵢ^{sensitive})=0.1872, P(Cᵢ^{insensitive})=0.8128

Rule 33

Gene 1: SID W 260223 Human mRNA for BST-1 complete cds [5′:N45417 3′:N32106]

Gene 2: TXNRD1 Thioredoxin reductase Chr.12 [510377 (IW) 5′:AA055407 3′:AA055408]

Drug: Mitomycin

Parameters:

μₖ^{sen}=0.1887, μₗ^{sen}=0.9736, σₖ^{sen}=0.6724, σₗ^{sen}=0.752, ρ_{k,l}^{sen}=0.7526

μₖ^{insen}=−0.04347, μₗ^{insen}=−0.2247, σₖ^{insen}=1.003, σₗ^{insen}=0.8952, ρ_{k,l}^{insen}=−0.007584

P(Cᵢ^{sensitive})=0.1872, P(Cᵢ^{insensitive})=0.8128

Rule 34

Gene 1: SCYA2 Small inducible cytokine A2 (monocyte chemotactic protein 1 homologous to mouse Sig-je) Chr.17 [108837 (DIW) 5′:T77816 3′:T77817]

Gene 2: *Carbonic anhydrase II SID) 429288 [5′:AA007456 3′:AA007360]

Drug: Anthrapyrazole-derivative

Parameters:

μₖ^{sen}=0.8903, μₗ^{sen}=−0.3723, σₖ^{sen}=0.9679, σₗ^{sen}=0.694, ρ_{k,l}^{sen}=−0.4114

μₖ^{insen}=−0.224, μₗ^{insen}=−0.09341, σₖ^{insen}=0.8509, σₗ^{insen}=1.03, ρ_{k,l}^{insen}=0.4247

P(Cᵢ^{sensitive})=0.2006, P(Cᵢ^{insensitive})=0.7994

Rule 35

Gene 1: SID 356851 Homo sapiens mRNA for nucleolar protein hNop56 [5′:3′:W86238]

Gene 2: Human extracellular protein (S1-5) mRNA complete cds Chr.2 [485875 (EW) 5′:AA040442 3′:AA040443]

Drug: Anthrapyrazole-derivative

Parameters:

μₖ^{sen}=−0.216, μₗ^{sen}=1.016, σₖ^{sen}=0.6331, σₗ^{sen}=1.089, ρ_{k,l}^{sen}=−0.6461

μₖ^{insen}=0.05396, μₗ^{insen}=−0.2548, σₖ^{insen}=1, σₗ^{insen}=0.7749, ρ_{k,l}^{insen}=0.2101

P(Cᵢ^{sensitive})=0.2006, P(Cᵢ^{insensitive})=0.7994

Rule 36

Gene 1: ALDH10 Aldehyde dehydrogenase 10 (fatty aldehyde dehydrogenase) Chr.17 [208950 (EW) 5′:H63829 3′:H63779]

Gene 2: SID W 488148 H.sapiens mRNA for 3′UTR of unknown protein [5′:AA057239 3′:AA058703]

Drug: Anthrapyrazole-derivative

Parameters:

μₖ^{sen}=0.6212, μₗ^{sen}=0.843, σₖ^{sen}=0.6852, σₗ^{sen}=0.575, ρ_{k,l}^{sen}=0.2169

μₖ^{insen}=−0.1554, μₗ^{insen}=−0.2115, σₖ^{insen}=0.9606, σₗ^{insen}=0.9263, ρ_{k,l}^{insen}=−0.3119

P(Cᵢ^{sensitive})=0.2006, P(Cᵢ^{insensitive})=0.7994

Rule 37

Gene 1: Human extracellular protein (S1-5) mRNA complete cds Chr.2 [485875 (EW) 5′:AA040442 3′:AA040443]

Gene 2: SID W 415693 Homo sapiens mRNA for phosphatidylinositol 4-kinase complete cds [5′:W78879 3′:W84724]

Drug: Anthrapyrazole-derivative

Parameters:

μₖ^{sen}=1.016, μₗ^{sen}=0.3712, σₖ^{sen}=1.809, σₗ^{sen}=0.4463, ρ_{k,l}^{sen}=−0.3426

μₖ^{insen}=−0.2548, μₗ^{insen}=−0.09229, σₖ^{insen}=0.7749, σₗ^{insen}=1.066, ρ_{k,l}^{insen}=0.341

P(Cᵢ^{sensitive})=0.2006, P(Cᵢ^{insensitive})=0.7994

Rule 38

Gene 1: SID W 345683 ESTs Highly similar to INTEGRAL MEMBRANE GLYCOPROTEIN GP210 PRECURSOR [Rattus norvegicus] [5′:W76432 3′:W72039]

Gene 2: Human mRNA for KIAA0143 gene partial cds Chr.8 [488462 (IW) 5′:AA047508 3′:AA047451]

Drug: Daunorubicin

Parameters:

μₖ^{sen}=0.918, μₗ^{sen}=−0.6559, σₖ^{sen}=0.3704, σₗ^{sen}=0.4622, ρ_{k,l}^{sen}=−0.5746

μₖ^{insen}=−0.2022, μₗ^{insen}=−0.1457, σₖ^{insen}=0.9271, σₗ^{insen}=1.007, ρ_{k,l}^{insen}=−0.009774

P(Cᵢ^{sensitive})=0.1811, P(Cᵢ^{insensitive})=0.8189

Rule 39

Gene 1: SID W 162077 ESTs [5′:H25689 3′:H26271]

Gene 2: SID W 197549 ESTs [5′:R87793 3′:R87731]

Drug: Deoxydoxorubicin

Parameters:

μₖ^{sen}=−0.2102, μₗ^{sen}=−0.1107, σₖ^{sen}=0.3133, σₗ^{sen}=0.9712, ρ_{k,l}^{sen}=−0.98

μₖ^{insen}=0.3539, μₗ^{insen}=−0.01824, σₖ^{insen}=1.068, σₗ^{insen}=1.008, ρ_{k,l}^{insen}=0.1725

P(Cᵢ^{sensitive})=0.1428, P(Cᵢ^{insensitive})=0.8572

Rule 40

Gene 1: ELONGATION FACTOR TU MITOCHONDRIAL PRECURSOR Chr. 16 [429540 (IW) 5′:AA011453 3′:AA011397]

Gene 2: ESTs Chr.2 [365120 (IW) 5′:AA025204 3′:AA025124]

Drug: Amsacrine

Parameters:

μₖ^{sen}=−0.7939, μₗ^{sen}=0.558, σₖ^{sen}=1.022, σₗ^{sen}=1.102, ρ_{k,l}^{sen}=0.7045

μₖ^{insen}=0.2239, μₗ^{insen}=−0.1576, σₖ^{insen}=0.791, σₗ^{insen}=0.8965, ρ_{k,l}^{insen}=0.4064

P(Cᵢ^{sensitive})=0.22, P(Cᵢ^{insensitive})=0.78

Rule 41

Gene 1: G6PD Glucose-6-phosphate dehydrogenase Chr.X [430251 (IW) 5′:AA010317 3′:AA010382]

Gene 2: SID W 376708 ESTs [5′:AA046358 3′:AA046274]

Drug: CPT,20-ester (S)

Parameters:

μₖ^{sen}=−0.09704, μₗ^{sen}=0.6823, σₖ^{sen}=0.4911, σₗ^{sen}=0.8524, ρ_{k,l}^{sen}=0.7542

μₖ^{insen}=0.02995, μₗ^{insen}=−0.2092, σₖ^{insen}=1.068, σₗ^{insen}=0.9393, ρ_{k,l}^{insen}=−0.5785

P(Cᵢ^{sensitive})=0.2344, P(Cᵢ^{insensitive})=0.7656

Rule 42

Gene 1: H.sapiens mRNA for ESM-1 protein Chr.5 [324122 (RW) 5′:W46667 3′:W465773]

Gene 2: Human FEZ2 mRNA partial cds Chr.2 [488055 (W) 5′:AA058551 3′:AA053303]

Drug: CPT

Parameters:

μₖ^{sen}=−0.1032, μₗ^{sen}=0.8185, σₖ^{sen}=0.4146, σₗ^{sen}=0.8985, ρ_{k,l}^{sen}=−0.6229

μₖ^{insen}=0.03592, μₗ^{insen}=−0.2863, σₖ^{insen}=1.124, σₗ^{insen}=0.8401, ρ_{k,l}^{insen}=0.4189

P(Cᵢ^{sensitive})=0.2594, P(Cᵢ^{insensitive})=0.7406

Rule 43

Gene 1: SID W 361023 ESTs [5′:AA013072 3′:AA012983]

Gene 2: H.sapiens mRNA for TRAMP protein Chr.8 [149355 (IEW) 5′:H01598 3′:H01495]

Drug: CPT

Parameters:

μₖ^{sen}=−0.6506, μₗ^{sen}=0.5667, σₖ^{sen}=0.6739, σₗ^{sen}=1.274, ρ_{k,l}^{sen}=0.7093

μₖ^{insen}=0.2279, μₗ^{insen}=−0.1978, σₖ^{insen}=0.9778, σₗ^{insen}=0.7508, ρ_{k,l}^{insen}=−0.1771

P(Cᵢ^{sensitive})=0.2594, P(Cᵢ^{insensitive})=0.7406

Rule 44

Gene 1: SID W 358754 Human mRNA for cysteine protease complete cds [5′:W94449 3′:W94332]

Gene 2: SID W 159512 Integrin alpha 6 [5′:H16046 3′:H15934]

Drug: CPT

Parameters:

μₖ^{sen}=−0.1082, μₗ^{sen}=0.7291, σₖ^{sen}=0.7356, σₗ^{sen}=0.6557, ρ_{k,l}^{sen}=−0.6645

μₖ^{insen}=0.0372, μₗ^{insen}=−0.2559, σₖ^{insen}=1.038, σₗ^{insen}=0.9638, ρ_{k,l}^{insen}=0.4712

P(Cᵢ^{sensitive})=0.2594, P(Cᵢ^{insensitive})=0.7406

Rule 45

Gene 1: SID 257009 ESTs [5′:N39759 3′:N26801]

Gene 2: SID W 488148 H.sapiens mRNA for 3′UTR of unknown protein [5′:AA057239 3′:AA058703]

Drug: CPT

Parameters:

μₖ^{sen}=0.3448, μₗ^{sen}=0.8224, σₖ^{sen}=0.7661, σₗ^{sen}=0.5588, ρ_{k,l}^{sen}=0.6149

μₖ^{insen}=−0.1208, μₗ^{insen}=−0.2881, σₖ^{insen}=1.029, σₗ^{insen}=0.9329, ρ_{k,l}^{insen}=0.06046

P(Cᵢ^{sensitive})=0.2594, P(Cᵢ^{insensitive})=0.7406

Rule 46

Gene 1: SID 43609 ESTs [5′:H06454 3′:H06184]

Gene 2: SID W 361023 ESTs [5′:AA013072 3′:AA012983]

Drug: CPT,20-ester (S)

Parameters:

μₖ^{sen}=0.4667, μₗ^{sen}=0.6333, σₖ^{sen}=1.301, σₗ^{sen}=0.554, ρ_{k,l}^{sen}=0.5266

μₖ^{insen}=−0.1602, μₗ^{insen}=−0.2168, σₖ^{insen}=0.7751, σₗ^{insen}=0.9858, ρ_{k,l}^{insen}=0.2268

P(Cᵢ^{sensitive})=0.255, P(Cᵢ^{insensitive})=0.745

Rule 47

Gene 1: Human G/T mismatch-specific thymine DNA glycosylase mRNA complete cds Chr.X [321997 (IW) 5′:W37234 3′:W37817]

Gene 2: SID W 358526 ESTs [5′:W96039 3′:W94821]

Drug: CPT,11-formyl (RS)

Parameters:

μₖ^{sen}=0.626, μₗ^{sen}=1.055, σₖ^{sen}=1.401, σₗ^{sen}=1.241, ρ_{k,l}^{sen}=−0.1072

μₖ^{insen}=−0.151, μₗ^{insen}=−0.2536, σₖ^{insen}=0.9295, σₗ^{insen}=0.7034, ρ_{k,l}^{insen}=0.6208

P(Cᵢ^{sensitive})=0.1939, P(Cᵢ^{insensitive})=0.8061

Rule 48

Gene 1: PROTEASOME COMPONENT C13 PRECURSOR Chr.6 [344774 (IW) 5′:W74742 3′:W74705]

Gene 2: SID W 484681 Homo sapiens ES/130 mRNA complete cds [5′:AA037568 3′:AA037487]

Drug: Mechlorethamine

Parameters:

μₖ^{sen}=0.6562, μₗ^{sen}=−0.8883, σₖ^{sen}=0.7248, σₗ^{sen}=0.7952, ρ_{k,l}^{sen}=−0.1383

μₖ^{insen}=−0.1656, μₗ^{insen}=−0.2119, σₖ^{insen}=0.9825, σₗ^{insen}=0.9257, ρ_{k,l}^{insen}=0.6324

P(Cᵢ^{sensitive})=0.1928, P(Cᵢ^{insensitive})=0.8072

Rule 49

Gene 1: AK1 Adenylate kinase 1 Chr.9 [488381 (IW) 5′:AA046783 3′:AA0466533]

Gene 2: Human vascular endothelial growth factor related protein VRP mRNA complete cds Chr.4 [309535 (I) 5′:3′:N94399]

Drug: Mechlorethamine

Parameters:

μₖ^{sen}=−0.4881, μₗ^{sen}=0.243, σₖ^{sen}=1.786, σₗ^{sen}=0.4893, ρ_{k,l}^{sen}=0.8105

μₖ^{insen}=0.1157, μₗ^{insen}=−0.05762, σₖ^{insen}=0.6286, σₗ^{insen}=1.08, ρ_{k,l}^{insen}=0.03238

P(Cᵢ^{sensitive})=0.1928, P(Cᵢ^{insensitive})=0.8072

Rule 50

Gene 1: SID W489301 ESTs [5′:AA054471 3′:AA058511]

Gene 2: Human epithelial membrane protein (CL-20) mRNA complete cds Chr.12 [488719 (IW) 5′:AA046077 3′:AA046025]

Drug: Melphalan

Parameters:

μₖ^{sen}=0.9792, μₗ^{sen}=−0.619, σₖ^{sen}=1.075, σₗ^{sen}=0.7439, ρ_{k,l}^{sen}=−0.8227

μₖ^{insen}=−0.2399, μₗ^{insen}=0.1515, σₖ^{insen}=0.7994, σₗ^{insen}=0.9531, ρ_{k,l}^{insen}=0.3178

P(Cᵢ^{sensitive})=0.1967, P(Cᵢ^{insensitive})=0.8033

Rule 51

Gene 1: SID W 245450 Human transcription factor NFATx mRNA complete cds [5′:N77274 3′:N55066]

Gene 2: SID W 485645 KERATIN TYPE II CYTOSKELETAL 7 [5′:AA039817 3′:AA041344]

Drug: 5-Hydroxypicolinaldehyde-thiose

Parameters:

μₖ^{sen}=0.122, μₗ^{sen}=0.8712, σₖ^{sen}=0.2463, σₗ^{sen}=0.6735, ρ_{k,l}^{sen}=0.1308

μₖ^{insen}=−0.02658, μₗ^{insen}=−0.1896, σₖ^{insen}=1.091, σₗ^{insen}=0.9271, ρ_{k,l}^{insen}=0.05545

P(Cᵢ^{sensitive})=0.1789, P(Cᵢ^{insensitive})=0.8211

Rule 52

Gene 1: SID 381780 ESTs [5′:AA059257 3′:AA059223]

Gene 2: SID 512355 ESTs Highly similar to SRC SUBSTRATE P80/85 PROTEINS [Gallus gallus] [5′:AA059424 3′:AA057835]

Drug: Paclitaxel—Taxol

Parameters:

μₖ^{sen}=0.1618, μₗ^{sen}=0.8354, σₖ^{sen}=0.1828, σₗ^{sen}=0.4935, ρ_{k,l}^{sen}=−0.09957

μₖ^{insen}=−0.03218, μₗ^{insen}=0.162, σₖ^{insen}=1.06, σₗ^{insen}=0.9902, ρ_{k,l}^{insen}=−0.09191

P(Cᵢ^{sensitive})=0.1622, P(Cᵢ^{insensitive})=0.8378

Rule 53

Gene 1: SID 381780 ESTs [5′:AA059257 3′:AA059223]

Gene 2: SID 130482 ESTs [5′:R21876 3′:R21877]

Drug: Paclitaxel—Taxol

Parameters:

μₖ^{sen}=0.1618, μₗ^{sen}=−0.9271, σₖ^{sen}=0.1828, σₗ^{sen}=0.3413, ρ_{k,l}^{sen}=−0.3935

μₖ^{insen}=−0.03218, μₗ^{insen}=0.1791, σₖ^{insen}=1.06, σₗ^{insen}=0.9842, ρ_{k,l}^{insen}=−0.2741

P(Cᵢ^{sensitive})=0.1622, P(Cᵢ^{insensitive})=0.8378

Rule 54

Gene 1: SID 344786 Human mRNA for KIAA0177 gene partial cds [5′:3′:W74713]

Gene 2: TXNRD1 Thioredoxin reductase Chr.12 [510377 (IW) 5′:AA055407 3′:AA055408]

Drug: Bisantrene

Parameters:

μₖ^{sen}=−0.3189, μₗ^{sen}=1.298, σₖ^{sen}=0.6532, σₗ^{sen}=0.7515, ρ_{k,l}^{sen}=0.9897

μₖ^{insen}=−0.02732, μₗ^{insen}=−0.1115, σₖ^{insen}=0.9915, σₗ^{insen}=0.9088, ρ_{k,l}^{insen}=0.06623

P(Cᵢ^{sensitive})=0.07889, P(Cᵢ^{insensitive})=0.9211

Determining Statistical Significance of Finding

Mean Square Error (MSE) scores are calculated by comparing the probabilities (a form of likelihood) computed by a method against an ensemble of surrogate data generated by different randomizations, i.e., permutations, of the original data (creating artificial samples). A resulting histogram of MSE scores is then interpreted as representing the probability distribution of error; hence, the statistical significance of any given determined probability can be assigned. The gene expression levels can then be selected according to the ranking of their probability for the original data, with a comparison against the MSE score for the randomized data.

Validating Predictions of Sensitivity to Drug, for Each Method

For any given gene k and drug I, a cross-validation procedure is used to assess validity of any prediction. For example, we omit 1 given cell line from consideration, and carry out a given method on the remaining cell lines, and record the findings. The omitted cell line is restored and a different cell line is omitted, and the given method re-applied. This is repeated, one cell line at a time, until all the cell lines have had their turn being omitted. All the findings are compiled. Difference scores between an original calculation and a cell line-omitted calculation are obtained. Mean Square Errors (MSE) are then calculated from the aggregated differences. MSE is then an assessment of the validity of the given method.

Sample results from one of the Bayesian classifiers (the LDA 2D) on the NCI60 dataset are shown in Table 8 below.

TABLE 8

| | | | | Statistical |
|---|---|---|---|---|
| | | | | Significance - |
| | | | | After |
| | | | | Bonferroni |
| Drug | Gene 1 | Gene 2 | P-Value | Correction |
| Acivicin | Glyoxalase-I-log | Homo sapiens mRNA | 5.947e−08 | 3.00% |
| (RNA synthesis | | for HYA22 complete | | |
| inhibitor) | | cds Chr.3 [358957 | | |
| | | (EW) 5′:W91969 | | |
| | | 3′:W94916] | | |
| Baker's-soluble- | SID W 254085 ESTs | SID 118593 [5′:T92821 | 1.982e−08 | 1.00% |
| antifoliate | Moderately similar to | 3′:T92741] | | |
| (antifol) | synaptonemal complex | | | |
| | protein [M. musculus] | | | |
| | [5′:N71532 3′:N22165] | | | |
| Baker's-soluble- | SID W 254085 ESTs | ESTs Chr.5 [46694 | 1.586e−07 | 7.90% |
| antifoliate | Moderately similar to | (RW) 5′:H10240 | | |
| (antifol) | synaptonemal complex | 3′:H10192] | | |
| | protein [M. musculus] | | | |
| | [5′:N71532 3′:N22165] | | | |
| Mitozolamide | SID W 242844 ESTs | *Hs.648 Cut | 5.947e−08 | 3.00% |
| (alkylating agent, | Moderately similar to | (Drosophila)-like 1 | | |
| guanine-O6) | !!!! ALU SUBFAMILY | (CCAAT displacement | | |
| | J WARNING ENTRY | protein) SID W 26677 | | |
| | !!!! [H. sapiens] | ESTs [5′:R13994 | | |
| | [5′:H94138 3′:H94064] | 3′:R39117] | | |
| Mitozolamide | Homo sapiens delta7- | SID W 380674 ESTs | 1.388e−07 | 6.90% |
| (alkylating agent, | sterol reductase mRNA | [5′:AA053720 | | |
| guanine-O6) | complete cds Chr.10 | 3′:AA053711] | | |
| | [417125 (E) 5′: | | | |
| | 3′:W87472] | | | |
| Mitozolamide | Glutathoine S- | *Hs.648 Cut | 1.982e−07 | 9.90% |
| (alkylating agent, | Tranferase Pi-log | (Drosophila)-like 1 | | |
| guanine-O6) | | (CCAAT displacement | | |
| | | protein) SID W 26677 | | |
| | | ESTs [5′:R13994 | | |
| | | 3′:R39117] | | |
| Clomesone | ESTs Chr.X [48536 (E) | SID W 242844 ESTs | 1.982e−08 | 1.00% |
| (alkylating agent, | 5′:H14669 3′:H14579] | Moderately similar to | | |
| guanine-O6) | | !!!! ALU SUBFAMILY | | |
| | | J WARNING ENTRY | | |
| | | !!!! [H. sapiens] | | |
| | | [5′:H94138 3′:H94064] | | |
| Clomesone | SID W 36809 Homo | SID W 487535 Human | 1.982e−08 | 1.00% |
| (alkylating agent, | sapiens neural cell | mRNA for KIAA0080 | | |
| guanine-O6) | adhesion molecule | gene partial cds | | |
| | (CALL) mRNA | [5′:AA043528 | | |
| | complete cds | 3′:AA043529] | | |
| | [5′:R34648 3′:R49177] | | | |
| Clomesone | M-PHASE INDUCER | SID W 487535 Human | 3.964e−08 | 2.00% |
| (alkylating agent, | PHOSPHATASE 2 | mRNA for KIAA0080 | | |
| guanine-O6) | Chr.20 [179373 (EW) | gene partial cds | | |
| | 5′:H50437 3′:H50438] | [5′:AA043528 | | |
| | | 3′:AA043529] | | |
| Clomesone | SID W 242844 ESTs | SID 469842 Homo | 3.964e−08 | 2.00% |
| (alkylating agent, | Moderately similar to | sapiens mRNA for fatty | | |
| guanine-O6) | !!!! ALU SUBFAMILY | acid binding protein | | |
| | J WARNING ENTRY | complete cds | | |
| | !!!! [H. sapiens] | [5′:AA0029794 | | |
| | [5′:H94138 3′:H94064] | 3′:AA029795] | | |
| Clomesone | ESTsSID 327435 | SID 469842 Homo | 3.964e−08 | 2.00% |
| (alkylating agent, | [5′:W32467 3′:W19830] | sapiens mRNA for fatty | | |
| guanine-O6) | | acid binding protein | | |
| | | complete cds | | |
| | | [5′:AA029794 | | |
| | | 3′:AA029795] | | |
| Clomesone | SID 512164 Human | SID W 345624 Human | 3.964e−08 | 2.00% |
| (alkylating agent, | clathrin assembly | homeobox protein | | |
| guanine-O6) | protein 50 (AP50) | (PHOX1) mRNA 3′ end | | |
| | mRNA complete cds | [5′:W76402 3′:W72050] | | |
| | [5′: 3′:AA057396] | | | |
| Clomesone | SID W 376951 ESTs | SID W 487535 Human | 3.964e−08 | 2.00% |
| (alkylating agent, | [5′:AA047756 | mRNA for KIAA0080 | | |
| guanine-O6) | 3′:AA047641] | gene partial cds | | |
| | | [5′:AA043528 | | |
| | | 3′:AA043529] | | |
| Clomesone | Glutathoine S- | SID W 487535 Human | 9.911e−08 | 5.00% |
| (alkylating agent, | Tranferase Pi-log | mRNA for KIAA0080 | | |
| guanine-O6) | | gene partial cds | | |
| | | [5′:AA043528 | | |
| | | 3′:AA043529] | | |
| Clomesone | XRCC4 DNA repair | SID W 242844 ESTs | 9.911e−08 | 5.00% |
| (alkylating agent, | protein XRCC4 Chr.5 | Moderately similar to | | |
| guanine-O6) | [26811 (RW) | !!!! ALU SUBFAMILY | | |
| | 5′:R14027 3′:R39148] | J WARNING ENTRY | | |
| | | !!!! [H. sapiens] | | |
| | | [5′:H94138 3′:H94064] | | |

The above steps as performed on, by way of example, the NCI60 dataset can be further explained as follows.

Start off with 2 tables of data: a table, T, with gene expression data and a table, A, with drug concentration data In table T each column is a gene, each row is a cell line and each entry is the expression level of a gene in a given cell line.

In table A, each column is a drug, each row is a cell line (corresponding exactly to the same cell lines in table T) and each entry is the drug concentration which inhibits the growth of a given cell line by 50%.

Note: The same cell lines appear in Tables T and A, and the order of the cell lines is the same in both tables. In the NCI60 analysis there were 60 cell lines, 1000 genes and 90 drugs.

TABLE T

| | Gene 1 | Gene 2 | Gene 3 |
|---|---|---|---|
| Cell line 1 | 0.4 | 0.2 | 0.8 |
| Cell line 2 | 0.5 | 0.4 | 0.3 |
| Cell line 3 | 0.2 | 0.7 | 0.1 |

TABLE A

| | Drug 1 | Drug 2 | Drug 3 |
|---|---|---|---|
| Cell line 1 | 0.6 | 1.1 | 1.8 |
| Cell line 2 | 0.1 | 0.4 | 0.3 |
| Cell line 3 | 0.5 | 0.1 | 0.1 |

An example of Tables T and A with actual data are shown below:

TABLE T
Gene expression values

| | | | Gene: Human |
|---|---|---|---|
| | | | GDP-dissociation |
| | Gene: SID W | | inhibitor protein |
| | 328550 ATL- | Gene: RAC2 Ras- | (Ly-GDI) mRNA |
| | derived PMA- | related C3 | complete cds |
| | responsive (APR) | botulinum toxin | Chr.12 [487374 |
| | peptide | substrate 2 Chr.22 | (IW) |
| | [5′: W40533 | [429908 (DI) 5′: | 5′:AA046482 |
| | 3′: W40261] | 3′:AA033975] | 3′:AA046695] |
| Cell line: | −1.17 | −0.93 | −0.62 |
| CNS:SNB-19 | | | |
| Cell line: | 0.19 | 0.1 | −0.77 |
| CNS:U251 | | | |
| Cell line: | −1.2 | −0.1 | −0.45 |
| BR:BT-549 | | | |

TABLE A
−logGI50 values

| | Drug: Thiopurine | Drug: alpha-2′- | Drug: |
|---|---|---|---|
| | (6 MP) | Deoxythioguanosine | Thioguanine |
| Cell line: | −2.08 | −2.35 | −4.14 |
| CNS:SNB-19 | | | |
| Cell line: | −0.77 | −1.03 | −1.63 |
| CNS:U251 | | | |
| Cell line: | −2.36 | −1.6 | −0.47 |
| BR:BT-549 | | | |

1) Transform the drug response values.

Form a new table which corresponds to the A table by transforming the numerical values of Table A so that they fall on a continuous numerical scale ≧0 and ≦1. This is done in order to represent the intensity of the attribute in a readily-interpretable manner: 0 represents negligible insensity (e.g., insensitive to drug) and 1 represents high intensity (e.g., sensitive to drug), with continuous gradation in between.

For example, using equation for the continuous piece-wise linear biological scoring function described previously:

Let aᵢⱼ represent the entry in the ith row and jth column of table A.

Transform each entry, aᵢⱼ, as follows:

if aᵢⱼ is less than 0.3 then set aᵢⱼ=0

if aᵢⱼ is between 0.3 and 0.7, then set aᵢⱼ=(aᵢⱼ−0.7)/0.3

if aᵢⱼ is greater than or equal to 0.7, then set aᵢⱼ=1

If a new entry aᵢⱼ is >0, consider cell line i to be at least partially sensitive to drug j. If a new entry aᵢⱼ is less <1, consider cell line i to be at least partially insensitive to drug j. Based on the transformed attribute values in some column j, it is possible to separate cell lines into 2 classes, C^{sensitive} and C^{insensitive}. Cell lines that are sensitive are in class C^{sensitive} and cell lines that are insensitive are in the C^{insensitive} class. But, some cell lines can be considered to be partially in both class. For example, if the transformed value aᵢⱼ=x, then cell line i is considered to be x*100% in class C^{sensitive} and (1−x)*100% in class C^{insensitive}.

2) Example Application of Bayesian Classifiers—UGDA 1D, UGDA 2D, LDA 1D, QDA 1D, LDA 2D, QDA 2D.

Note: Steps explained using LDA 1D are equivalently applied for any of the other Bayesian classifiers.

### EXAMPLE OF STEPS

Apply LDA 1D to measure how well a given gene co-occurs, associates with, or predicts response to a given drug.

2.1) Select a column, Tₖ, from the T matrix, with the expression values of some gene k. Select a column, Aᵢ, from the A matrix, with the drug concentrations (e.g., in units of −log₁₀GI50) values of some drug i [see paragraph 1d in the Methods document for GI50].

2.2) Remove the first entry, T_{1,k}, from column Tₖ and the first entry, A_{1,i}, from column Aᵢ. Assume that these entries belong to cell line L₁.

2.3) Separate the remaining entries, (T_{2,k} through T_{n,k}) in column Tₖ into two sets:

one set, ᵢC^{sensitive} has the gene expression values of cell lines at least partially sensitive to drug i (i.e. these cell lines have values greater than 0 in column Aᵢ)

a second set, ᵢC^{insensitive}, has the gene expression values of cell lines at least partially insensitive to drug i (i.e. these cell lines have values smaller than 1 in column Aᵢ)

2.4) Compute the weighted mean, μₖ^{sensitive}, and the weighted standard deviation, σₖ^{sensitive}, of the values in set ᵢC^{sensitive}.

Find the weighted mean, μₖ^{insensitive}, and the weighted standard deviation, σₖ^{insensitive} of the values in set ᵢC^{insensitive}.

Find the weighted average standard deviation σₖ^{avg} of the two sets.

Find the frequency, P(ᵢC^{sensitive}), of the sensitive class and the frequency, P(ᵢC^{insensitive}), of the insensitive class.

Compute parameters necessary to fit any chosen mathematical density function or continuous curve to a α category-wise histogram of the type described previously.

2.5) Compute the probability, P(L₁εC^{sensitive}|T_{1,k}), that cell line L₁ is sensitive to drug i, using the information of the expression level of gene k and the proportion, i.e., frequency, of the sensitive and insensitive classes. Namely, compute

$$P ( {L}_{1} ∈ {C}_{i}^{sensitive} \vert {T}_{1 , k} ) = \frac{{}_{i} {G}_{k}^{sensitive} ( {T}_{1 , k} ) \cdot P ( {C}_{i}^{sensitive} )}{{}_{i} {G}_{k}^{sensitive} ( {T}_{1 , k} ) \cdot P ( {C}_{i}^{sensitive} ) {+}_{i} {G}_{k}^{insensitive} ( {T}_{1 , k} ) \cdot P ( {C}_{i}^{insensitive} )} , \\ \begin{matrix}where \\ {}_{i} {G}_{k}^{sensitive} ( {T}_{1 , k} ) = \frac{1}{{σ}_{k}^{avg} \sqrt{2 π}} {e}^{- {( {T}_{1 , k} - {μ}_{k}^{sensitive} )}^{2} / 2 {( {σ}_{k}^{avg} )}^{2}} \\ {}_{i} {G}_{k}^{insensitive} ( {T}_{1 , k} ) = \frac{1}{{σ}_{k}^{avg} \sqrt{2 π}} {e}^{- {( {T}_{1 , k} - {μ}_{k}^{insensitive} )}^{2} / 2 {( {σ}_{k}^{avg} )}^{2}}\end{matrix}$$

as described previously.

2.6) Calculate an error for the probability derived in step 2.5.

Consider the probability from step 2.5 to be the expected probability, p^{expected}, that cell line L₁ is sensitive to drug i. Consider entry A_{1,i} to be the observed probability, p^{observed}, that cell line L₁ is sensitive to drug i.

Then, calculate an error, E₁, based on these two values, where E₁=(P^{expected}−P^{observed})².

2.7) A cross-validation procedure.

For each cell line, find the probability of sensitivity to drug i.

Restore the first entries of columns Tₖ and Aᵢ, (entries belonging to cell line L₁) and remove the second entry of these columns. Assume that the removed entries belong to cell line C₂. Repeat steps 2.3 through 2.6, to obtain the probability of cell line L₂ being sensitive to drug i. Follow the same procedure for each of the cell lines. Find the mean of the error terms, E, from all the iterations. This value is referred to as the mean squared error (MSE). This MSE quantifies how well gene k predicts sensitivity to drug i.

3) Find the MSE scores of all genes versus all drugs.

4) A statistical significance assessment procedure.

Find initial significance p-values for all MSE scores.

A significance p-value indicates the likelihood that an MSE score could have arisen by chance (i.e. that randomized data (i.e., the original data, randomly permuted to obliterate any patterns that may have been in the original data) could have generated the MSE score).

4.1) Construct a distribution, i.e., histogram, of MSE scores from the LDA 1D being applied to randomized data.

In each column of the T table, randomly rearrange the order of the entries. In each column of the A table, randomly rearrange the order of the entries. Make copies of these two tables, and again randomly rearrange the entries in all columns. Repeat this procedure until there are 100 randomized versions of the 2 tables. Apply steps 2 and 3 to each of the randomized pairs of tables. In other words, for each pair of tables, find the MSE scores of all genes versus all drugs. This results in a total of 100,000 MSE scores (1000 scores for a single pair of tables*100 pairs of tables). Such scores are referred to as MSE^{rand}. MSE scores from non-randomized tables are referred to as MSE^{nonrand}

4.2) Compare MSE scores from non-randomized data tables to MSE from randomized data tables.

For a given MSE score, Mᵢ, from non-randomized tables, determine the fraction of MSE^{rand} scores which are lower than Mᵢ. This fraction is the significance p-value for score Mᵢ. Using this approach, determine the significance p-values for all MSE_{nonrand} scores.

5) Adjust the significance p-values associated with MSE^{nonrand} scores to correct for multiple tests significance test being employed.

The initial significance p-values associated with MSE^{nonrand} scores may not necessarily fairly reflect the true statistical significance because there were multiple significance tests employed. Thus, multiply each significance p-value by 1000 to take into account that 1000 genes were tested against each drug. This kind of adjustment of statistical significance to account for multiple significance tests being employed is known in the statistical literature as the Bonferroni method.

6) Report by cell line and drug, the genes and the probabilities derived in step 2.5

6.1) Particularly identify in the report those cell lines and drugs for which there are genes for which the probability derived in step 2.5 is high, say >0.85, and ranked by smallest-to-largest significance p-score.

The examples set out above provide general principles that may be extended to other fields of study, and are not intended to limit the scope of the invention. For example, drug sensitivity levels reflecting the inhibiting of growth could be replaced by drug sensitivity that reflects toxic reactions to drugs. This could be useful in finding markers that indicate circumstances where a given drug not only does not help, but may cause harm (be toxic to non-diseased cells). Diagnostic kits can then be derived to search for those markers in given patients.

Similarly, examples of characterizing attributes could be SNPs or proteins (proteomics).

The Bayesian classifiers are not limited to 1 dimensional or 2 dimensional classifiers, rather any dimension of classifier could be used as appropriate for the chosen characterizing attribute set. This may or may not turn up additional significant likelihoods of co-occurrences depending on the relationships of the attributes in the dataset. It is recognized that a brute force approach of carrying out all steps for all combinations of characterizing attributes and attributes sets of interests can require a great deal of time and computational power, particularly with higher order combinations of attributes. Pre-processing techniques, such as those mentioned previously, can be employed to reduce the number of candidate characterizing attribute sets, and thus the amount of time and computational power required.

Alternate methods could be used to create artificial samples in place of the randomizations suggested herein. The randomizations used herein proved to be a simple and effective manner of creating the artificial samples.

In the examples provided above, two likelihood thresholds have been used. First, a likelihood threshold based upon the artifical samples. Second, a likelihood threshold based upon the assigned likelihoods being above a certain percentile of all assigned likelihoods for the relevant attribute of interest.

The likelihood threshold can also be based on a selected threshold based on empirical knowledge, statistically derivation, or otherwise. In order to capture all characterizing sets of interest, even those that could possibly lack statistical validity, the likelihood threshold could simply be set at zero. Expanding on this, the likelihood threshold could be a selected numerical threshold, or the threshold could be varied, to determine the effect on the results. The likelihood threshold need not be based on artificial or random data in order to derive useful results from the methods.

As we have seen, the likelihood thresholds could be a single threshold, or a combination of likelihoods thresholds.

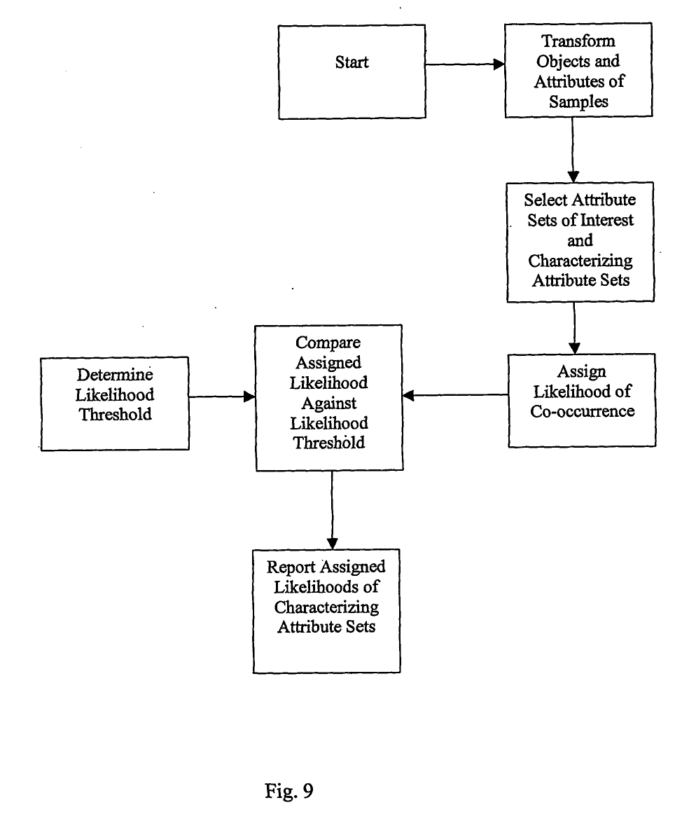

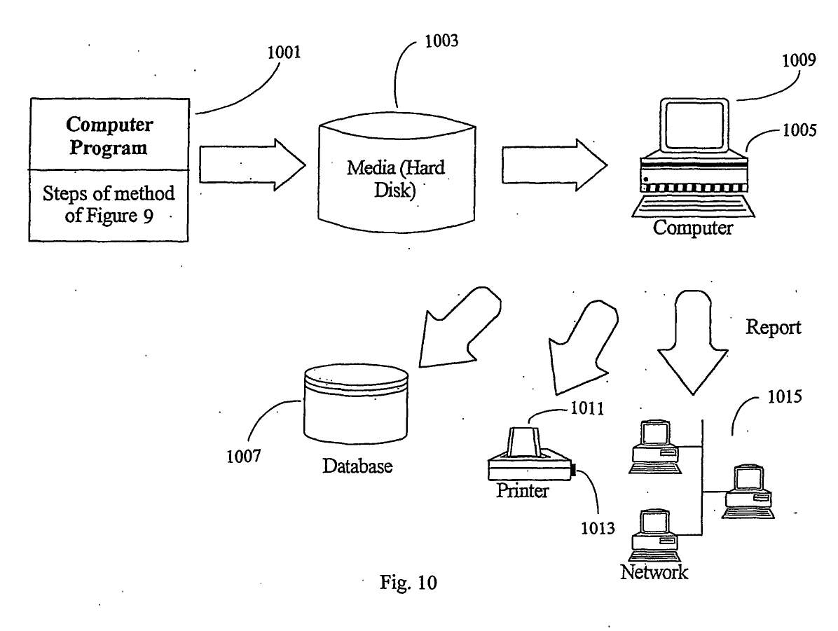

The methods described herein can be embodied in a computer program running on an appropriate computing platform as shown in FIG. 9. The combination of the computing platform and computer program results in a system for determining co-occurrences of characterizing attributes and attribute sets of interest. Again, the examples shown in the Figures are not intended to be limiting to the breadth of the invention. As will be evident to those skilled in the art, other configurations of computing platforms and computer programs are possible. For example, the computing platform could take the form of computer network with the computer program distributed about the network, or accessed by terminals remote from that part of the computing platform running the computer program. For example, the computer program may be running on a computer that is connected to and accessible through the Internet.

An example flow diagram for the preferred embodiment of software embodying the first base method described above is shown in FIG. 9. Similarly, an example general block diagram for an embodiment of a system for determining co-occurrences of characterizing attributes and attributes of interest is shown in FIG. 10. In this example, a computer program 1001 is stored on computer storage media 1003 (such as a hard disk from which the computer program is loaded into memory of the computer at the time the program is run) of a standalone computer 1005. The dataset is stored in a database 1007 accessible to the computer 1005. The ranked characterizing attribute sets resulting from the base methods may be reported and stored in a file on the hard disk 1003 for later use, including as an output display for viewing on a computer monitor 1009 of the computer 1005. They may take an alternative form of output display as a report 1011 generated on a printer 1013. Similarly, they maybe reported to a file, or other output display across a computer network 1015.

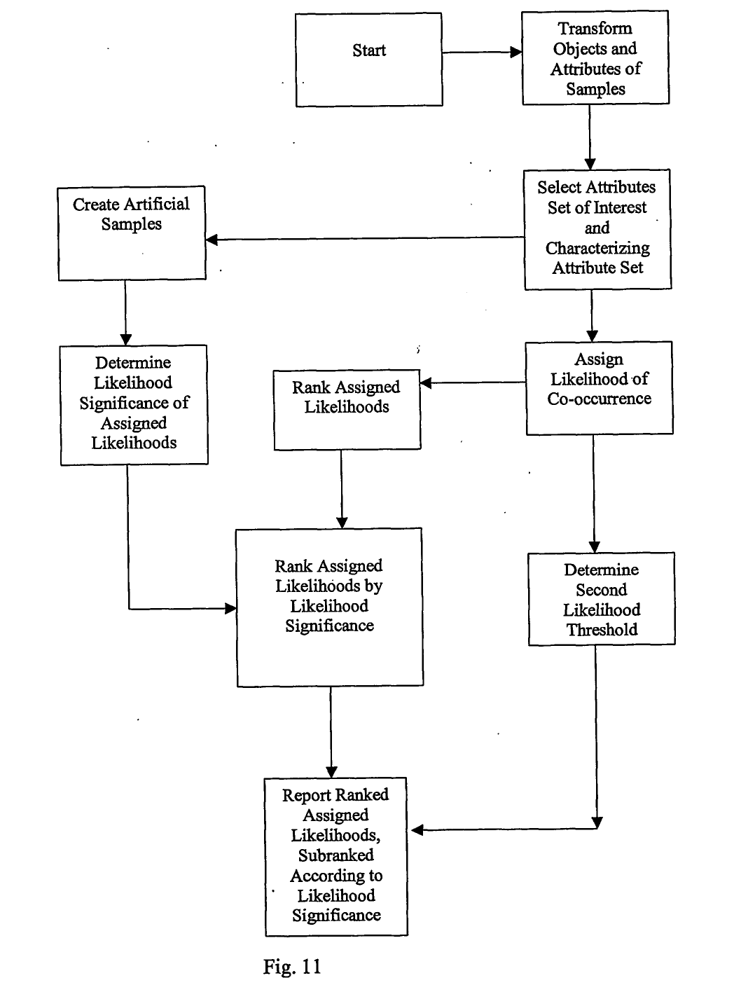

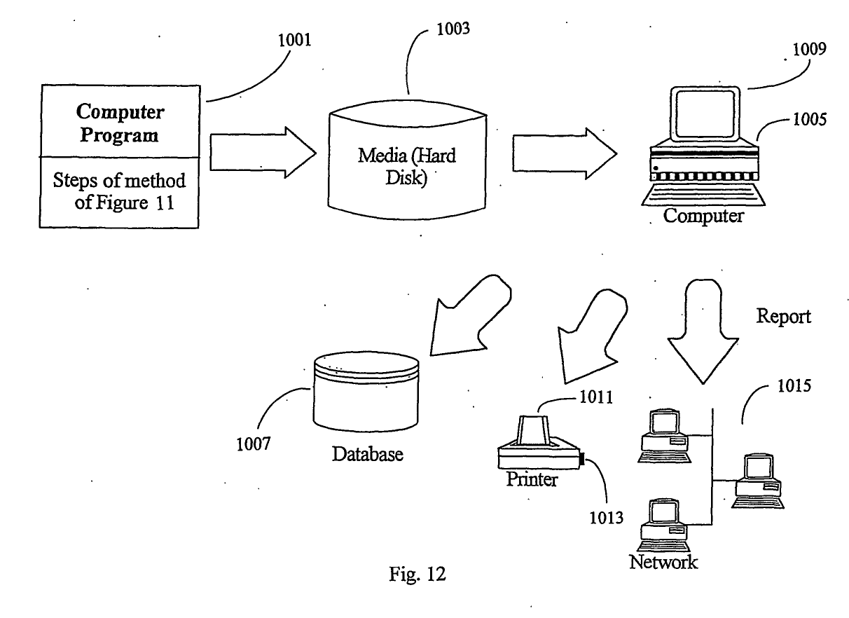

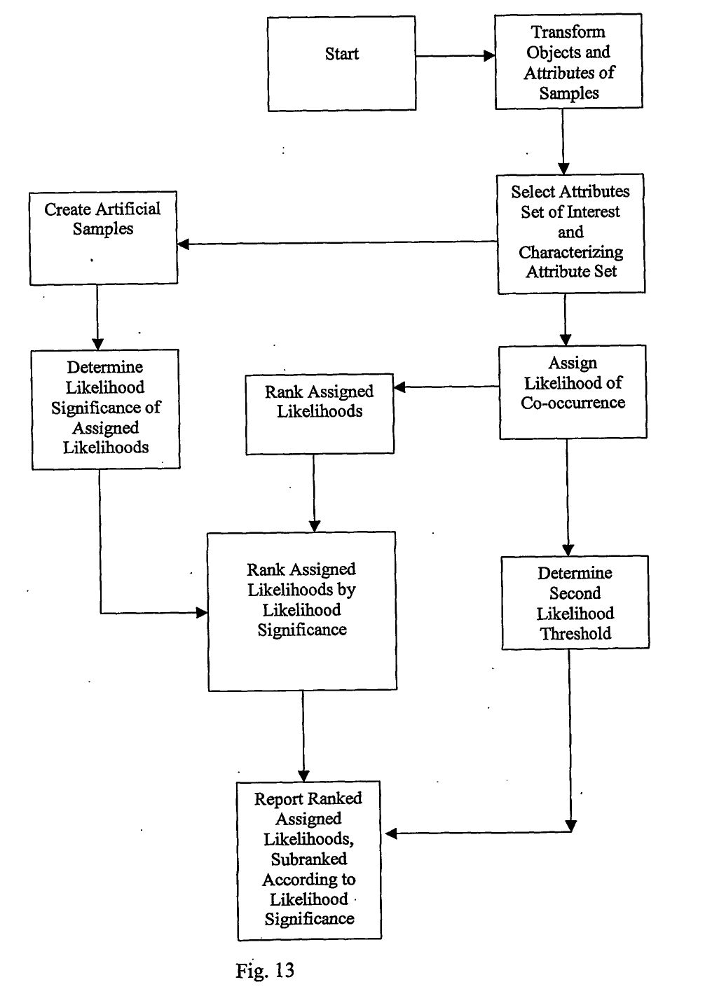

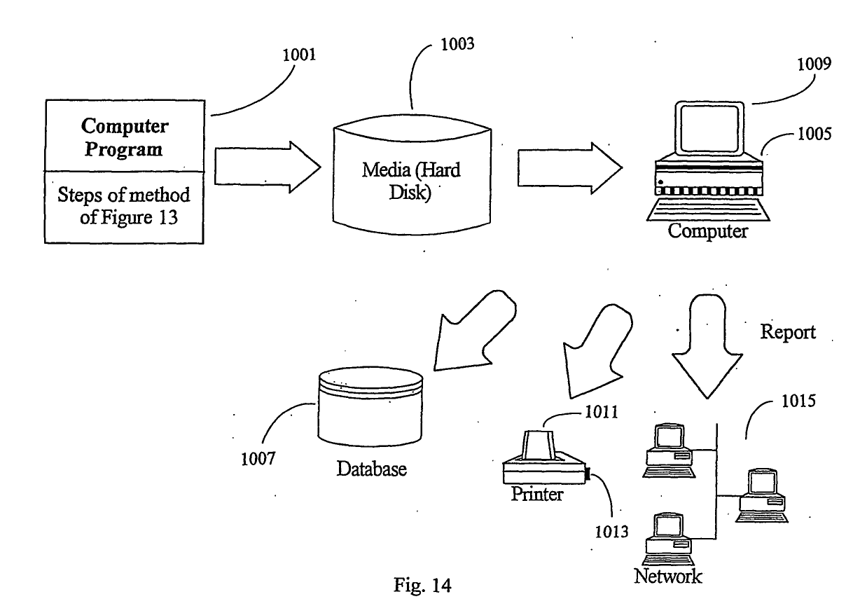

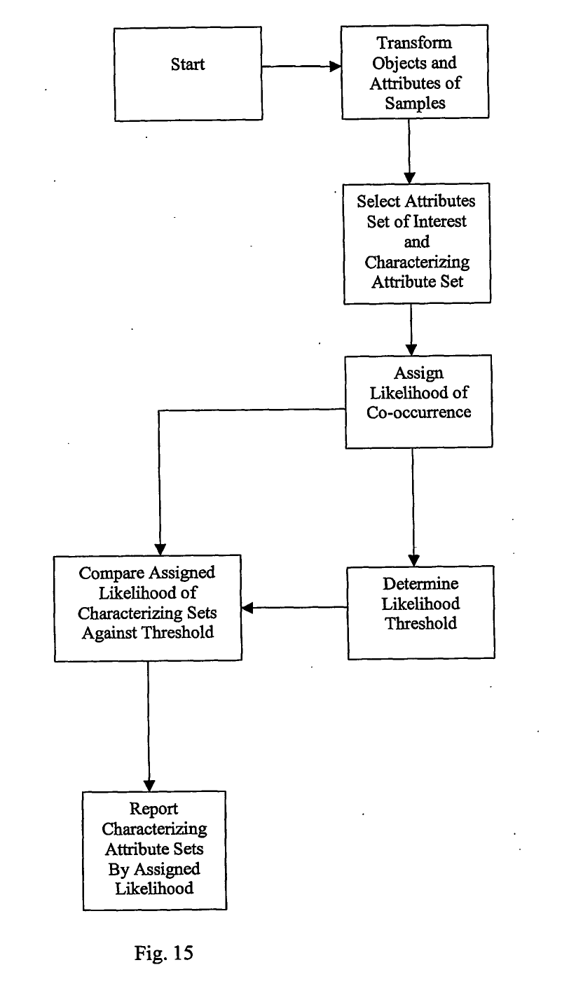

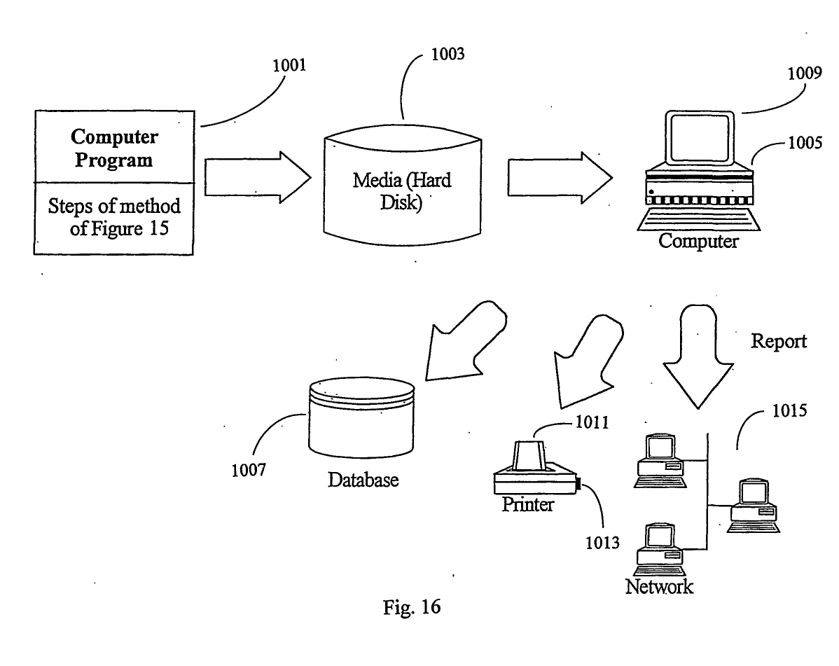

Flow diagrams for embodiments of a number of other base methods are shown in FIGS. 11, 13 and 15. Corresponding block diagrams are shown in FIGS. 12, 14 and 16.

The methods, system and other aspects of the embodiments described herein, and the invention, can be used to identify markers for diagnosis, such as might form part of diagnostic kits or procedures used to determine a disease or syndrome type of a patient. Similarly, they may be used to identify markers for prognosis of a disease or syndrome of a patient, such as might form part of diagnostic kits or procedures used to determine a disease or syndrome type of a patient. Similarly, they may be used to identify markers to determine whether a therapy or treatment is appropriate for a patient, or other biological attribute of a human or other living system. This can be done by identifying and attribute set to be tested for in the patient or other living system by carrying out one or more of the base methods previously described. Although the methods, system and other aspects of the embodiments have been described primarily with respect to the use of gene level expression sets as attribute sets, the embodiments and the invention may also be applied to tissue or serum protein concentration sets, or blood or tissue molecular marker sets, or microscopic or macroscopic clinical observables, or combinations thereof.

It will be understood by those skilled in the art that this description is made with reference to the preferred embodiment and that it is possible to make other embodiments employing the principles of the invention which fall within its spirit and scope as defined by the following claims.

We claim:

1. A method of identifying one or more characterizing attributes for an object that are likely to co-occur with one or more attributes of interest for the object, the method comprising the steps of:
Selecting one or more attribute sets of one or more characterizing attributes of the object,
Selecting an attribute set of one or more attributes of interest for the object,
Assigning a likelihood for each characterized attribute set that the attribute set occurs for the object when the attribute set of interest occurs for the object, each likelihood determined using one or more Bayesian computable classifiers on a dataset of attributes for a plurality of actual samples of the object,
Comparing each assigned likelihood against one or more likelihood thresholds, and
Reporting the assigned likelihoods of the characterizing attribute set based on the likelihood thresholds.

2. The method of claim 1 or 7, wherein a likelihood threshold for each characterizing attribute set is determined using the same Bayesian classifiers as the assigned likelihood on a dataset of attributes for a plurality of artificial samples of the object.

3. The method of claim 1 or 7, wherein a likelihood threshold for each characterizing attribute set is determined by computing those characterizing attribute sets with an assigned likelihood above a given percentile of all assigned likelihoods for the relevant attribute set.

4. The method of claim 2 or 24, wherein the artificial samples are created by randomizing the actual gene expression levels for the characterizing attributes.

5. The method of claim 2 or 24, wherein the artificial samples are created by transposing the actual gene expression levels for each characterizing attribute to another characterizing attribute.

6. The method of claim 1, wherein the assigned likelihoods of the remaining characterizing attribute sets are also compared against a second likelihood threshold determined by computing those characterizing attribute sets with an assigned likelihood above a given percentile of all assigned likelihoods for the relevant attribute set of interest.

7. A method of identifying a characterizing attribute for an object that is likely to co-occur with an attribute of interest for the object, the method comprising the steps of:
Selecting one characterizing attribute set of one or more attributes for the object,
Selecting an attribute of interest for the object,
Assigning a likelihood for the characterized attribute set that the attribute occurs for the object when the attribute of interest occurs for the object, the assigned likelihood determined using a Bayesian computable classifier on a dataset of attributes for a plurality of actual samples of the object,
Comparing the assigned likelihood against a likelihood threshold, and
Reporting the assigned likelihood of the characterizing attribute set based on the likelihood threshold.

8. The method of claim 7 or 24, wherein the characterizing attributes are gene expression levels and the attribute of interest is a drug sensitivity level.

9. The method of claim 1, wherein each characterizing attribute is a gene expression level and the attribute of interest is a drug sensitivity level.

10. The method of claim 1, wherein each characterizing attribute is a gene expression level and the attribute of interest is drug dose (absolute concentration or dose relative to some standard dose) along an increasing, or decreasing, scale.

11. The method of claim 1, wherein each characterizing attribute is a gene expression level and the attribute of interest is the dose of drug which causes half-maximal cellular growth rate.

12. The method of claim 1, wherein each characterizing attribute is a gene expression level and the attribute of interest is —logarithm₁₀(dose), where dose is the dose which yields half-maximal total cell mass accumulating under otherwise standard conditions.

13. The method of claim 9, the drug sensitivity level represents growth inhibiting in diseased cells.

14. The method of claim 9, the drug sensitivity level represents a lack of growth inhibiting in diseased cells.

15. The method of claim 9, the drug sensitivity level represents patient toxicity in healthy cells.

16. The method of claim 9, wherein the attributes are represented in a dataset taken from the NCI60 dataset.

17. The method of claim 7 or 24, wherein the Bayesian classifier is selected from a group consisting of linear discriminant analysis, quadratic discriminant analysis, and a uniform/gaussian analysis.

18. The method of claim 1, wherein the Bayesian classifiers are selected from a group consisting of linear discriminant analysis, quadratic discriminant analysis, and a uniform/gaussian analysis.

19. The method of claim 1, wherein two Bayesian classifiers are used selected from a group consisting of linear discriminant analysis, quadratic discriminant analysis, and a uniform/gaussian analysis.

20. The method of claim 1, wherein one Bayesian classifier is used selected from a group consisting of linear discriminant analysis, quadratic discriminant analysis, and a uniform/gaussian analysis.

21. The method of claim 1, wherein the Bayesian classifiers are linear discriminant analysis, quadratic discriminant analysis, and a uniform/gaussian analysis.

22. The method of claim 1, wherein the characterizing attribute sets ranked following comparison of the likelihood and the likelihood threshold are reported.

23. The method of claim 22, wherein the ranked characterizing attributes sets are reported to one of a group consisting of a computer readable file stored on computer readable media, a printed report, and a computer network.

24. A method of identifying one or more characterizing attributes for an object that are likely to co-occur with one or more attributes of interest for the object, the method comprising the steps of:
selecting one or more attribute sets of one or more characterizing attributes of the object,
selecting an attribute set of one or more attributes of interest for the object,
assigning a likelihood for each characterized attribute set that the attribute set occurs for the object when the attribute set of interest occurs for the object, each likelihood determined using one or more Bayesian computable classifiers on a dataset of attributes for a plurality of actual samples of the object,
determining a likelihood significance for each assigned likelihood using artificial samples, and
ranking the assigned likelihoods of the characterizing attribute set using the likelihood significance.

25. The method of claim 24, wherein the assigned likelihoods are ranked by assigned likelihood and subranked by likelihood significance.

26. The method of claim 24, further comprising the steps of:
comparing the assigned likelihood against a likelihood threshold, and
reporting the assigned likelihood of the characterizing attribute set based on the likelihood threshold and the ranking of the assigned likelihood.

27. A method of identifying one or more characterizing attributes for an object that are likely to co-occur with one or more attributes of interest for the object using a dataset of samples of attributes for the object, the method comprising accessing one of the systems of claim 28.

28. A system for identifying one or more characterizing attributes for an object that are likely to co-occur with one or more attributes of interest for the object using a dataset of samples of attributes for the object, the system comprising:
a computing platform, and
a computer program on a computer readable medium for use on the computer platform in association with the dataset, the computer program comprising:
instructions to identify a characterizing attribute for an object that is likely to co-occur with an attribute of interest for the object, by carrying out the steps of the method of claim 1, 7 or 24.

29. A computer program on a computer readable medium for use on a computer platform in association with a dataset, the computer program comprising:
instructions to identify a characterizing attribute for an object that is likely to co-occur with an attribute of interest for the object, by carrying out the steps of the method of claim 1, 7 or 24.

30. A method of drug discovery comprising the steps:
identifying characterizing attribute sets for interaction by the drug, wherein the step of identifying comprises carrying out the steps of the method of claim 1, 7 or 24 for drug sensitive attributes of interest, and
performing screens for drugs where growth in cells having desirably ranked characterizing attribute sets is drug sensitive.

31. A method of identifying markers for diagnostic kits used to determine if a treatment is appropriate for a patient, the method comprising the steps:
identifying a gene expression level set to be tested for in the patient by carrying out the steps of the method of claim 1, 7 or 24.

32. A method of identifying markers for diagnosis is of a living system, the method comprising the steps:
identifying an attribute set to be tested for in the living system by carrying out the steps of the method of claim 1, 7 or 24.

33. A method of identifying markers for prognosis of a living system, the method comprising the steps:
identifying an attribute set to be tested for in the living system by carrying out the steps of the method of claim 1, 7 or 24.

34. A method of identifying markers for determining the appropriateness of a therapy or treatment of a living system, the method comprising the steps:
identifying an attribute set to be tested for in the living system by carrying out the steps of the method of claim 1, 7 or 24.

35. The method of claim 32, wherein the diagnosis is with respect to a disease or syndrome type of a patient.

36. The method of claim 33, wherein the prognosis is with respect to a disease or syndrome type of a patient.

37. The method of claim 32, 33 or 34, wherein the attributes of the attribute set comprise protein concentrations.

38. The method of claim 37, wherein the protein concentrations comprise tissue protein concentrations.

39. The method of claim 37, wherein the protein concentrations comprise serum protein concentrations.

40. The method of claim 32, 33 or 34, wherein the attributes of the attribute set comprise molecular markers.

41. The method of claim 40, wherein the molecular markers comprise blood molecular markers.

42. The method of claim 40, wherein the molecular markers comprise tissue molecular markers.

43. The method of claim 32, 33 or 34, wherein the attributes of the attribute set comprise clinical observables.

44. The method of claim 43, wherein the clinical observables comprise microscopic clinical observables.

45. The method of claim 43, wherein the clinical observables comprise macroscopic clinical observables.

46. The method of claim 32, wherein the markers are for diagnostic kits used in the diagnosis.

47. The method of claim 32, wherein the markers are for diagnostic procedures used in the diagnosis.

48. The method of claim 33, wherein the markers are for prognostic kits used in the prognosis.

49. The method of claim 33, wherein the markers are for prognostic procedures used in the prognosis.
